(19) United States
(12) Patent Application Publication
(10) Pub. No.: US 2007/0259134 A1
(43) Pub. Date: Nov. 8, 2007

(54) Cellulose Compound Film, Optical Compensation Sheet, Polarizing Plate, and Liquid Crystal Display Device

(75) Inventors: Yutaka Nozoe, Minami-ashigara-shi (JP); Tadashi Omatsu, Minami-ashigara-shi (JP)

Correspondence Address: BUCHANAN, INGERSOLL & ROONEY PC, POST OFFICE BOX 1404, ALEXANDRIA, VA, 22313-1404, US

(73) Assignee: FUJIFILM CORPORATION, Tokyo (JP)

(21) Appl. No.: 11/743,173

(22) Filed: May 2, 2007

(30) Foreign Application Priority Data
May 2, 2006 (JP) 2006-128452

(51) Int. Cl. C09K 19/00; C08B 5/00

(52) U.S. Cl. 428/1.31; 536/34

(57) ABSTRACT

A cellulose compound film containing a cellulose compound having two or more substituents whose polarizability anisotropies Δα calculated by mathematical formula (1) are different from each other, wherein substitution degrees of the following substituents A and B in the cellulose compound satisfy relationship as defined by mathematical formula (A1), in which the substituent A has the lowest Δα and the substituent B has the highest Δα:

$$Δ α = α x - \frac{α y + α z}{2} \qquad Mathematical formula ( 1 )$$

wherein, in characteristic values obtained after diagonalization of polarizability tensor, αx is the largest component, αy is the second largest component, and αz is the smallest component;
DS_{B}2+DS_{B}3−DS_{B}6≧−0.1 Mathematical formula (A1)
wherein DS_{B}2, DS_{B}3, and DS_{B}6 represent a substitution degree of the substituent B at the 2-, 3-, or 6-position of a β-glucose ring constituting unit of cellulose, respectively; and an optical compensation film, a polarizing plate, and a liquid crystal display device, using the cellulose compound film.

### FIELD OF THE INVENTION

The present invention relates to a cellulose compound film having a negative retardation and providing a desired retardation with a small film thickness; and the present invention also relates to an optical compensation sheet, a polarizing plate, and a liquid crystal display device, each of which utilizes the cellulose compound film.

### BACKGROUND OF THE INVENTION

Cellulose acylate films have been widely used as polarizing plate protective films for liquid crystal display devices, owing to their adequate water permeability and high optical isotropy, or small retardation in the absolute value.

In recent years, with the prevalence of liquid crystal display devices, increasingly higher levels of display performance and durability are demanded, and hence there are demands for the increase in the response speed, and compensation in a wider range of viewing angles for performances such as the contrast and color balance of a displayed image observed from an oblique direction. For satisfying these demands, various types of liquid crystal modes are developed, and at the same time it is urgently needed to develop a retardation film (a phase difference plate) as an optical compensation film for the purpose of compensating viewing angles corresponding to each mode.

Further, in addition to the above, slimming down of panels to be incorporated and cost reduction are demanded on liquid crystal display devices, and hence a method for imparting the function of the retardation film to a protective film for a polarizing plate to be used in a liquid crystal display device has become studied.

On the other hand, along with the diversification of the display modes of liquid crystal display televisions, greater diversity of retardation films are become required, one of which is a retardation film having a negative retardation in the film thickness direction. For example, for a so-called in-plane switching (IPS) mode in which a transverse electric field is applied to a liquid crystal, as a means for improving the color tone and the viewing angle when displaying black, it is suggested to dispose, between a liquid crystal layer and a polarizing plate, an optical compensation material having a birefringent property, which is composed of a film having positive birefringence and an optical axis in the plane of the film and a film having positive birefringence and an optical axis in the normal direction of the film, as an optical compensation film (see JP-A-11-133408 (“JP-A” means unexamined published Japanese patent application)).

For the above-described demands, there is a suggestion of a method of cooling and dissolving cellulose acylate low in the degree of substitution of an acyl group, as a cellulose acylate film having a negative retardation in the film thickness direction (see JP-A-2005-120352) However, by these methods, Rth, i.e. a retardation in the film thickness direction, cannot be sufficiently reduced, and hence other method for further reducing Rth has been demanded. Further, a cellulose acylate film produced by any of these methods has a high water permeability and a high moisture content, and hence a polarizing plate using the film as a protective film has a problem in its durability, particularly in conspicuous deterioration of the polarizing plate performance under high temperature and high humidity conditions.

### SUMMARY OF THE INVENTION

The present invention resides in a cellulose compound film containing a cellulose compound having two or more substituents whose polarizability anisotropies Δα which are calculated by mathematical formula (1) are different from each other, wherein substitution degrees of the following substituents A and B in the cellulose compound satisfy relationship as defined by mathematical formula (A1), in which the substituent A has the lowest polarizability anisotropy Δα and the substituent B has the highest polarizability anisotropy Δα:

$$Δ α = α x - \frac{α y + α z}{2} \qquad Mathematical formula ( 1 )$$

wherein αx is the largest component in characteristic values obtained after diagonalization of polarizability tensor; αy is the second largest component in the characteristic values obtained after diagonalization of the polarizability tensor; and αz is the smallest component in the characteristic values obtained after diagonalization of the polarizability tensor;
DS_{B}2+DS_{B}3−DS_{B}6≧−0.1 Mathematical formula (A1)

wherein DS_{B}2, DS_{B}3, and DS_{B}6 represent a substitution degree of the substituent B at the 2-, 3-, or 6-position of a β-glucose ring that is a constituting unit of cellulose, respectively.

Further, the present invention resides in an optical compensation sheet, comprising the cellulose compound film.

Further, the present invention resides in an optical compensation sheet, having an optical anisotropic layer on the cellulose compound film.

Further, the present invention resides in a polarizing plate, comprising a polarizing film, and two transparent protective films disposed on both sides of the polarizing film, wherein at least one of the transparent protective films is the above optical compensation sheet.

Further, the present invention resides in a liquid crystal display device, comprising a liquid crystal cell, and two polarizing plates disposed on both sides of the liquid crystal cell, wherein at least one of the polarizing plates is the above polarizing plate.

Other and further features and advantages of the invention will appear more fully from the following description, appropriately referring to the accompanying drawing.

### BRIEF DESCRIPTION OF THE DRAWING

FIG. 1 is a schematic view showing an IPS mode liquid crystal cell prepared in the examples.

### DETAILED DESCRIPTION OF THE INVENTION

The inventors, having studied keenly, found that the site of a substituent(s) greatly influences the developability of a retardation in a cellulose compound, in particular, that a substituent(s) having a large polarizability anisotropy dramatically changes the retardation developability, according to the site of the substituent(s). Further, the inventors also found that, by adding a retardation-controlling agent having an octanol-water partition coefficient (log P value) in a specific range to a cellulose compound film, it is possible to reduce the water permeability and moisture content of the resultant film and to improve the durability of a polarizing plate using the film as a protective film of the polarizing plate. The present invention has been attained based on those findings.

According to the present invention, there is provided the following means:
<1> A cellulose compound film containing a cellulose compound having two or more substituents whose polarizability anisotropies Δα which are calculated by mathematical formula (1) are different from each other, wherein substitution degrees of the following substituents A and B in the cellulose compound satisfy relationship as defined by mathematical formula (A1), in which the substituent A has the lowest polarizability anisotropy Δα and the substituent B has the highest polarizability anisotropy Δα:

$$Δ α = α x - \frac{α y + α z}{2} \qquad Mathematical formula ( 1 )$$

wherein αx is the largest component in characteristic values obtained after diagonalization of polarizability tensor; αy is the second largest component in the characteristic values obtained after diagonalization of the polarizability tensor; and αz is the smallest component in the characteristic values obtained after diagonalization of the polarizability tensor;
DS_{B}2+DS_{B}3−DS_{B}6≧−0.1 Mathematical formula (A1)

wherein DS_{B}2, DS_{B}3, and DS_{B}6 represent a substitution degree of the substituent B at the 2-, 3-, or 6-position of a β-glucose ring that is a constituting unit of cellulose, respectively;
<2> The cellulose compound film according to <1>, wherein the retardation Rth in the film thickness direction is negative;
<3> The cellulose compound film according to <1> or <2>, wherein the total of the substitution degrees of the substituents A and B satisfies relationship as defined by mathematical formula (A2):
   DS_{A}2+DS_{A}3+DS_{A}6>DS_{B}2+DS_{B}3+DS_{B}6 Mathematical formula (A2)

wherein DS_{A}2, DS_{A}3, and DS_{A}6 represent a substitution degree of the substituent A at the 2-, 3-, or 6-position of a β-glucose ring that is a constituting unit of cellulose, respectively; and DS_{B}2, DS_{B}3, and DS_{B}6 represent a substitution degree of the substituent B at the 2-, 3-, or 6-position of a β-glucose ring that is a constituting unit of cellulose, respectively;
<4> The cellulose compound film according to any one of <1> to <3>, wherein the total of the substitution degrees of the substituents A and B satisfies relationship as defined by mathematical formula (A3):
   1.5≦DS_{A}2+DS_{A}3+DS_{A}6+DS_{B}2+DS_{B}3+DS_{B}6≦3.0 Mathematical formula (A3)

wherein DS_{A}2, DS_{A}3, and DS_{A}6 represent a substitution degree of the substituent A at the 2-, 3-, or 6-position of a β-glucose ring that is a constituting unit of cellulose, respectively; and DS_{B}2, DS_{B}3, and DS_{B}6 represent a substitution degree of the substituent B at the 2-, 3-, or 6-position of a β-glucose ring that is a constituting unit of cellulose, respectively;
<5> The cellulose compound film according to any one of <1> to <4>, wherein the polarizability anisotropy of the substituent B is 2.5×10⁻²⁴ cm³ or more;
<6> The cellulose compound film according to <5>, wherein the substituent B having a polarizability anisotropy of 2.5×10⁻²⁴ cm³ or more is an aromatic acyl group;
<7> The cellulose compound film according to any one of <1> to <6>, containing a retardation-controlling agent which has an octanol-water partition coefficient (log P value) of 1.0 to 10.0;
<8> The cellulose compound film according to any one of <1> to <7>, wherein the equilibrium moisture content of the film at 25° C. and 80% RH is 3.0% or less;
<9> The cellulose compound film according to any one of <1> to <8>, wherein the film is oriented in an amount of 1% or more but 100% or less in the film conveyance direction and/or the direction perpendicular to the film conveyance direction;
<10> The cellulose compound film according to any one of <1> to <9>, containing at least one retardation-controlling agent which satisfies relationship as defined by mathematical formula (11-1):

$$\frac{Rth ( a ) - Rth ( 0 )}{a} ≦ - 1.5 \qquad Mathematical formula ( 11 \text{-} 1 )$$

in which, a is: 0.1≦a≦3.0

wherein Rth(a) is a Rth (nm) of a cellulose acetate film at wavelength 589 nm, which film has a thickness of 80 μm and contains the retardation-controlling agent in an amount of a % by mass to cellulose acetate whose substitution degree of an acetyl group is 2.86; Rth(0) is a Rth (nm) of a film at wavelength 589 nm, which film has a thickness of 80 μm, and is composed of cellulose acetate whose substitution degree of an acetyl group is 2.86 which does not contain the retardation-controlling agent; and a is an amount in part by mass of the retardation-controlling agent to 100 parts by mass of cellulose acetate;
<11> The cellulose compound film according to <10>, wherein the retardation-controlling agent is at least one of compounds represented by any one of formulae (1) to (19):

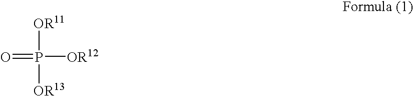

wherein R¹¹, R¹² and R¹³ each independently represent an aliphatic group having 1 to 20 carbon atoms, in which the aliphatic group may have a substituent, and R¹¹, R¹² and R¹³ may be combined each other to form a ring;

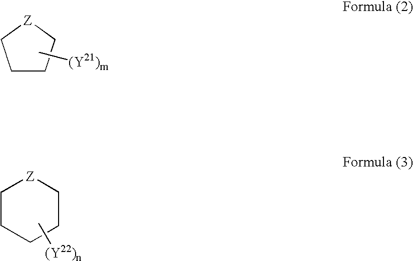

wherein Z represents a carbon atom, an oxygen atom, a sulfur atom, or —NR²⁵—, in which R²⁵ represents a hydrogen atom or an alkyl group, the 5- or 6-membered ring formed by containing Z may have a substituent; Y²¹ and Y²² each independently represent an ester group, an alkoxycarbonyl group, an amido group, or a carbamoyl group, each having 1 to 20 carbon atoms, or Y²¹s may be combined each other to form a ring, and Y²²s may be combined each other to form a ring; m represents an integer of 1 to 5; and n represents an integer of 1 to 6;

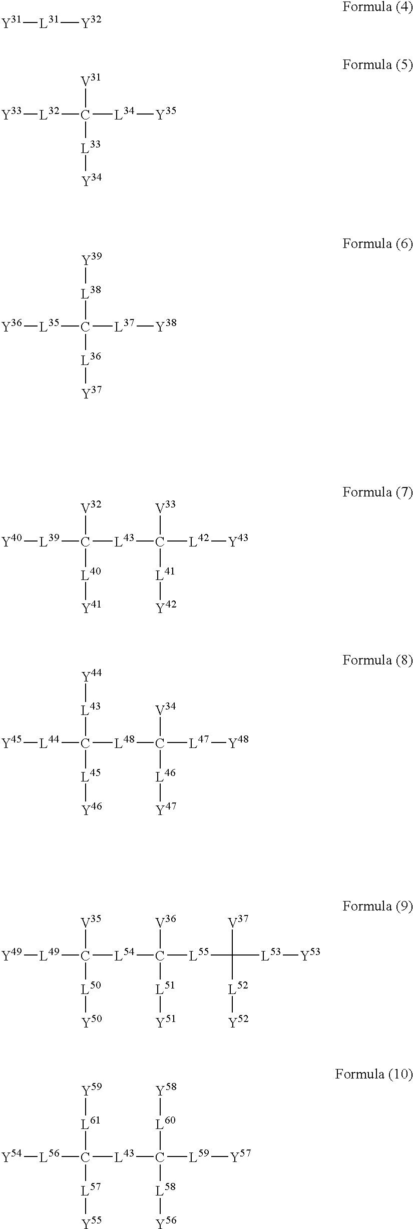

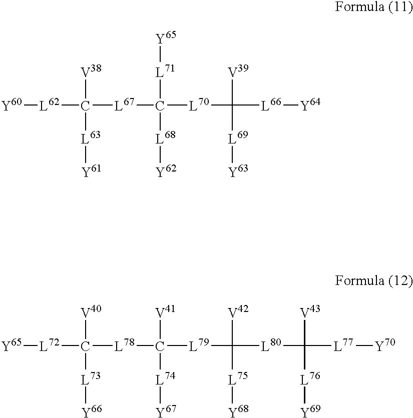

wherein Y³¹ to Y⁷⁰ each independently represent an ester group, an alkoxycarbonyl group, an amido group, or a carbamoyl group, each having 1 to 20 carbon atoms, or a hydroxy group; V³¹ to V⁴³ each independently represent a hydrogen atom or an aliphatic group having 1 to 20 carbon atoms; L³¹ to L⁸⁰ each independently represent a saturated divalent linking group which is composed of 0 to 40 atoms for constituting the group and which has 0 to 20 carbon atoms; when L³¹ to L⁸⁰ are each composed of zero (0) atom, it means that L³¹ to L⁸⁰ each represent a single bond; and V³¹ to V⁴³ and L³¹ to L⁸⁰ each may further have a substituent;

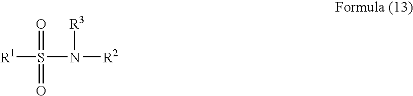

wherein R¹ represents an alkyl group or an aryl group, and R² and R³ each independently represent a hydrogen atom, an alkyl group, or an aryl group, in which the total of carbon atoms of R¹, R², and R³ is 10 or more, and the alkyl group and the aryl group each may have a substituent;

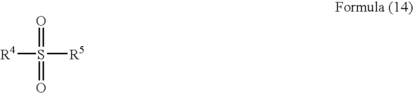

wherein R⁴ and R⁵ each independently represent an alkyl group or an aryl group, in which the total of carbon atoms of R⁴ and R⁵ is 10 or more, and the alkyl group and the aryl group each may have a substituent;

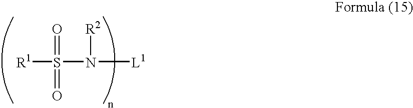

wherein R¹ represents a substituted or unsubstituted aliphatic group, or a substituted or unsubstituted aromatic group; R² represents a hydrogen atom, a substituted or unsubstituted aliphatic group, or a substituted or unsubstituted aromatic group; L¹ represents a divalent to hexavalent linking group; and n represents an integer of 2 to 6 corresponding to the valence of L¹;

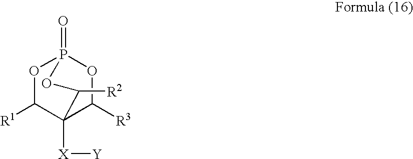

wherein R¹, R², and R³ each independently represent a hydrogen atom or an alkyl group; X represents a divalent linking group composed of at least one selected from the following ‘linking groups 1’; and Y represents a hydrogen atom, an alkyl group, an aryl group, or an aralkyl group:
‘Linking groups 1’ includes a single bond, —O—, —CO—, —NR⁴— (in which R⁴ represents a hydrogen atom, an alkyl group, an aryl group, or an aralkyl group.), an alkylene group, and an arylene group;

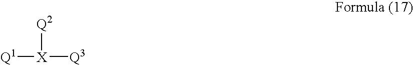

wherein Q¹, Q², and Q³ each independently represent a 5- or 6-membered ring; and X represents B, C—R, N, P, or P═O, in which R represents a hydrogen atom or a substituent;

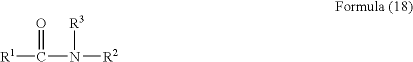

wherein R¹ represents an alkyl group or an aryl group, and R² and R³ each independently represent a hydrogen atom, an alkyl group, or an aryl group, in which the alkyl group and the aryl group each may have a substituent;

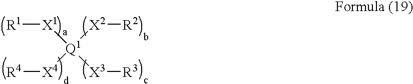

wherein R¹, R², R³, and R⁴ each independently represent a hydrogen atom, a substituted or unsubstituted aliphatic group, or a substituted or unsubstituted aromatic group; X¹, X², X³, and X⁴ each independently represent a divalent linking group formed by at least one selected from the group consisting of a single bond, —CO—, and —NR⁵— (in which R⁵ represents a substituted or unsubstituted aliphatic group, or a substituted or unsubstituted aromatic group); a, b, c, and d each are an integer of 0 or more, and a+b+c+d is 2 or more; and Q¹ represents an organic group having a valence of (a+b+c+d).
<12> An optical compensation sheet, comprising the cellulose compound film according to any one of <1> to <1>;
<13> An optical compensation sheet, having an optical anisotropic layer on the cellulose compound film according to any one of <1> to <1>;
<14> A polarizing plate, comprising a polarizing film, and two transparent protective films disposed on both sides of the polarizing film, wherein at least one of the transparent protective films is the optical compensation sheet according to <12> or <13>;
<15> A liquid crystal display device, comprising a liquid crystal cell, and two polarizing plates disposed on both sides of the liquid crystal cell, wherein at least one of the polarizing plates is the polarizing plate according to <14>; and
<16> The liquid crystal display device according to <15>, wherein a display mode of the liquid crystal display device is an IPS mode.

Hereinafter, the present invention will be described in detail. The descriptions below may be given based on some representative embodiments or examples of elements of the present invention, but the invention is not meant to be limited to such embodiments or examples. For example, the cellulose compound film of the present invention may be referred to, in some cases, as a cellulose acyrate film or a cellulose acetate film, which are preferable examples of the cellulose compound film. Herein, in the specification, a numerical range expressed using “to” denotes a range including numerical values described before and after the “to” as a minimum value and a maximum value of the range.

An embodiment of the present invention is a cellulose compound having two or more substituents with different polarizability anisotropies each other, wherein the substitution degrees of the substituents in the 2-, 3-, and 6-positions of a β-glucose ring that is a constituting unit of cellulose satisfy a specific relationship, which cellulose compound can be used in an optical compensation film.

[Cellulose Compound Film]

The cellulose compound film of the present invention is described below, in the order of the cellulose compound, additives, and the film formation method.

[Cellulose Compound]

The cellulose compound (cellulose derivative or cellulosic) for use in the cellulose compound film of the present invention, has at least two substituents whose polarizability anisotropy values are different from each other, as substituents bonded to at least one of three hydroxy groups on a β-glucose ring that is a constituting unit of cellulose, wherein the polarizability anisotropy Δα is calculated by mathematical formula (1):

$$Δ α = α x - \frac{α y + α z}{2} \qquad Mathematical formula ( 1 )$$

wherein αx is the largest component of the characteristic values obtained after diagonalization of the polarizability tensor; αy is the second largest component of the characteristic values obtained after diagonalization of the polarizability tensor; and αz is the smallest component of the characteristic values obtained after diagonalization of the polarizability tensor.

The substituents each have a characteristic polarizability anisotropy Δα, and the Δα can be calculated using Gaussian 03 (Revision B.03, trade name, software manufactured by Gaussian, Inc.). Specifically, using a structure optimized at the B3LYP/6-31G* level, a substituent bonded to a hydroxy group on a β-glucose ring that is a constituting unit of cellulose is DFT calculated on the B3LYP/6-311+G** level, as a partial structure containing an oxygen atom of the hydroxy group (more specifically, the substituted moiety in the cellulose side chain is modeled in the form of a substituent —OH such as AcOH, and structurally optimized), thus the polarizability tensor is calculated. The resulting polarizability tensor is diagonalized, and then coordinate transformation (C═O is defined as X axis, and bonded atoms are placed along Y axis) is conducted, to determine αx, αy, and αz; and the resultant αx, αy, and αz components are assigned to the mathematical formula (1), thereby to determine the polarizability anisotropy Δα.

Examples of the polarizability anisotropy Δα of each substituent as calculated by the above method, are listed below: Acetyl group=0.91, propionyl group=1.44, butyryl group=2.20, benzoyl group=5,08, 2,4,5-trimethoxybenzoyl group=7.12.

When the polarizability anisotropy Δα is calculated in the above manner, the substitution degree of the substituent A having the lowest Δα and the substitution degree of the substituent B having the highest Δα, each in the cellulose compound according to the present invention, satisfy the relationship as defined by mathematical formula (A1). Further, the total substitution degree of the substituents A and B in the cellulose compound according to the present invention preferably satisfy any one or both of the relationships as defined by mathematical formulas (A2) and (A3):
DS_{B}2+DS_{B}3−DS_{B}6≧−0.1 Mathematical formula (A1)
DS_{A}2+DS_{A}3+DS_{A}6>DS_{B}2+DS_{B}3+DS_{B}6 Mathematical formula (A 2)
1.5≦DS_{A}2+DS_{A}3+DS_{A}6+DS_{B}2+DS_{B}3+DS_{B}6≦3.0 Mathematical formula (A3)

wherein DS_{A}2, DS_{A}3, and DS_{A}6 respectively represent the substitution degree of the substituent A at the 2-, 3-, or 6-position of a β-glucose ring that is a constituting unit of cellulose; and DS_{B}2, DS_{B}3, and DS_{B}6 respectively represent the substitution degree of the substituent B at the 2-, 3-, or 6-position of a β-glucose ring that is a constituting unit of cellulose.

The mathematical formula (A1) represents that, with reference to the substituent B having the highest polarizability anisotropy in the cellulose compound according to the present invention, the total of the substitution degrees at the 2- and 3-positions of a [-glucose ring constituting cellulose is equal to or larger than the value obtained by subtracting 0.1 from the substitution degree at the 6-position.

The mathematical formula (A1) is preferably:
DS_{B}2+DS_{B}3−DS_{B}6≧0
and, more preferably:
DS_{B}2+DS_{B}3−DS_{B}6≧0.2

The mathematical formula (A2) represents that, in the cellulose compound according to the present invention, the total substitution degree of the substituent A having the lowest polarizability anisotropy is preferably higher than the total substitution degree of the substituent B having the highest polarizability anisotropy.

The mathematical formula (A2) is further preferably:
DS_{A}2+DS_{A}3+DS_{A}6>DS_{B}2+DS_{B}3+DS_{B}6+0.5
and, most preferably:
DS_{A}²+DS_{A}³+DS_{A}6>DS_{B}2+DS_{B}3+DS_{B}6+1.0

The mathematical formula (A3) represents that, in the cellulose compound according to the present invention, the total substitution degree of the substituents A and B is preferably 1.5 or more but 3.0 or less.

The mathematical formula (A3) is further preferably:
2.0≦DS_{A}2+DS_{A}3+DS_{A}6+DS_{B}2+DS_{B}3+DS_{B}6≦3.0
and, most preferably:
2.4≦DS_{A}2+DS_{A}3+DS_{A}6+DS_{B}2+DS_{B}3+DS_{B}6≦3.0

When the substitution degrees of the substituents A and B of the cellulose compound used in the present invention satisfy the above relationships, there is provided a cellulose compound having a more negative retardation in the film thickness direction, and a lower water permeability and a lower moisture content.

The cellulose compound used in the present invention may be selected from various cellulose compounds, such as cellulose esters and cellulose ethers, and it is particularly preferably a cellulose acylate, from the viewpoints of the transparency and flexibility of the resulting film.

Cellulose acylate that can be preferably used in the present invention is described below.

As the raw material cotton of cellulose acylate that can be used in the cellulose acylate film of the present invention, any of known materials can be used (e g., refer to Hatsumei Kyokai Kokai Giho Kogi No. 2001-1745). Further, the synthesis of cellulose acylate can also be performed according to a known manner (e.g., Migita, et al., “Mokuzai Kagaku” (“Wood Chemistry”), pp. 180-190, Kyoritsu Shuppan Co., Ltd. (1968)). The viscosity average polymerization degree of cellulose acylate is preferably from 300 to 700, more preferably from 350 to 500, and most preferably from 400 to 500.

By making the degree of polymerization greater, the crystallization at the time of production of the cellulose acylate film can be restrained.

The cellulose acylate that can be used in the present invention is a cellulose compound having two or more kinds of substituents with different polarizability anisotropies, in which at least one acyl group is substituted.

When the cellulose acylate that can be used in the present invention is substituted by two kinds of acyl groups with different polarizability anisotropies, the substituent A having the lowest polarizability anisotropy is preferably an acetyl group.

Further, the substituent having the largest polarizability anisotropy may be selected from various substituents as long as it is an acyl group having 3 or more carbon atoms. When an aliphatic acyl group is used, a propionyl group and a butyryl group are particularly preferable.

The substituent B of the cellulose acylate that can be used in the present invention is preferably the above-described substituent having a polarizability anisotropy of 2.5×10⁻²⁴ cm³ or more. The polarizability anisotropy of the substituent B is more preferably 4.0×10⁻²⁴ cm³ or more but 300×10⁻²⁴ cm³ or less, and most preferably 6.0×10⁻²⁴ cm³ or more but 300×10⁻²⁴ cm³ or less. As a substituent having a large polarizability anisotropy, an aromatic acyl group is particularly preferable, because it has high hydrophobization effect and is less prone to increase the free volume of the film.

In the present invention, the substitution degree in the cellulose compound can be determined as follows: The cellulose compound is dissolved in a solvent such as deuterated dimethyl sulfoxide, subjected to C¹³-NMR spectroscopy, and then the substitution degree is calculated from the peak strength of carbonyl carbons of the acyl group.

The cellulose acylate that can be used in the present invention is particularly preferably a compound, in which the substituent A is an acetyl group, and the substituent B is an aromatic acyl group represented by formula (A):

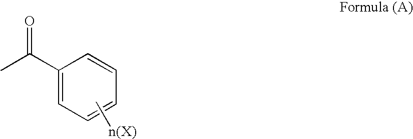

In formula (A), X represents a substituent, and n represents an integer of 0 to 5.

The compound represented by formula (A) is described below. In formula (A), X represents a substituent. Examples of the substituent include a halogen atom, a cyano group, an alkyl group, an alkoxy group, an aryl group, an aryloxy group, an acyl group, a carbonamido group, a sulfonamido group, a ureido group, an aralkyl group, a nitro group, an alkoxycarbonyl group, an aryloxycarbonyl group, an aralkyloxycarbonyl group, a carbamoyl group, a sulfamoyl group, an acyloxy group, an alkenyl group, an alkynyl group, an alkylsulfonyl group, an arylsulfonyl group, an alkyloxysulfonyl group, an aryloxysulfonyl group, an alkylsulfonyloxy group, an arylsulfonyloxy group, —S—R, —NH—CO—OR, —PH—R, —P(—R)₂, —PH—O—R, —P(—R)(—O—R), —P(—O—R)₂, —PH(═O)—R, —P(═O)(—R)₂, —PH(═O)—O—R, —P(═O)(—R)(—O—R), —P(═O)(—O—R)₂, —O—PH(═O)—R, —O—P(═O)(—R)₂, —O—PH(═O)—O—R, —O—P(═O)(—R)(—O—R), —O—P(═O)(—O—R)₂, —NH—PH(═O)—R, —NH—P(═O)(—R)(—O—R), —NH—P(═O)(—O—R)₂, —SiH₂—R, —SiH(—R)₂, —Si(—R)₃, —O—SiH₂—R, —O—SiH(—R)₂, and —O—Si(—R)₃. X may be further substituted by another substituent. The above-described R is an aliphatic group, an aromatic group, or a heterocyclic group.

The substituent represented by X is preferably a halogen atom, a cyano group, an alkyl group, an alkoxy group, an aryl group, an aryloxy group, an acyl group, a carbonamido group, a sulfonamido group or a ureido group; more preferably a halogen atom, a cyano group, an alkyl group, an alkoxy group, an aryloxy group, an acyl group or a carbonamido group; further preferably a halogen atom, a cyano group, an alkyl group, an alkoxy group or an aryloxy group; and most preferably a halogen atom, an alkyl group or an alkoxy group.

Examples of the halogen atom include a fluorine atom, a chlorine atom, a bromine atom and an iodine atom.

The above-described alkyl group is not limited to a linear group, and may have a cyclic or branched structure. The alkyl group is preferably an alkyl group having 1 to 20 carbon atoms, more preferably 1 to 12 carbon atoms, further preferably 1 to 6 carbon atoms, most preferably 1 to 4 carbon atoms. Examples of the alkyl group include methyl, ethyl, propyl, isopropyl, butyl, t-butyl, hexyl, cyclohexyl, octyl, and 2-ethylhexyl.

The above-described alkoxy group is not limited to a linear group, and may have a cyclic or branched structure. The alkoxy group is preferably an alkoxy group having 1 to 20 carbon atoms, more preferably 1 to 12 carbon atoms, further preferably 1 to 6 carbon atoms, most preferably 1 to 4 carbon atoms. The alkoxy group may be further substituted with another alkoxy group. Examples of the alkoxy group include methoxy, ethoxy, 2-methoxyethoxy, 2-methoxy-2-ethoxyethoxy, butyloxy, hexyloxy and octyloxy.

The aryl group is preferably an aryl group having 6 to 20 carbon atoms, more preferably 6 to 12 carbon atoms. Examples of the aryl group include phenyl and naphthyl.

The aryloxy group is preferably an aryloxy group having 6 to 20 carbon atoms, more preferably 6 to 12 carbon atoms Examples of the aryloxy group include phenoxy and naphthoxy.

The acyl group is preferably an acyl group having 1 to 20 carbon atoms, more preferably 1 to 12 carbon atoms. Examples of the acyl group include formyl, acetyl and benzoyl.

The carbonamido group is preferably a carbonamido group having 1 to 20 carbon atoms, more preferably 1 to 12 carbon atoms. Examples of the carbonamido group include an acetoamido group and a benzamido group.

The sulfonamido group is preferably a sulfonamido group having 1 to 20 carbon atoms, more preferably 1 to 12 carbon atoms. Examples of the sulfonamido group include a methanesulfonamido group, a benzenesulfonamido group, and a p-toluene sulfonamido group.

The ureido group is preferably an ureido group having 1 to 20 carbon atoms, more preferably 1 to 12 carbon atoms Examples of the ureido group include (unsubstituted) ureido.

The aralkyl group is preferably an aralkyl group having 7 to 20 carbon atoms, more preferably 7 to 12 carbon atoms. Examples of the aralkyl group include benzyl, phenethyl and naphthylmethyl.

The alkoxycarbonyl group is preferably an alkoxycarbonyl group having 2 to 20 carbon atoms, more preferably 2 to 12 carbon atoms. Examples of the alkoxycarbonyl group include methoxycarbonyl.

The aryloxycarbonyl group is preferably an aryloxycarbonyl group having 7 to 20 carbon atoms, more preferably 7 to 12 carbon atoms. Examples of the aryloxycarbonyl group include phenoxycarbonyl.

The aralkyloxycarbonyl group is preferably an aralkyloxycarbonyl group having 8 to 20 carbon atoms, more preferably 8 to 12 carbon atoms. Examples of the aralkyloxycarbonyl group include benzyloxycarbonyl.

The carbamoyl group is preferably a carbamoyl group having 1 to 20 carbon atoms, more preferably 1 to 12 carbon atoms. Examples of the carbamoyl group include (unsubstituted) carbamoyl and N-methylcarbamoyl.

The sulfamoyl group is preferably a sulfamoyl group having 20 or less carbon atoms, more preferably 12 or less carbon atoms. Examples of the sulfamoyl group include (unsubstituted) sulfamoyl and N-methylsulfamoyl.

The acyloxy group is preferably an acyloxy group having 1 to 20 carbon atoms, more preferably 2 to 12 carbon atoms. Examples of the acyloxy group include acetoxy and benzoyloxy.

The alkenyl group is preferably an alkenyl group having 2 to 20 carbon atoms, more preferably 2 to 12 carbon atoms. Examples of the alkenyl group include vinyl, allyl and isopropenyl.

The alkynyl group is preferably an alkynyl group having 2 to 20 carbon atoms, more preferably 2 to 12 carbon atoms. Examples of the alkynyl group include a thienyl group.

The alkylsulfonyl group is preferably an alkylsulfonyl group having 1 to 20 carbon atoms, more preferably 1 to 12 carbon atoms. Examples of the alkylsulfonyl group include a methanesulfonyl group.

The arylsulfonyl group is preferably an arylsulfonyl group having 6 to 20 carbon atoms, more preferably 6 to 12 carbon atoms. Examples of the arylsulfonyl group include a p-toluenesulfonyl group.

The alkyloxysulfonyl group is preferably an alkyloxysulfonyl group having 1 to 20 carbon atoms, more preferably 1 to 12 carbon atoms. Examples of the alkyloxysulfonyl group include a methylsulfuric acid group.

The aryloxysulfonyl group is preferably an aryloxysulfonyl group having 6 to 20 carbon atoms, more preferably 6 to 12 carbon atoms. Examples of the aryloxysulfonyl group include a phenylsulfuric acid group.

The alkylsulfonyloxy group is preferably an alkylsulfonyloxy group having 1 to 20 carbon atoms, more preferably 1 to 12 carbon atoms. Examples of the alkylsulfonyloxy group include a methanesulfonyloxy group.

The arylsulfonyloxy group is preferably an arylsulfonyloxy group having 6 to 20 carbon atoms, more preferably 6 to 12 carbon atoms. Examples of the arylsulfonyloxy group include a p-toluenesulfonyloxy group.

In formula (A), n is the number of substituents, and represents an integer of 0 to 5. The number of substituents Xs (n) substituting on the aromatic ring is preferably 1 to 5, more preferably 1 to 4, further preferably 1 to 3, and particularly preferably 1 or 2.

When the number of substituents substituting on the aromatic ring is 2 or more, the substituents may be the same or different from each other, or may be linked each other to form a condensed polycyclic compound (e.g., naphthalene group, indene group, indane group, phenanthrene group, quinoline group, isoquinoline group, chromene group, chroman group, phthalazine group, acridine group, indole group, and indoline group).

Specific examples of the aromatic acyl group represented by formula (A) are shown below, but the present invention is not limited thereto. Among the following specific examples, the exemplified group Nos. 1, 3, 5, 6, 8, 13, 18 and 28 are preferable; and the exemplified group Nos. 1, 3, 6 and 13 are more preferable.

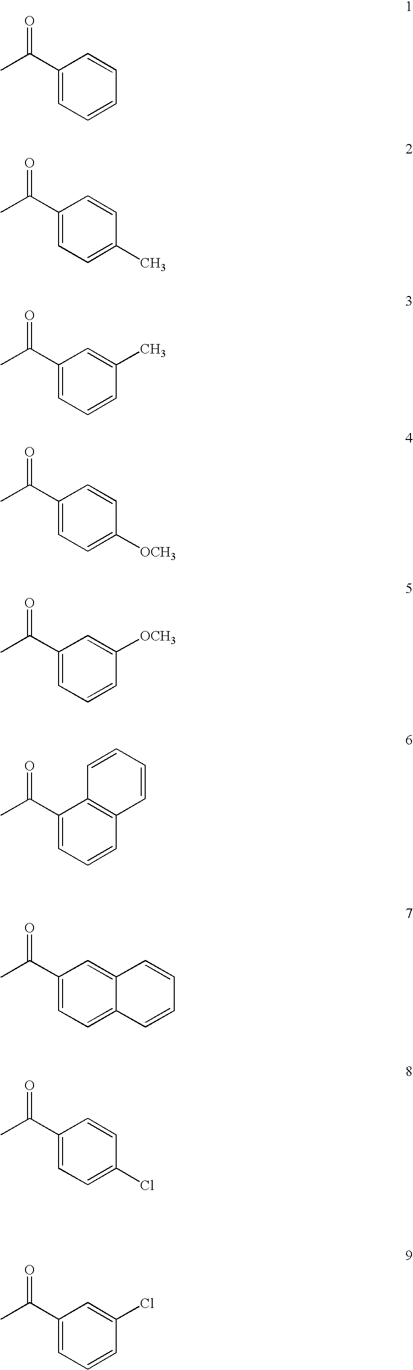

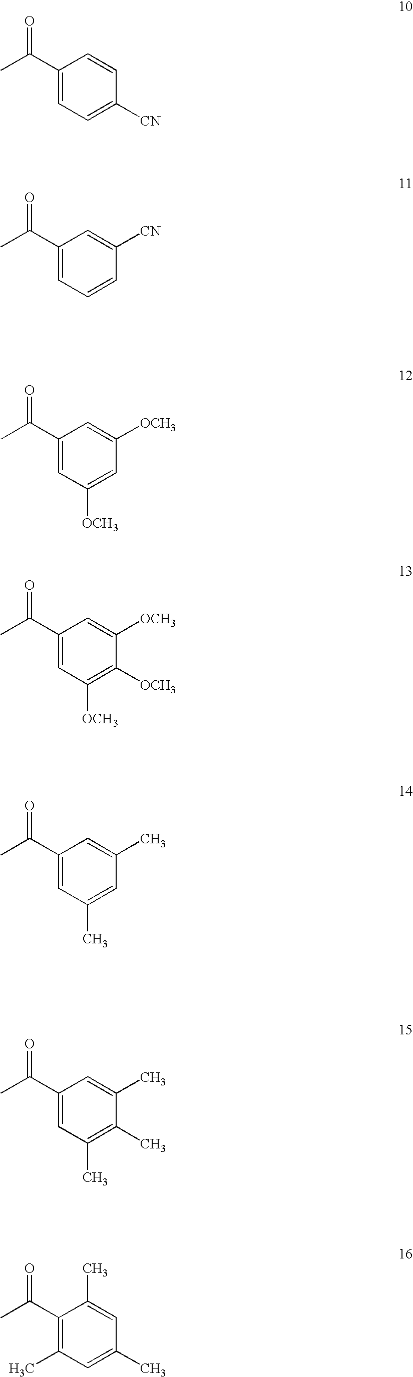

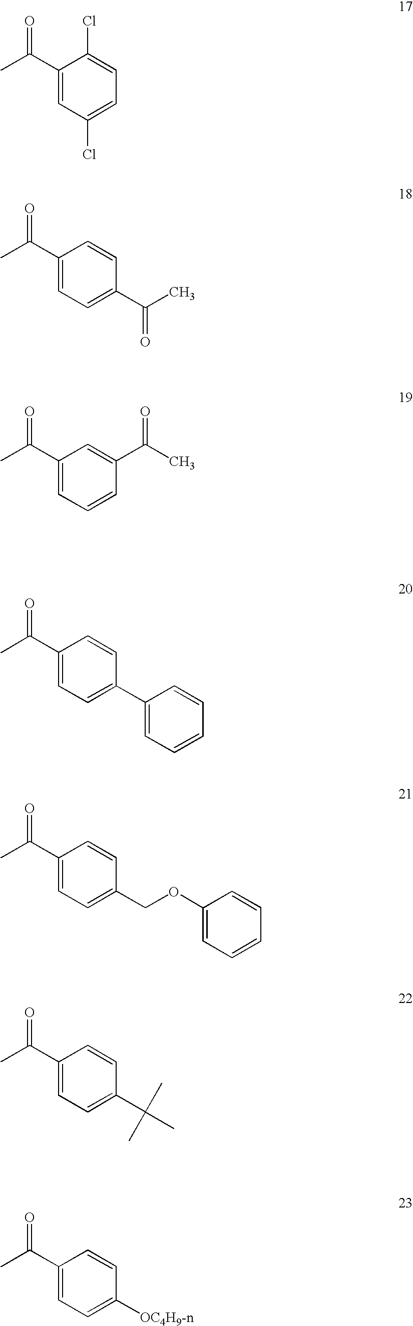

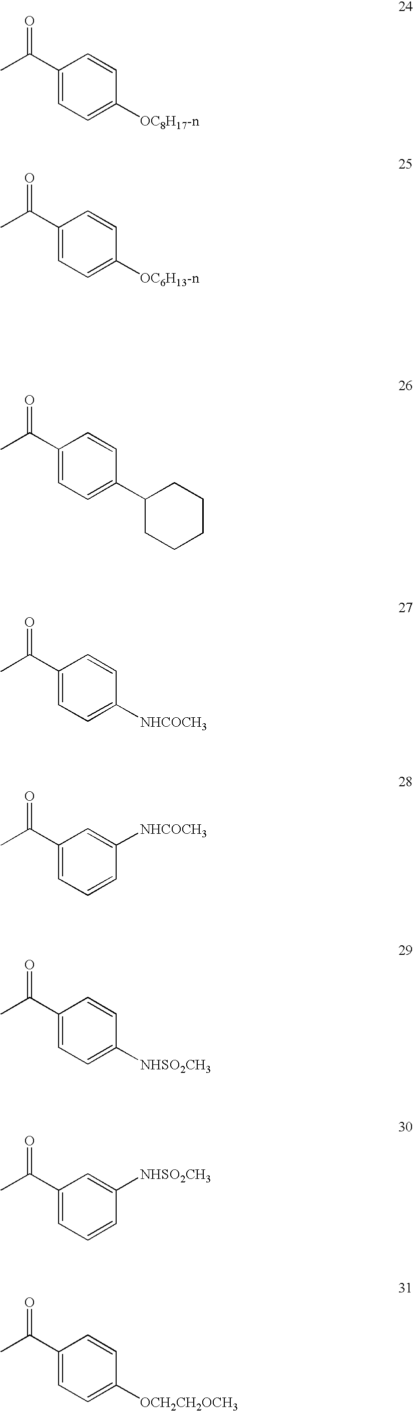

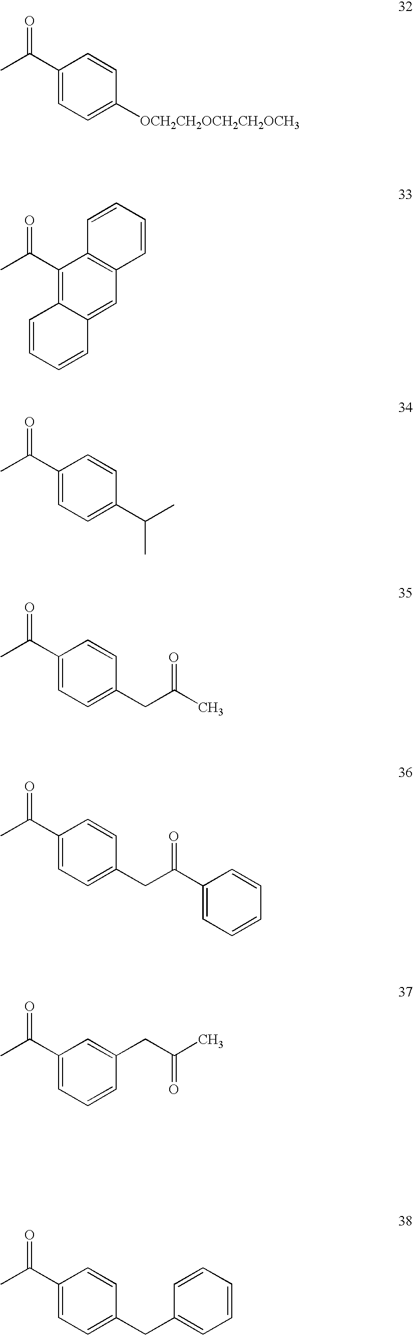

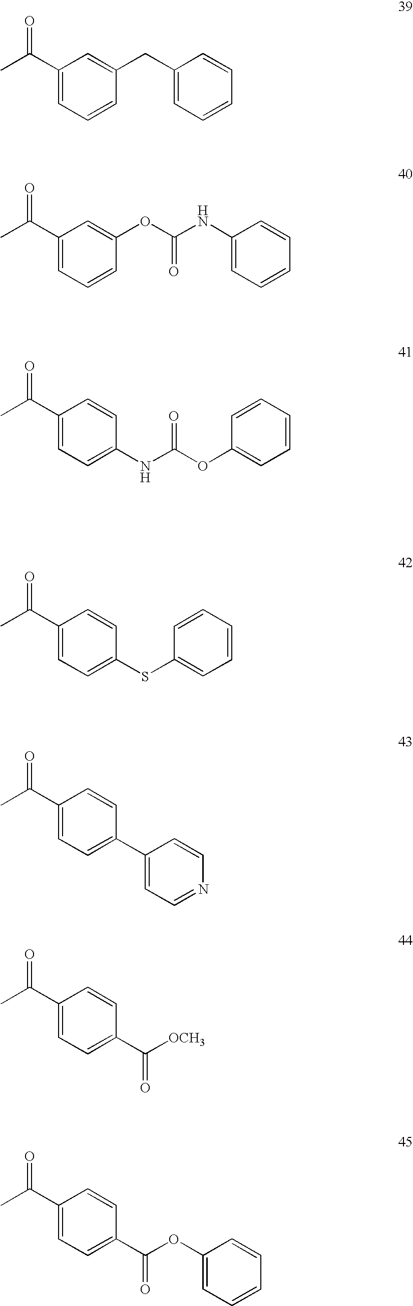

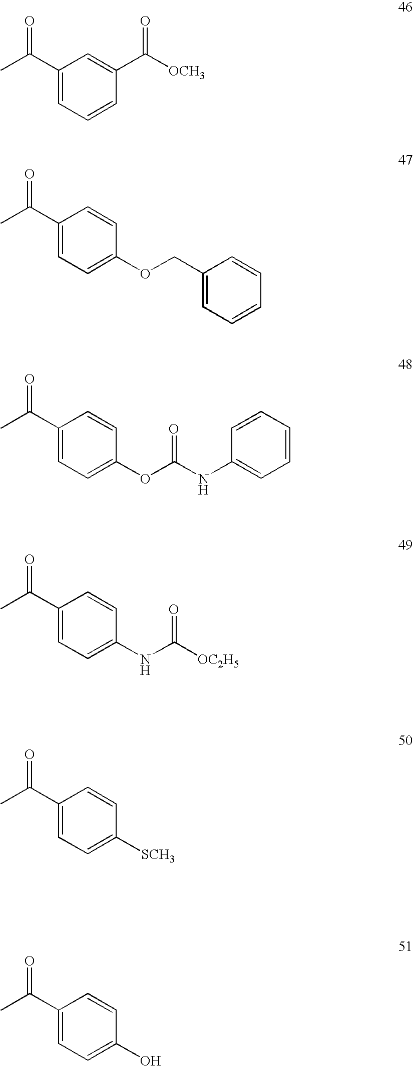

The cellulose-mixed acylate substituted by two kinds of acyl groups may be prepared by, for example, a method of reacting cellulose with a mixture of or sequentially added two kinds of carboxylic acid anhydrides as acylating agents, a method of using a mixed acid anhydride of two kinds of carboxylic acids (e.g., mixed acid anhydride of acetic acid and propionic acid), a method of reacting cellulose with a mixed acid anhydride (e.g., mixed acid anhydride of acetic acid and propionic acid) synthesized from a carboxylic acid and an acid anhydride of another carboxylic acid (e.g., acetic acid and propionic acid anhydride) within the reaction system, or a method of synthesizing cellulose acylate with a substitution degree of less than 3 and then further acylating the residual hydroxy groups using an acid anhydride or acid halide.

Specifically, the cellulose compound used in the present invention may be prepared, for example, from cellulose acetate having an acetyl substitution degree of 2.45 (manufactured by Aldrich), cellulose acetate having an acetyl substitution degree of 2.41 (trade name: L-70, manufactured by Daicel Chemical Industries, Ltd.) or 2.14 (trade name: LM-80, manufactured by Daicel Chemical Industries, Ltd.) as a starting material, through reaction with a corresponding acid chloride. Further, cellulose acetate having a low acetyl substitution degree may be prepared by synthesizing an intermediate having an acetyl substitution degree of 1.80 from microcrystalline cellulose, manufactured by Aldrich, as a starting material, by the method as will be described in the following Synthetic example 1, and reacting the intermediate with a corresponding acid chloride. Herein, the term “acetyl substitution degree” means a substitution degree of an acetyl group.

The cellulose compound (e.g. a cellulose acylate) that can be used in the present invention preferably has a mass average degree of polymerization of 100 to 700, and more preferably 180 to 550. Further, the cellulose acylate that can be used in the present invention preferably has a number average molecular weight of 70,000 to 230,000, more preferably 75,000 to 230,000, and most preferably 78,000 to 120,000.

Further, the cellulose compound that can be used in the present invention preferably has a narrow distribution of molecular weight, which is in terms of Mw/Mn (Mw is a mass average molecular weight, and Mn is a number average molecular weight) as evaluated by gel permeation chromatography. Specifically, the value of Mw/Mn is preferably from 1.0 to 5.0, more preferably from 1.5 to 3.5, and most preferably from 2.0 to 3.0.

[Additives]

(Retardation-Controlling Agent)

In the present invention, the cellulose compound film preferably contains a retardation-controlling agent. The retardation-controlling agent is a compound for reducing the retardation in the film thickness direction, and preferably a compound which satisfies the relationship as defined by mathematical formula (11-1):

$$\frac{Rth ( a ) - Rth ( 0 )}{a} ≦ - 1.5 \qquad Mathematical formula ( 11 \text{-} 1 )$$

in which, a is: 0.01≦a≦3.0

wherein Rth(a) is Rth (nm) of a cellulose acetate film at wavelength 589 nm, which has a film thickness of 80 μm and contains the retardation-controlling agent at an amount of a % by mass to cellulose acetate having an acetyl substitution degree of 2.86;

Rth(0) is Rth (nm) of a film at wavelength 589 nm, which has a film thickness of 80 μm and does not contain the retardation-controlling agent but is composed of cellulose acetate having an acetyl substitution degree of 2.86; and

a is part(s) by mass of the retardation-controlling agent to 100 parts by mass of cellulose acetate.

Through the use of the compound satisfying the relationship as defined by mathematical formula (11-1) as a retardation-controlling agent, Rth is sufficiently reduced, and a film exhibiting a desired Rth can be prepared without excessive use of retardation-controlling agents. As will be described below, Rth represents a retardation in the thickness direction.

In the present invention, Rth can be further reduced, by combining a cellulose compound having substituents large in polarizability anisotropy (or ‘high’ in polarizability anisotropy), with a compound which reduces Rth and satisfies the relationship as defined by mathematical formula (11-1) as a retardation-controlling agent.

The retardation-controlling agent more preferably satisfies the relationship as defined by mathematical formula (11-2), and further preferably satisfies the relationship as defined by mathematical formula (11-3):

$$\begin{matrix}\frac{Rth ( a ) - Rth ( 0 )}{a} ≦ - 2.0 & Mathematical formula ( 11 \text{-} 2 ) \\ \frac{Rth ( a ) - Rth ( 0 )}{a} ≦ - 2.5 & Mathematical formula ( 11 \text{-} 3 )\end{matrix}$$

in which, a is: 0.01≦a≦3.0

wherein Rth(a) is Rth (nm) of the cellulose acetate film at wavelength 589 nm, which has a film thickness of 80 μm and contains the retardation-controlling agent at an amount of a % by mass to cellulose acetate having an acetyl substitution degree of 2.86;

Rth(0) is Rth (nm) of the film at wavelength 589 nm, which has a film thickness of 80 μm and does not contain the retardation-controlling agent but is composed of cellulose acetate having an acetyl substitution degree of 2.86; and

a is part(s) by mass of the retardation-controlling agent to 100 parts by mass of cellulose acetate.

Further, the retardation-controlling agent that can be used in the present invention is preferably a compound which exhibits Re satisfying the relationship as defined by mathematical formula (10) at wavelength 589 nm when added in a cellulose acetate film having an acetyl substitution degree of 2.86. As will be described later, Re represents the retardation in the plane, i.e. an in-plane retardation.

$$\frac{\vert Re ( a ) - Re ( 0 ) \vert}{a} ≧ 1.0 \qquad Mathematical formula ( 10 )$$

wherein Re(a) is Re (nm) of the cellulose acetate film at wavelength 589 nm, which has a film thickness of 80 μm and contains the retardation-controlling agent at an amount of a % by mass to cellulose acetate having an acetyl substitution degree of 2.86;

Re(0) is Re (nm) of the film at wavelength 589 nm, which has a film thickness of 80 μm and does not contain the retardation-controlling agent but is composed of cellulose acetate having an acetyl substitution degree of 2.86; and

a is part(s) by mass of the retardation-controlling agent to 100 parts by mass of cellulose acetate.

Examples of the retardation-controlling agent satisfying the relationship as defined by mathematical formula (11-1) include following compounds represented by any one of formulae (1) to (19), but the invention is not limited to these compounds.

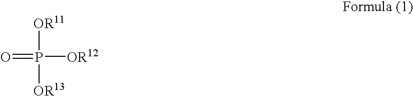

In formula (1), R¹¹ to R¹³ each independently represent an aliphatic group having 1 to 20 carbon atoms, and the aliphatic group may have a substituent. Alternatively, R¹¹ to R¹³ may be combined each other, to form a ring.

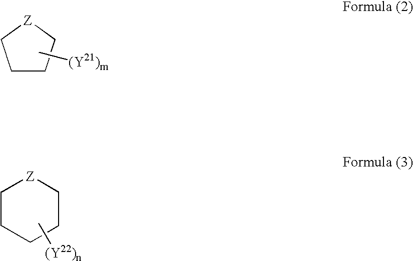

In formulae (2) and (3), Z represents a carbon atom, an oxygen atom, a sulfur atom, or —NR²⁵—; and R²⁵ represents a hydrogen atom or an alkyl group. The 5- or 6-membered ring constituted by containing Z may have a substituent. Y²¹ and Y²² each independently represent an ester group, an alkoxycarbonyl group, an amido group, or a carbamoyl group, each having 1 to 20 carbon atoms; or Y²¹s may be combined each other, to form a ring, and Y²²s may be combined each other, to form a ring. m represents an integer of 1 to 5, and n represents an integer of 1 to 6.

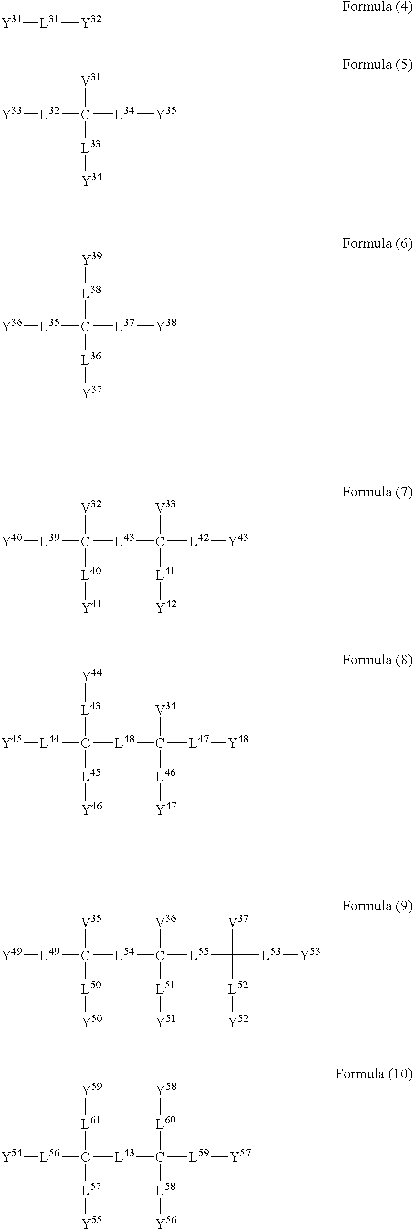

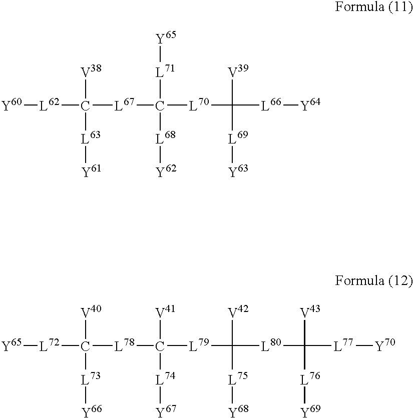

In formulae (4) to (12), Y³¹ to Y⁷⁰ each independently represent an ester group, an alkoxycarbonyl group, an amido group, or a carbamoyl group, each having 1 to 20 carbon atoms, or a hydroxy group; V³¹ to V⁴³ each independently represent a hydrogen atom or an aliphatic group having 1 to 20 carbon atoms. L³¹ to L⁸⁰ each independently represent a saturated divalent linking group that is composed of 0 to 40 atoms and has 0 to 20 carbon atoms. When L³¹ to L⁸⁰ are each composed of zero (0) atom, it means that L³¹ to L⁸⁰ each represent a single bond. V³¹ to V⁴³ and L³¹ to L⁸⁰ may further have a substituent.

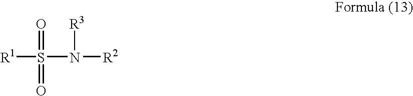

In formula (13), R¹ represents an alkyl group or an aryl group; R² and R³ each independently represent a hydrogen atom, an alkyl group, or an aryl group. The total of carbon atoms of R¹, R², and R³ is 10 or more, and the alkyl group and the aryl group each may have a substituent.

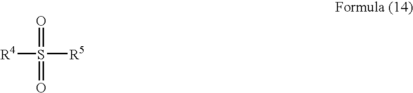

In formula (14), R⁴ and R⁵ each independently represent an alkyl group or an aryl group. The total of carbon atoms of R⁴ and R⁵ is 10 or more, and the alkyl group and the aryl group each may have a substituent.

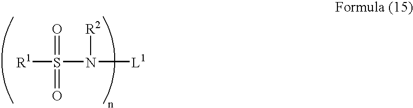

In formula (15), R¹ represents a substituted or unsubstituted aliphatic group, or a substituted or unsubstituted aromatic group; and R² represents a hydrogen atom, a substituted or unsubstituted aliphatic group, or a substituted or unsubstituted aromatic group. L¹ represents a divalent to hexavalent linking group. n represents an integer of 2 to 6 corresponding to the valency of L¹.

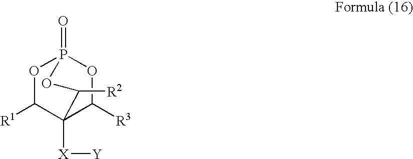

In formula (16), R¹, R² and R³ each independently represent a hydrogen atom or an alkyl group. X represents a divalent linking group formed with at least one selected from the following (Linking groups 1). Y represents a hydrogen atom, an alkyl group, an aryl group, or an aralkyl group.
(Linking groups 1) includes: single bond, —O—, —CO—, —NR⁴— (in which R⁴ represents a hydrogen atom, an alkyl group, an aryl group, or an aralkyl group.), an alkylene group, and an arylene group.

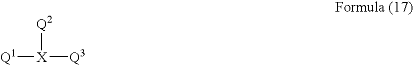

In formula (17), Q¹, Q² and Q³ each independently represent a 5- or 6-membered ring; X represents B, C—R, N, P or P═O; and R represents a hydrogen atom or a substituent.

Preferred examples of the compound represented by formula (17) include a compound represented by formula (17a).

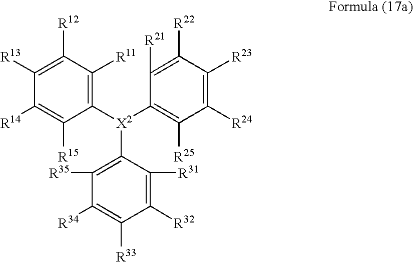

In formula (17a), X² represents B, C—R, N, P, or P═O, in which R represents a hydrogen atom or a substituent; R¹¹, R¹², R¹³, R¹⁴, R¹⁵, R²¹, R²², R²³, R²⁴, R²⁵, R³¹, R³², R³³, R³⁴, and R³⁵ each independently represent a hydrogen atom or a substituent.

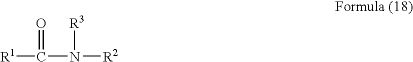

In formula (18), R¹ represents an alkyl group or an aryl group; R² and R³ each independently represent a hydrogen atom, an alkyl group, or an aryl group; and the alkyl group and the aryl group each may have a substituent.

Preferred examples of the compound represented by formula (18) include a compound represented by formula (18a).

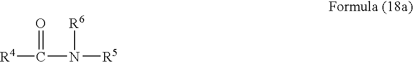

In formula (18a), R⁴, R⁵, and R⁶ each independently represent an alkyl group or an aryl group. The alkyl group may be linear, branched, or cyclic, and preferably has 1 to 20 carbon atoms, more preferably 1 to 15 carbon atoms, and most preferably 1 to 12 carbon atoms. The cyclic alkyl group is particularly preferably a cyclohexyl group. The aryl group preferably has 6 to 36 carbon atoms, and more preferably 6 to 24 carbon atoms. The alkyl group and the aryl group may have a substituent.

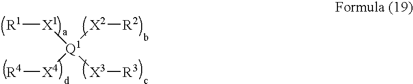

In formula (19), R¹, R², R³, and R⁴ each independently represent a hydrogen atom, a substituted or unsubstituted aliphatic group, or a substituted or unsubstituted aromatic group. X¹, X², X³, and X⁴ each independently represent a divalent linking group formed by at least one selected from the group consisting of a single bond, —CO—, and —NR⁵— (in which R⁵ represents a substituted or unsubstituted aliphatic group, or a substituted or unsubstituted aromatic group). a, b, c, and d each are an integer of 0 or more, and (a+b+c+d) is 2 or more. Q¹ represents an organic group having the valency of (a+b+c+d).

The compound represented by formula (1) is described below.

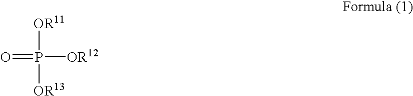

In formula (1), R¹¹ to R¹³ each independently represent an aliphatic group having 1 to 20 carbon atoms, and the aliphatic group may have a substituent; or R¹¹ to R¹³ may be combined each other, to form a ring.

R¹¹ to R¹³ are further described below. R¹¹ to R¹³ are each preferably an aliphatic group having 1 to 20 carbon atoms, more preferably 1 to 16 carbon atoms, and particularly preferably 1 to 12 carbon atoms. Herein, the aliphatic group is preferably an aliphatic hydrocarbon group, and more preferably an alkyl group (including linear, branched, and cyclic alkyl groups), an alkenyl group, or an alkynyl group. Examples of the alkyl group include methyl, ethyl, n-propyl, isopropyl, n-butyl, isobutyl, sec-butyl, tert-butyl, n-pentyl, tert-amyl, n-hexyl, n-octyl, decyl, dodecyl, eicosyl, 2-ethylhexyl, cyclopentyl, cyclohexyl, cycloheptyl, 2,6-dimethyl-cyclohexenyl, 4-tert-butyl-cyclohexyl, cyclopentyl, 1-adamantyl, 2-adamantyl, and bicyclo[2.2.2]octan-3-yl. Examples of the alkenyl group include vinyl, allyl, prenyl, geranyl, oreyl, 2-cyclopentene-1-yl, and 2-cyclohexene-1-yl. Examples of the alkynyl group include ethynyl and propargyl.

The aliphatic group represented by any of R¹¹ to R¹³ may have a substituent. Examples of the substituent include a halogen atom (a fluorine, chlorine, bromine, or iodine atom), an alkyl group (any of linear, branched, or cyclic alkyl groups including a bicycloalkyl group and an active methine group), an alkenyl group, an alkynyl group, an aryl group, a heterocyclic group (any substitution position is permitted), an acyl group, an alkoxycarbonyl group, an aryloxycarbonyl group, a heterocyclic oxycarbonyl group, a carbamoyl group, an N-acylcarbamoyl group, an N-sulfonylcarbamoyl group, an N-carbamoylcarbamoyl group, an N-sulfamoylcarbamoyl group, a carbazoyl group, a carboxyl group or a salt thereof, an oxalyl group, an oxamoyl group, a cyano group, a carbonimidoyl group, a formyl group, a hydroxyl group, an alkoxy group (including a group containing ethyleneoxy or propyleneoxy units as repeating units), an aryloxy group, a heterocyclic oxy group, an acyloxy group, an alkoxy- or aryloxy-carbonyloxy group, a carbamoyloxy group, a sulfonyloxy group, an amino group, an alkyl-, aryl- or heterocyclic-amino group, an acylamino group, a sulfonamido group, a ureido group, a thioureido group, an imido group, an alkoxy- or aryloxy-carbonylamino group, a sulfamoylamino group, a semicarbazido group, an ammonio group, an oxamoylamino group, an N-(alkyl- or aryl-)sulfonylureido group, an N-acylureido group, an N-acylsulfamoylamino group, a heterocyclic group containing a quaternary nitrogen atom (e.g., a pyridinio group, an imidazolio group, a quinolinio group, or an isoquinolinio group), an isocyano group, an imino group, an alkyl- or aryl-sulfonyl group, an alkyl- or aryl-sulfinyl group, a sulfo group or a salt thereof, a sulfamoyl group, an N-acylsulfamoyl group, an N-sulfonylsulfamoyl group or a salt thereof, a phosphino group, a phosphinyl group, a phosphinyloxy group, a phosphinylamino group, and a silyl group.

The above groups may be further combined, to form a complex substituent. Examples of the substituent include an ethoxyethoxyethyl group, a hydroxyethoxyethyl group, and an ethoxycarbonylethyl group. Further, R¹¹ to R¹³ may contain a phosphate ester group as a substituent, and the compound represented by formula (1) may have a plurality of phosphoric ester groups in the molecule.

Specific examples of the compound represented by formula (1) (C-1 to C-76) are shown below, but the invention is not limited to them. The octanol-water partition coefficients (log P values) were determined by the Crippen's fragmentation method (J. Chem. Inf. Comput. Sci., 27, 21 (1987)).

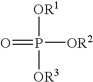

In the above formula, R¹ to R³ have the same meanings as the R¹¹ to R¹³ in formula (1), respectively; and specific examples are exemplified with the following C-1 to C-76.

| compound | R¹ | R² | R³ | logP |
|---|---|---|---|---|
| C-1 | CH₃ | C₂H₅ | C₂H₅ | 1.24 |
| C-2 | C₂H₅ | C₂H₅ | C₂H₅ | 1.58 |
| C-3 | C₃H₇ | C₃H₇ | C₃H₇ | 2.99 |
| C-4 | i-C₃H₇ | i-C₃H₇ | i-C₃H₇ | 2.82 |
| C-5 | C₄H₉ | C₄H₉ | C₄H₉ | 4.18 |
| C-6 | i-C₄H₉ | i-C₄H₉ | i-C₄H₉ | 4.2 |
| C-7 | s-C₄H₉ | s-C4H₉ | s-C₄H₉ | 4.23 |
| C-8 | t-C₄H₉ | t-C₄H₉ | t-C₄H₉ | 3.06 |
| C-9 | C₅H₁₁ | C₅H₁₁ | C₅H₁₁ | 5.37 |
| C-10 | CH₂C(CH₃)₃ | CH₂C(CH₃)₃ | CH₂C(CH₃)₃ | 5.71 |
| C-11 | c-C₅H₉ | c-C₅H₉ | c-C₅H₉ | 4.12 |
| C-12 | 1-ethylpropyl | 1-ethylpropyl | 1-ethylpropyl | 5.63 |
| C-13 | C₆H₁₃ | C₆H₁₃ | C₆H₁₃ | 6.55 |
| C-14 | c-C₆H₁₁ | c-C₆H₁₁ | c-C₆H₁₁ | 5.31 |
| C-15 | C₇H₁₅ | C₇H₁₅ | C₇H₁₅ | 7.74 |
| C-16 | 4-methylcyclohexyl | 4-methylcyclohexyl | 4-methylcyclohexyl | 6.3 |
| C-17 | 4-t-butylcyclohexyl | 4-t-butylcyclohexyl | 4-t-butylcyclohexyl | 9.78 |
| C-18 | C₈H₁₇ | C₈H₁₇ | C₈H₁₇ | 8.93 |
| C-19 | 2-ethylhexyl | 2-ethylhexyl | 2-ethylhexyl | 8.95 |
| C-20 | 3-methylbutyl | 3-methylbutyl | 3-methylbutyl | 5.17 |
| C-21 | 1,3-dimethylbutyl | 1,3-dimethylbutyl | 1,3-dimethylbutyl | 6.41 |
| C-22 | 1-isopropyl-2-methylpropyl | 1-isopropyl-2-methylpropyl | 1-isopropyl-2-methylpropyl | 8.05 |
| C-23 | 2-ethylbutyl | 2-ethylbutyl | 2-ethylbutyl | 6.57 |
| C-24 | 3,5,5-trimethylhexyl | 3,5,5-trimethylhexyl | 3,5,5-trimethylhexyl | 9.84 |
| C-25 | cyclohexylmethyl | cyclohexylmethyl | cyclohexylmethyl | 6.25 |
| C-26 | CH₃ | CH₃ | 2-ethylhexyl | 3.35 |
| C-27 | CH₃ | CH₃ | 1-adamantyl | 2.27 |
| C-28 | CH₃ | CH₃ | C₁₂H₂₅ | 4.93 |
| C-29 | C₂H₅ | C₂H₅ | 2-ethylhexyl | 4.04 |
| C-30 | C₂H₅ | C₂H₅ | 1-adamantyl | 2.96 |
| C-31 | C₂H₅ | C₂H₅ | C₁₂H₂₅ | 5.62 |
| C-32 | C₄H₉ | C₄H₉ | cyclohexyl | 4.55 |
| C-33 | C₄H₉ | C₄H₉ | C₆H₁₃ | 4.97 |
| C-34 | C₄H₉ | C₄H₉ | C₈H₁₇ | 5.76 |
| C-35 | C₄H₉ | C₄H₉ | 2-ethylhexyl | 5.77 |
| C-36 | C₄H₉ | C₄H₉ | C₁₀H₂₁ | 6.55 |
| C-37 | C₄H₉ | C₄H₉ | C₁₂H₂₅ | 7.35 |
| C-38 | C₄H₉ | C₄H₉ | 1-adamantyl | 4.69 |
| C-39 | C₄H₉ | C₄H₉ | C₁₆H₃₃ | 8.93 |
| C-40 | C₄H₉ | C₄H₉ | dicyclopentadienyl | 4.68 |
| C-41 | C₆H₁₃ | C₆H₁₃ | C₁₄H₂₉ | 9.72 |
| C-42 | C₆H₁₃ | C₆H₁₃ | C₈H₁₇ | 7.35 |
| C-43 | C₆H₁₃ | C₆H₁₃ | 2-ethylhexyl | 7.35 |
| C-44 | C₆H₁₃ | C₆H₁₃ | C₁₀H₂₁ | 8.14 |
| C-45 | C₆H₁₃ | C₆H₁₃ | C₁₂H₂₅ | 8.93 |
| C-46 | C₆H₁₃ | C₆H₁₃ | 1-adamantyl | 6.27 |
| C-47 | 4-chlorobutyl | 4-chlorobutyl | 4-chlorobutyl | 4.18 |
| C-48 | 4-chlorohexyl | 4-chlorohexyl | 4-chlorohexyl | 6.55 |
| C-49 | 4-bromobutyl | 4-bromobutyl | 4-bromobutyl | 4.37 |
| C-50 | 4-bromohexyl | 4-bromohexyl | 4-bromohexyl | 6.74 |
| C-51 | (CH₂)₂OCH₂CH₃ | (CH₂)₂OCH₂CH₃ | (CH₂)₂OCH₂CH₃ | 1.14 |
| C-52 | C₈H₁₇ | C₈H₁₇ | (CH₂)₂O(CH₂)₂OCH₂CH₃ | 6.55 |
| C-53 | C₆H₁₃ | C₆H₁₃ | (CH₂)₂O(CH₂)₂OCH₂CH₃ | 4.96 |
| C-54 | C₄H₉ | C₄H₉ | (CH₂)₂O(CH₂)₂OCH₂CH₃ | 3.38 |
| C-55 | C₄H₉ | C₄H₉ | (CH₂)₂O(CH₂)₂OCH₂OH | 2.59 |
| C-56 | C₆H₁₃ | C₆H₁₃ | (CH₂)₂O(CH₂)₂OCH₂OH | 4.18 |
| C-57 | C₈H₁₇ | C₈H₁₇ | (CH₂)₂O(CH₂)₂OCH₂OH | 5.76 |
| C-58 | C₄H₉ | (CH₂)₂O(CH₂)₂ | (CH₂)₂O(CH₂)₂OCH₂OH | 2.2 |
| | | OCH₂OH | | |
| C-59 | C₄H₉ | C₄H₉ | CH₂CH═CH₂ | 4.19 |
| C-60 | C₄H₉ | CH₂CH═CH₂ | CH₂CH═CH₂ | 3.64 |
| C-61 | (CH₂)₂CO₂CH₂CH₃ | (CH₂)₂CO₂CH₂CH₃ | (CH₂)₂CO₂CH₂CH₃ | 1.1 |
| C-62 | (CH₂)₂CO₂(CH₂)₃CH₃ | (CH₂)₂CO₂(CH₂)₃CH₃ | (CH₂)₂CO₂(CH₂)₃CH₃ | 3.69 |
| C-63 | (CH₂)₂CONH(CH₂)₃CH₃ | (CH₂)₂CONH(CH₂)₃CH₃ | (CH₂)₂CONH(CH₂)₃CH₃ | 1.74 |
| C-64 | C₄H₉ | C₄H₉ | (CH₂)₄OP═O(OC₄H₉)₂ | 6.66 |
| C-65 | C4H₉ | C₄H₉ | (CH₂)₃OP═O(OC₄H₉)₂ | 6.21 |
| C-66 | C₄H₉ | C₄H₉ | (CH₂)₂OP═O(OC₄H₉)₂ | 6.16 |
| C-67 | C₄H₉ | C4H₉ | (CH2)₂O(CH₂)₂OP═O(OC₄H₉)₂ | 5.99 |
| C-68 | C₆H₁₃ | C₆H₁₃ | (CH₂)₂O(CH₂)₂OP═O(OC₄H₉)₂ | 7.58 |
| C-69 | C₆H₁₃ | C₆H₁₃ | (CH₂)₄OP═O(OC₄H₉)₂ | 8.25 |
| C-70 | c-C₆H₁₃ | c-C₆H₁₃ | (CH₂)₂O(CH₂)₂OP═O(OC₄H₉)₂ | 6.35 |
| C-71 | C₆H₁₂Cl | C₆H₁₂Cl | (CH₂)₂O(CH₂)₂OP═O(OC₄H₉)₂ | 7.18 |
| C-72 | C₄H₈Cl | C₄H₈Cl | (CH₂)₂O(CH₂)₂OP═O(OC₄H₉)₂ | 5.6 |
| C-73 | C₄H₈Cl | C₄H₈Cl | (CH₂)₂O(CH₂)₂OP═O(OC₄H₈Cl)₂ | 5.59 |
| C-74 | C₄H₉ | C₄H₉ | 2-tetrahydrofuranyl | 3.27 |
| C-75 | C₄H₉ | 2-tetrahydrofuranyl | 2-tetrahydrofuranyl | 2.36 |
| C-76 | 2-tetrahydrofuranyl | 2-tetrahydrofuranyl | 2-tetrahydrofuranyl | 1.45 |

The compound represented by formula (2) or (3) is described below.

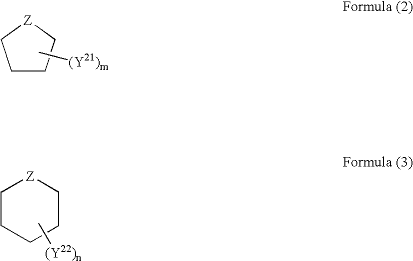

In formulae (2) and (3), Z represents a carbon atom, an oxygen atom, a sulfur atom, or —NR²⁵—, in which R²⁵ represents a hydrogen atom or an alkyl group. The 5- or 6-membered ring formed by containing Z may have a substituent, or a plurality of substituents may be combined each other to form a ring. Examples of the 5- or 6-membered ring containing Z include tetrahydrofuran, tetrahydropyran, tetrahydrothiophene, thiane, pyrrolidine, piperidine, indoline, isoindoline, chroman, isochroman, tetrahydro-2-furanone, tetrahydro-2-pyrone, 4-butanelactam, and 6-hexanolactam.

Further, the 5- or 6-membered ring containing Z also include a lactone structure or lactam structure, more specifically a cyclic ester or cyclic amide structure having an oxo group at the carbon adjacent to Z. Examples of the cyclic ester or cyclic amide structure include 2-pyrrolidone, 2-piperidone, 5-pentanolide, and 6-hexanolide.

R²⁵ represents a hydrogen atom, or an alkyl group having preferably 1 to 20 carbon atoms, more preferably 1 to 16 carbon atoms, and particularly preferably 1 to 12 carbon atoms (including linear, branched, and cyclic alkyl groups). Examples of the alkyl group represented by R²⁵ include methyl, ethyl, n-propyl, isopropyl, n-butyl, isobutyl, sec-butyl, tert-butyl, n-pentyl, tert-amyl, n-hexyl, n-octyl, decyl, dodecyl, eicosyl, 2-ethylhexyl, cyclopentyl, cyclohexyl, cycloheptyl, 2,6-dimethylcyclohexyl, 4-tert-butylcyclohexyl, cyclopentyl, 1-adamantyl, 2-adamantyl, and bicyclo[2.2.2]octan-3-yl. Further, the alkyl group represented by R²⁵ may further have a substituent, and examples of the substituent include those which the R¹¹ to R¹³ may possess thereon.

Y²¹ and Y²² each independently represent an ester group, an alkoxycarbonyl group, an amido group, or a carbamoyl group.

The ester group is an ester group having preferably 1 to 20 carbon atoms, more preferably 1 to 16 carbon atoms, and particularly preferably 1 to 12 carbon atoms. Examples of the ester group include acetoxy, ethylcarbonyloxy, propylcarbonyloxy, n-butylcarbonyloxy, iso-butylcarbonyloxy, t-butylcarbonyloxy, sec-butylcarbonyloxy, n-pentylcarbonyloxy, tert-amylcarbonyloxy, n-hexylcarbonyloxy, cyclohexylcarbonyloxy, 1-ethylpentylcarbonyloxy, n-heptylcarbonyloxy, n-nonylcarbonyloxy, n-undecylcarbonyloxy, benzylcarbonyloxy, 1-naphthalenecarbonyloxy, 2-naphthalenecarbonyloxy, and 1-adamantanecarbonyloxy.

The alkoxycarbonyl group is an alkoxycarbonyl group having preferably 1 to 20 carbon atoms, more preferably 1 to 16 carbon atoms, and particularly preferably 1 to 12 carbon atoms. Examples of the alkoxycarbonyl group include methoxycarbonyl, ethoxycarbonyl, n-propyloxycarbonyl, isopropyloxycarbonyl, n-butoxycarbonyl, t-butoxycarbonyl, isobutyloxycarbonyl, sec-butyloxycarbonyl, n-pentyloxycarbonyl, tert-amyloxycarbonyl, n-hexyloxycarbonyl, cyclohexyloxycarbonyl, 2-ethylhexyloxycarbonyl, 1-ethylpropyloxycarbonyl, n-octyloxycarbonyl, 3,7-dimethyl-3-octyloxycarbonyl, 3,5,5-trimethylhexyloxycarbonyl, 4-t-butylcyclohexyloxycarbonyl, 2,4-dimethylpentyl-3-oxycarbonyl, 1-adamantaneoxycarbonyl, 2-adamantaneoxycarbonyl, dicyclopentadienyloxycarbonyl, n-decyloxycarbonyl, n-dodecyloxycarbonyl, n-tetradecyloxycarbonyl, n-hexadecyloxycarbonyl.

The amido group is an amido group having preferably 1 to 20 carbon atoms, more preferably 1 to 16 carbon atoms, and particularly preferably 1 to 12 carbon atoms. Examples of the amido group include acetamido, ethylcarboxyamido, n-propylcarboxyamido, isopropylcarboxyamido, n-butylcarboxyamido, t-butylcarboxyamido, iso-butylcarboxyamido, sec-butylcarboxyamido, n-pentylcarboxyamido, tert-amylcarboxyamido, n-hexylcarboxyamido, cyclohexylcarboxyamido, 1-ethylpentylcarboxyamido, 1-ethylpropylcarboxyamido, n-heptylcarboxyamido, n-octylcarboxyamido, 1-adamantanecarboxyamido, 2-adamantanecarboxyamido, n-nonylcarboxyamido, n-dodecylcarboxyamido, n-pentacarboxyamido, and n-hexadecylcarboxyamido.

The carbamoyl group is a carbamoyl group having preferably 1 to 20 carbon atoms, more preferably 1 to 16 carbon atoms, and particularly preferably 1 to 12 carbon atoms. Examples of the carbamoyl group include methylcarbamoyl, dimethylcarbamoyl, ethylcarbamoyl, diethylcarbamoyl, n-propylcarbamoyl, isopropylcarbamoyl, n-butylcarbamoyl, t-butylcarbamoyl, iso-butylcarbamoyl, sec-butylcarbamoyl, n-pentylcarbamoyl, tert-amylcarbamoyl, n-hexylcarbamoyl, cyclohexylcarbamoyl, 2-ethylhexylcarbamoyl, 2-ethylbutylcarbamoyl, t-octylcarbamoyl, n-heptylcarbamoyl, n-octylcarbamoyl, 1-adamantanecarbamoyl, 2-adamantanecarbamoyl, n-decylcarbamoyl, n-dodecylcarbamoyl, n-tetradecylcarbamoyl, and n-hexadecylcarbamoyl.

Y²¹s may be combined each other, to form a ring, and Y²²s may be combined each other, to form a ring. Further, Y²¹ and Y²² may have a substituent, and examples of the substituent include those which the R¹¹ to R¹³ may possess thereon.

Examples of the compound represented by formula (2) or (3) (C-201 to C-231) are shown below, but the invention is not limited to them. The octanol-water partition coefficients (log P values), as shown in parenthesis, were determined by the Crippen's fragmentation method (J. Chem. Inf. Comput. Sci., 27, 21 (1987)).

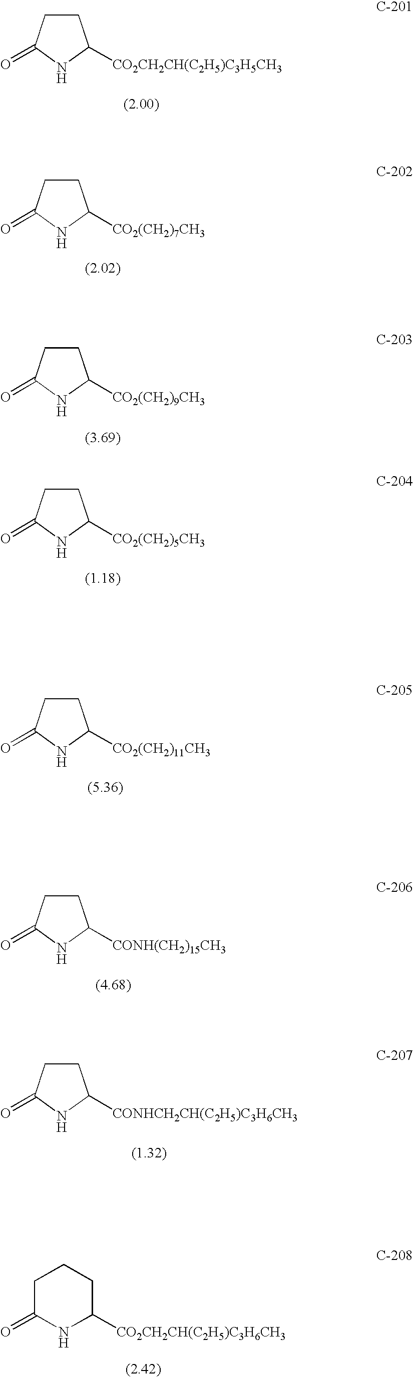

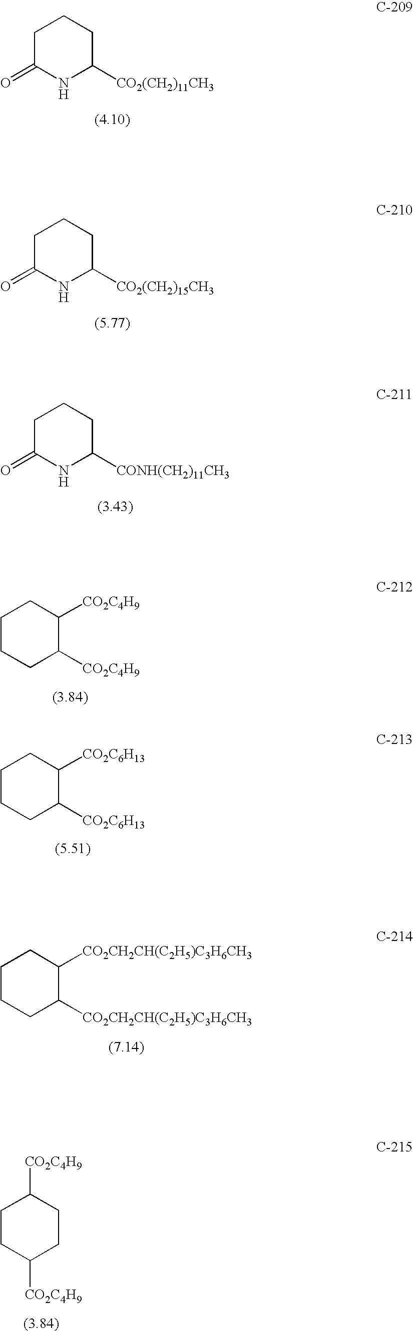

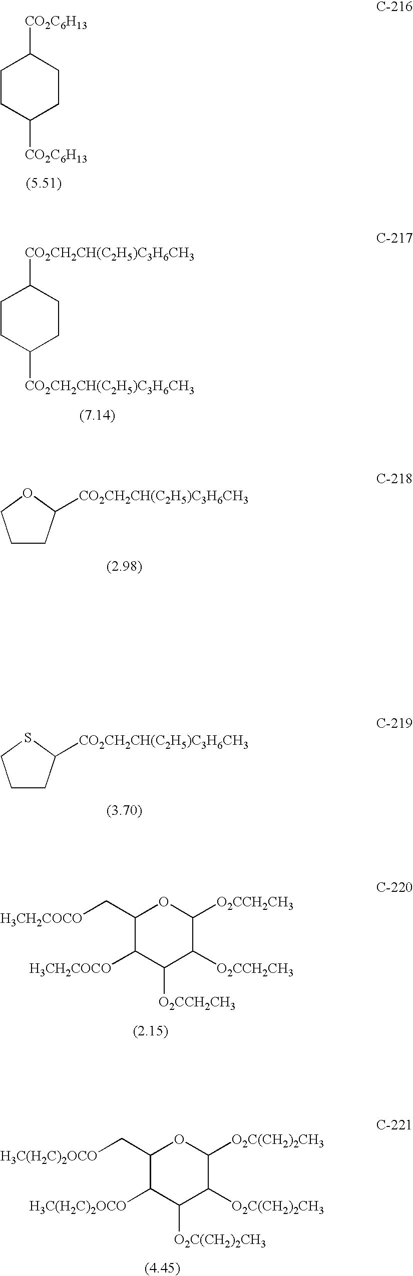

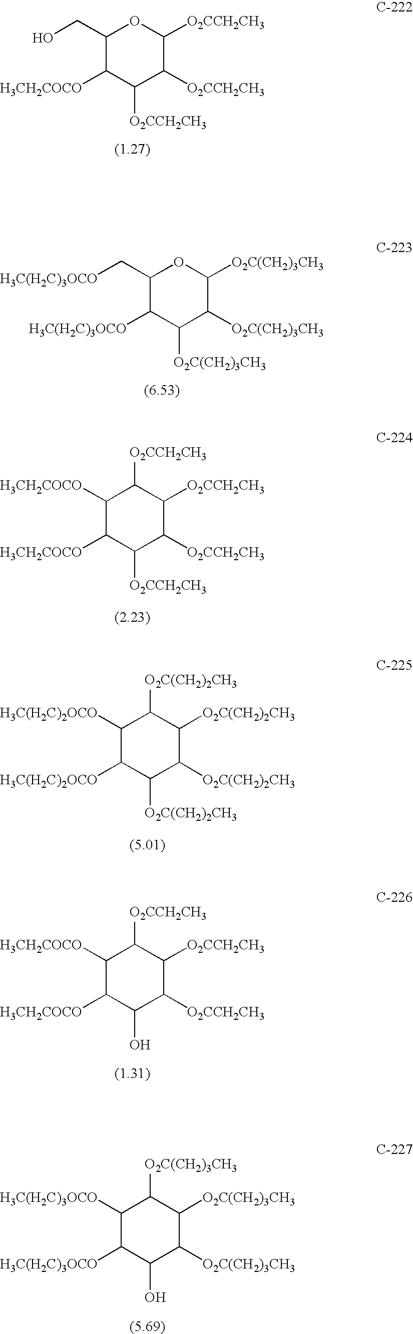

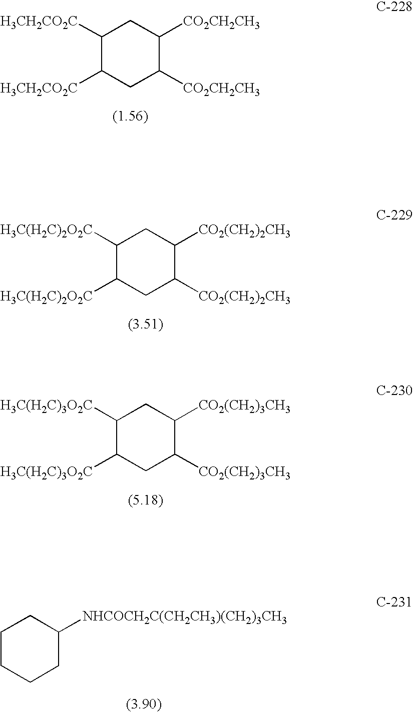

The compounds represented by any one of formulas (4) to (12) are explained below.

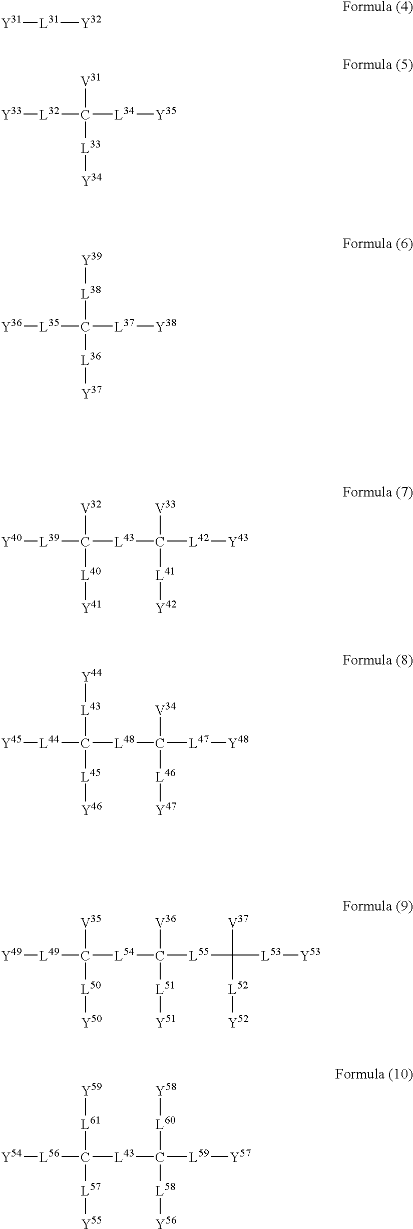

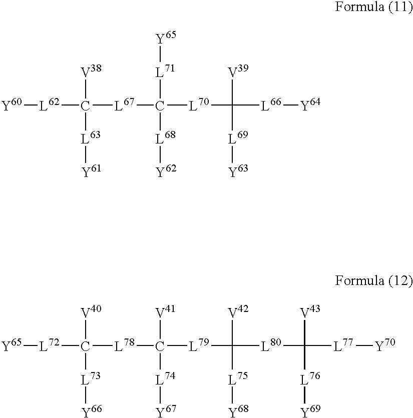

In formulas (4) to (12), Y³¹ to Y⁷⁰ each independently represent an ester group, an alkoxycarbonyl group, an amido group, a carbamoyl group, or a hydroxyl group.

The ester group is an ester group having preferably 1 to 20 carbon atoms, more preferably 1 to 16 carbon atoms, and particularly preferably 1 to 12 carbon atoms. Examples of the ester group include acetoxy, ethylcarbonyloxy, propylcarbonyloxy, n-butylcarbonyloxy, iso-butylcarbonyloxy, t-butylcarbonyloxy, sec-butylcarbonyloxy, n-pentylcarbonyloxy, tert-amylcarbonyloxy, n-hexylcarbonyloxy, cyclohexylcarbonyloxy, 1-ethylpentylcarbonyloxy, n-heptylcarbonyloxy, n-nonylcarbonyloxy, n-undecylcarbonyloxy, benzylcarbonyloxy, 1-naphthalenecarbonyloxy, 2-naphthalenecarbonyloxy, and 1-adamantanecarbonyloxy.

The alkoxycarbonyl group is an alkoxycarbonyl group having preferably 1 to 20 carbon atoms, more preferably 1 to 16 carbon atoms, and particularly preferably 1 to 12 carbon atoms. Examples of the alkoxycarbonyl group include methoxycarbonyl, ethoxycarbonyl, n-propyloxycarbonyl, isopropyloxycarbonyl, n-butoxycarbonyl, t-butoxycarbonyl, iso-butyloxycarbonyl, sec-butyloxycarbonyl, n-pentyloxycarbonyl, tert-amyloxycarbonyl, n-hexyloxycarbonyl, cyclohexyloxycarbonyl, 2-ethylhexyloxycarbonyl, 1-ethylpropyloxycarbonyl, n-octyloxycarbonyl, 3,7-dimethyl-3-octyloxycarbonyl, 3,5,5-trimethylhexyloxycarbonyl, 4-t-butylcyclohexyloxycarbonyl, 2,4-dimethylpentyl-3-oxycarbonyl, 1-adamantaneoxycarbonyl, 2-adamantaneoxycarbonyl, dicyclopentadienyloxycarbonyl, n-decyloxycarbonyl, n-dodecyloxycarbonyl, n-tetradecyloxycarbonyl, and n-hexadecyloxycarbonyl.

The amido group is an amido group having preferably 1 to 20 carbon atoms, more preferably 1 to 16 carbon atoms, and particularly preferably 1 to 12 carbon atoms. Examples of the amido group include acetamido, ethylcarboxyamido, n-propylcarboxyamido, isopropylcarboxyamido, n-butylcarboxyamido, t-butylcarboxyamido, iso-butylcarboxyamido, sec-butylcarboxyamido, n-pentylcarboxyamido, tert-amylcarboxyamido, n-hexylcarboxyamido, cyclohexylcarboxyamido, 1-ethylpentylcarboxyamido, 1-ethylpropylcarboxyamido, n-heptylcarboxyamido, n-octylcarboxyamido, 1-adamantanecarboxyamido, 2-adamantanecarboxyamido, n-nonylcarboxyamido, n-dodecylcarboxyamido, n-pentacarboxyamido, and n-hexadecylcarboxyamido.

The carbamoyl group is a carbamoyl group having preferably 1 to 20 carbon atoms, more preferably 1 to 16 carbon atoms, and particularly preferably 1 to 12 carbon atoms. Examples of the carbamoyl group include methylcarbamoyl, dimethylcarbamoyl, ethylcarbamoyl, diethylcarbamoyl, n-propylcarbamoyl, isopropylcarbamoyl, n-butylcarbamoyl, t-butylcarbamoyl, iso-butylcarbamoyl, sec-butylcarbamoyl, n-pentylcarbamoyl, tert-amylcarbamoyl, n-hexylcarbamoyl, cyclohexylcarbamoyl, 2-ethylhexylcarbamoyl, 2-ethylbutylcarbamoyl, t-octylcarbamoyl, n-heptylcarbamoyl, n-octylcarbamoyl, 1-adamantanecarbamoyl, 2-adamantanecarbamoyl, n-decylcarbamoyl, n-dodecylcarbamoyl, n-tetradecylcarbamoyl, and n-hexadecylcarbamoyl.

Y³¹ and Y⁷⁰ may have a substituent, and examples of the substituent include those which the R¹¹ to R¹³ may possess thereon.

V³¹ to V⁴³ each independently represent a hydrogen atom, or an aliphatic group having preferably 1 to 20 carbon atoms, more preferably 1 to 16 carbon atoms, and particularly preferably 1 to 12 carbon atoms. Herein, the aliphatic group is preferably an aliphatic hydrocarbon group, and more preferably an alkyl group (including linear, branched, and cyclic alkyl groups), an alkenyl group, or an alkynyl group. Examples of the alkyl group include methyl, ethyl, n-propyl, isopropyl, n-butyl, isobutyl, sec-butyl, tert-butyl, n-pentyl, tert-amyl, n-hexyl, n-octyl, decyl, dodecyl, eicosyl, 2-ethylhexyl, cyclopentyl, cyclohexyl, cycloheptyl, 2,6-dimethyl-cyclohexyl, 4-tert-butylcyclohexyl, cyclopentyl, 1-adamantyl, 2-adamantyl, and bicyclo[2.2.2]octan-3-yl. Examples of the alkenyl group include vinyl, allyl, prenyl, geranyl, oreyl, 2-cyclopentene-1-yl, and 2-cyclohexene-1-yl. Examples of the alkynyl group include ethynyl and propargyl. Further, V³¹ to V⁴³ may have a substituent, and examples of the substituent include those which the R¹¹ to R¹³ may possess thereon.

L³¹ to L⁸⁰ each independently represent a divalent saturated linking group composed of 0 to 40 atoms, and having 0 to 20 carbon atoms. When L³¹ to L⁸⁰ are each composed of zero (0) atom, it means that L³¹ to L⁸⁰ each represent a single bond. Preferable examples of L³¹ to L⁸⁰ include alkylene groups (e.g., methylene, ethylene, propylene, trimethylene, tetramethylene, pentamethylene, hexamethylene, methylethylene, and ethylethylene), cyclic divalent groups (e.g., cis-1,4-cyclohexylene, trans-1,4-cyclohexylene, and 1,3-cyclopentylidene), ethers, thioethers, esters, amides, sulfones, sulfoxides, sulfides, sulfonamides, ureylenes, and thioureylenes. These divalent groups may be combined each other, to form a divalent complex group. Examples of the complex linking include —(CH₂)₂O(CH₂)₂—, —(CH₂)₂O(CH₂)₂O(CH₂)—, —(CH₂)₂S(CH₂)₂—, and —(CH₂)₂O₂C(CH₂)₂—. Further, L³¹ to L⁸⁰ may have a substituent, and examples of the substituent include those which the R¹¹ to R¹³ may possess thereon.

In formulae (4) to (12), preferable examples of the compounds formed by combinations of Y³¹ to Y⁷⁰, V³¹ to V⁴³, and L³¹ to L⁸⁰ include citrates (e.g., triethyl O-acetylcitrate, tributyl O-acetylcitrate, acetyl triethyl citrate, acetyl tributyl citrate, O-acetylcitric acid tri(ethyloxycarbonylmethylene)ester), oleates (e.g., ethyl oleate, butyl oleate, 2-ethylhexyl oleate, phenyl oleate, cyclohexyl oleate, and octyl oleate), ricinoleate (e.g., methyl acetyl ricinoleate), sebacates (e.g., dibutyl sebacate), glycerol carboxylate esters (e.g., triacetin and tributyrin), glycolate esters (e.g., butyl phthalyl butyl glycolate, ethyl phthalyl ethyl glycolate, methyl phthalyl ethyl glycolate, butyl phthalyl butyl glycolate, methyl phthalyl methyl glycolate, propyl phthalyl propyl glycolate, butyl phthalyl butyl glycolate, and octyl phthalyl octyl glycolate), pentaerythritol carboxylate esters (e.g., pentaerythritol tetraacetate and pentaerythritol tetrabutylate), dipentaerythritol carboxylate esters (e.g., dipentaerythritol hexaacetate, dipentaerythritol hexabutylate, and dipentaerythritol tetraacetate), trimethylolpropane carboxylate esters (e.g., trimethylolpropane triacetate, trimethylolpropane diacetate monopropionate, trimethylolpropane tripropionate, trimethylolpropane tributylate, trimethylolpropane tripivaloate, trimethylolpropane tri(t-butyl acetate), trimethylolpropane di-2-ethylhexanate, trimethylolpropane tetra(2-ethylhexanate), trimethylolpropane diacetate monooctanate, trimethylolpropane trioctanate, and trimethylolpropane tri(cyclohexane carboxylate)), glycerol esters described in JP-A-11-246704, diglycerol esters described in JP-A-2000-63560, citrates described in JP-A-11-92574, pyrrolidone carboxylate esters (e.g., methyl 2-pyrrolidone-5-carboxylate, ethyl 2-pyrrolidone-5-carboxylate, butyl 2-pyrrolidone-5-carboxylate, 2-ethylhexyl 2-pyrrolidone-5-carboxylate), cyclohexane dicarboxylate esters(dibutyl cis-1,2-cyclohexanedicarboxylate, dibutyl trans-1,2-cyclohexanedicarboxylate, dibutyl cis-1,4-cyclohexanedicarboxylate, and dibutyl trans-1,4-cyclohexanedicarboxylate), and xylitol carboxylate esters (e.g., xylitol pentaacetate, xylitol tetraacetate, and xylitol pentapropionate).

Examples of the compound represented by any one of the formulae (4) to (12) (C-401 to C-448) are shown below, but the invention is not limited to them. The octanol-water partition coefficients (log P values) in parentheses were determined by the Crippen's fragmentation method (J. Chem. Inf. Comput. Sci., 27, 21 (1987)).

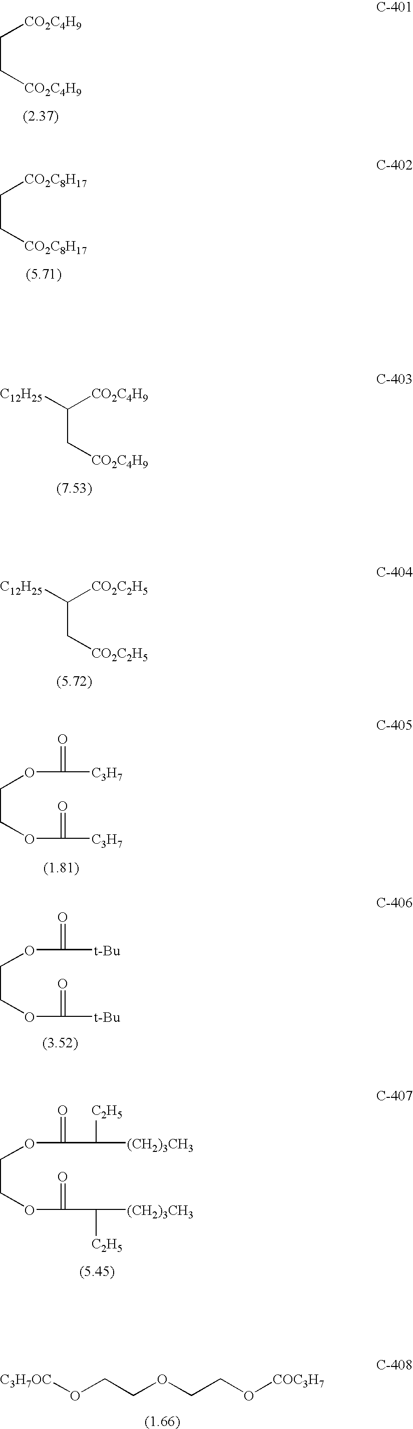

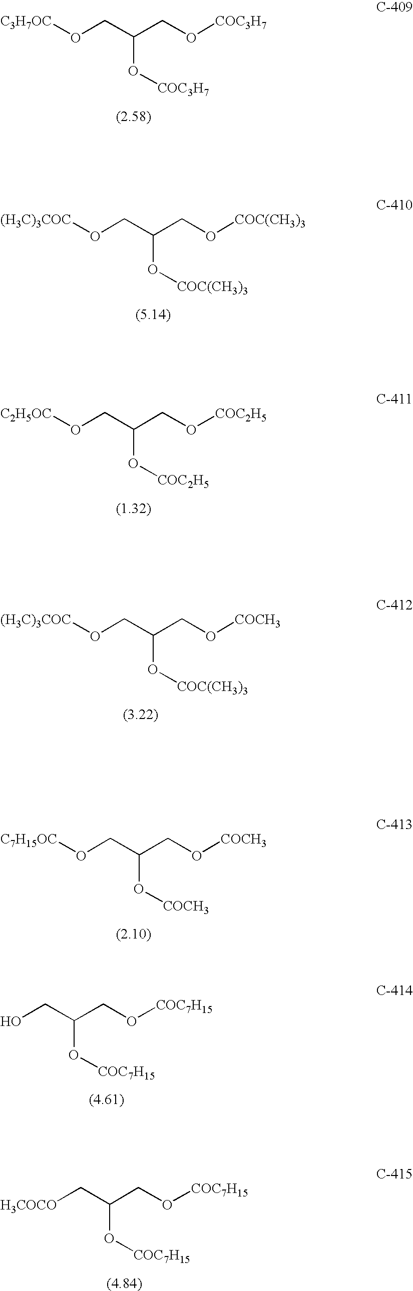

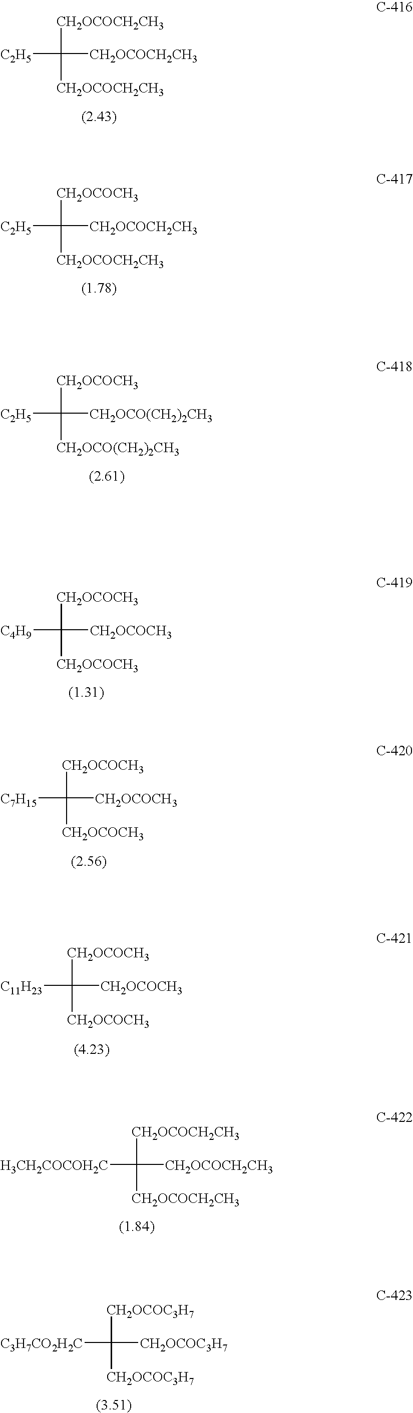

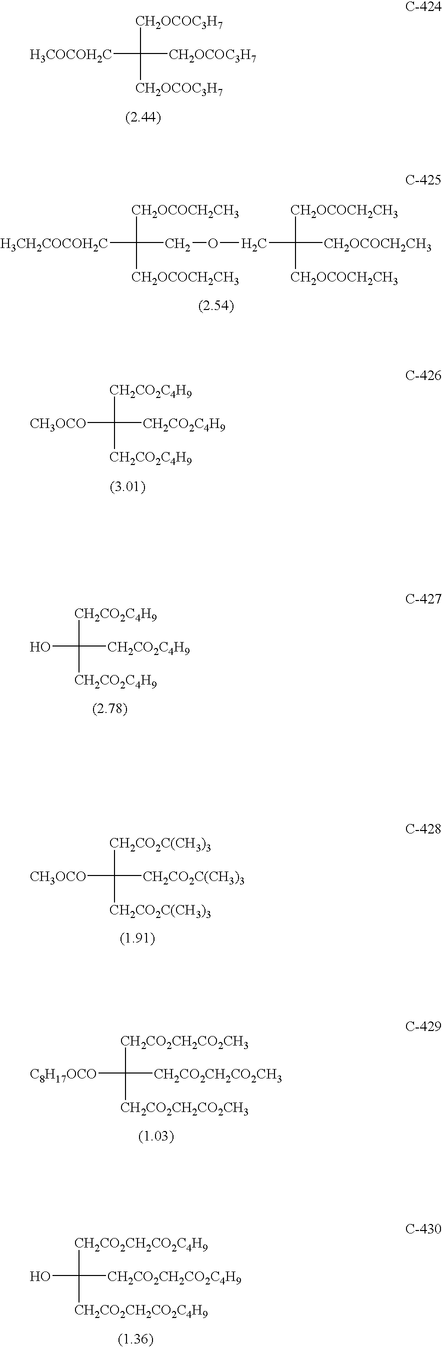

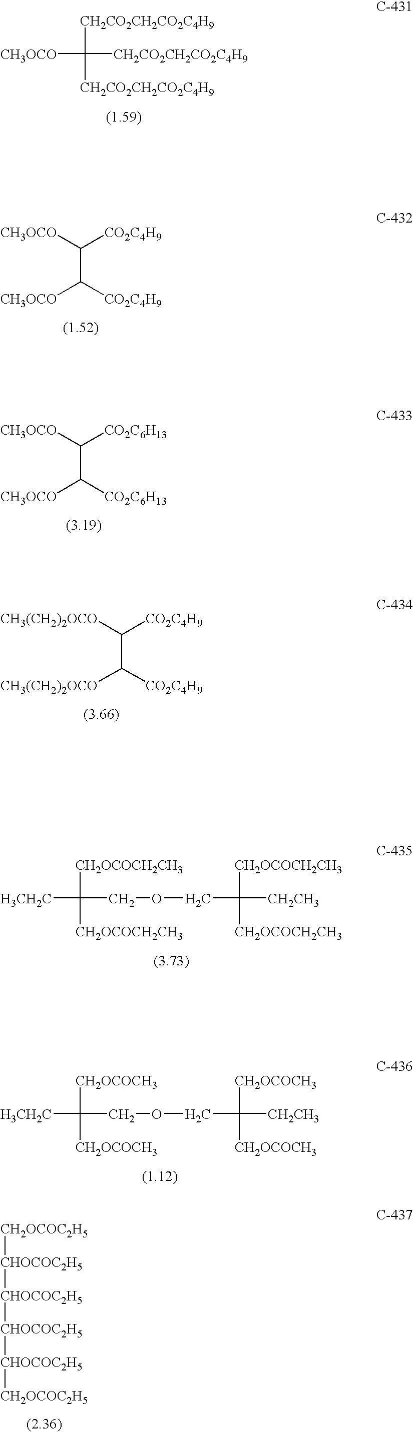

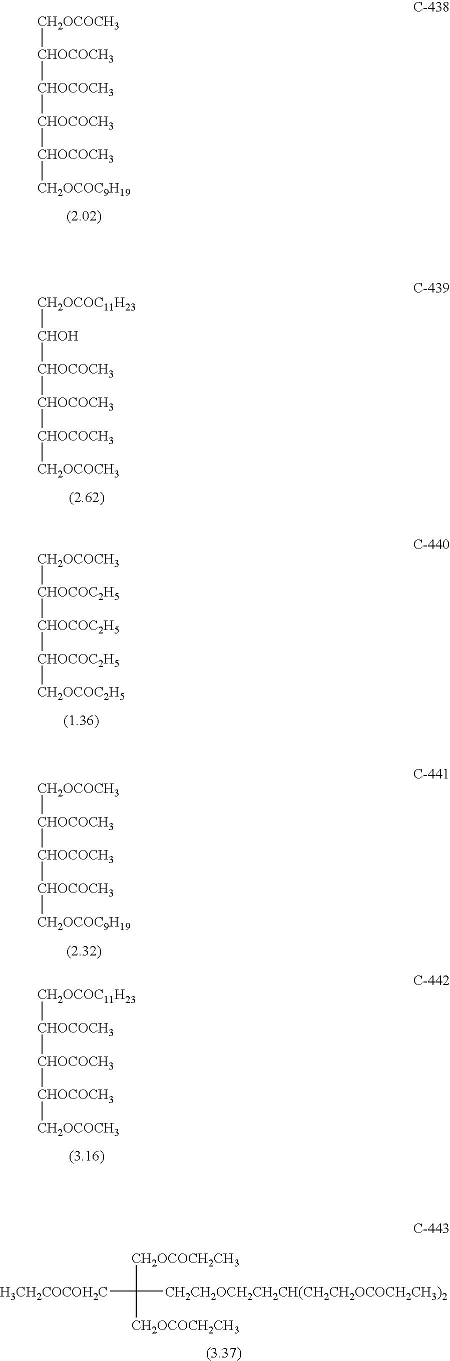

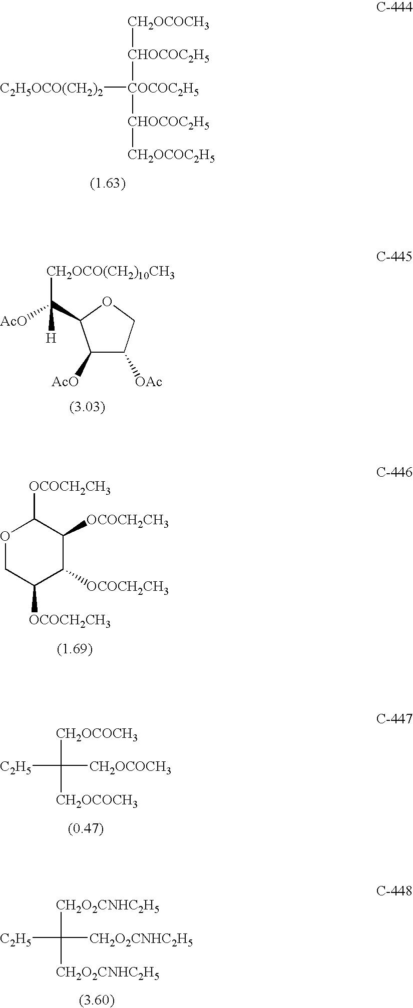

The compounds represented by formula (13) or (14) are explained below.

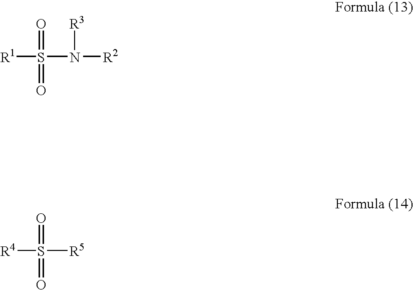

In formula (13), R¹ represents an alkyl group or an aryl group, R² and R³ each independently represent a hydrogen atom, an alkyl group, or an aryl group; and the total of carbon atoms of R¹, R², and R³ is 10 or more, and the alkyl group and the aryl group each may have a substituent. Further, in formula (14), R⁴ and R⁵ each independently represent an alkyl group or an aryl group. The total of carbon atoms of R⁴ and R⁵ is 10 or more, and the alkyl group and the aryl group each may have a substituent.

The substituent is preferably a fluorine atom, an alkyl group, an aryl group, an alkoxy group, a sulfone group, or a sulfonamido group, and particularly preferably an alkyl group, an aryl group, an alkoxy group, a sulfone group, or a sulfonamido group. The alkyl group may be linear, branched, or cyclic, and preferably has 1 to 25 carbon atoms, more preferably 6 to 25 carbon atoms, and particularly preferably 6 to 20 carbon atoms (e.g., methyl, ethyl, propyl, isopropyl, butyl, isobutyl, t-butyl, amyl, isoamyl, t-amyl, hexyl, cyclohexyl, heptyl, octyl, bicyclooctyl, nonyl, adamantyl, decyl, t-octyl, undecyl, dodecyl, tridecyl, tetradecyl, pentadecyl, hexadecyl, heptadecyl, octadecyl, nonadecyl, and didecyl). The aryl group preferably has 6 to 30 carbon atoms, and particularly preferably 6 to 24 carbon atoms (e.g., phenyl, biphenyl, terphenyl, naphthyl, binaphthyl, and triphenylphenyl),

Specific preferred examples of the compound represented by formula (13) or (14) are shown below, but the present invention is not limited thereto.

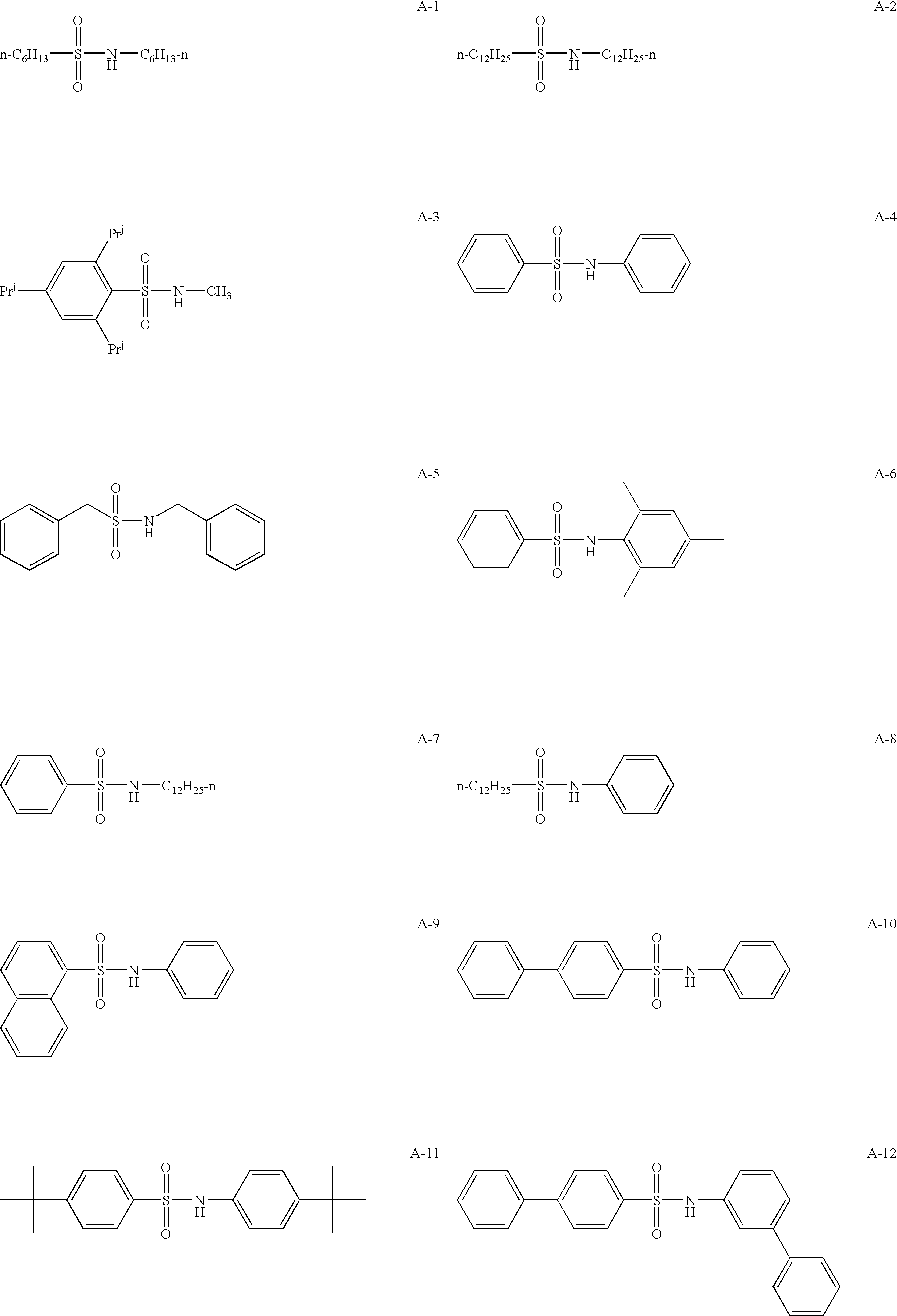

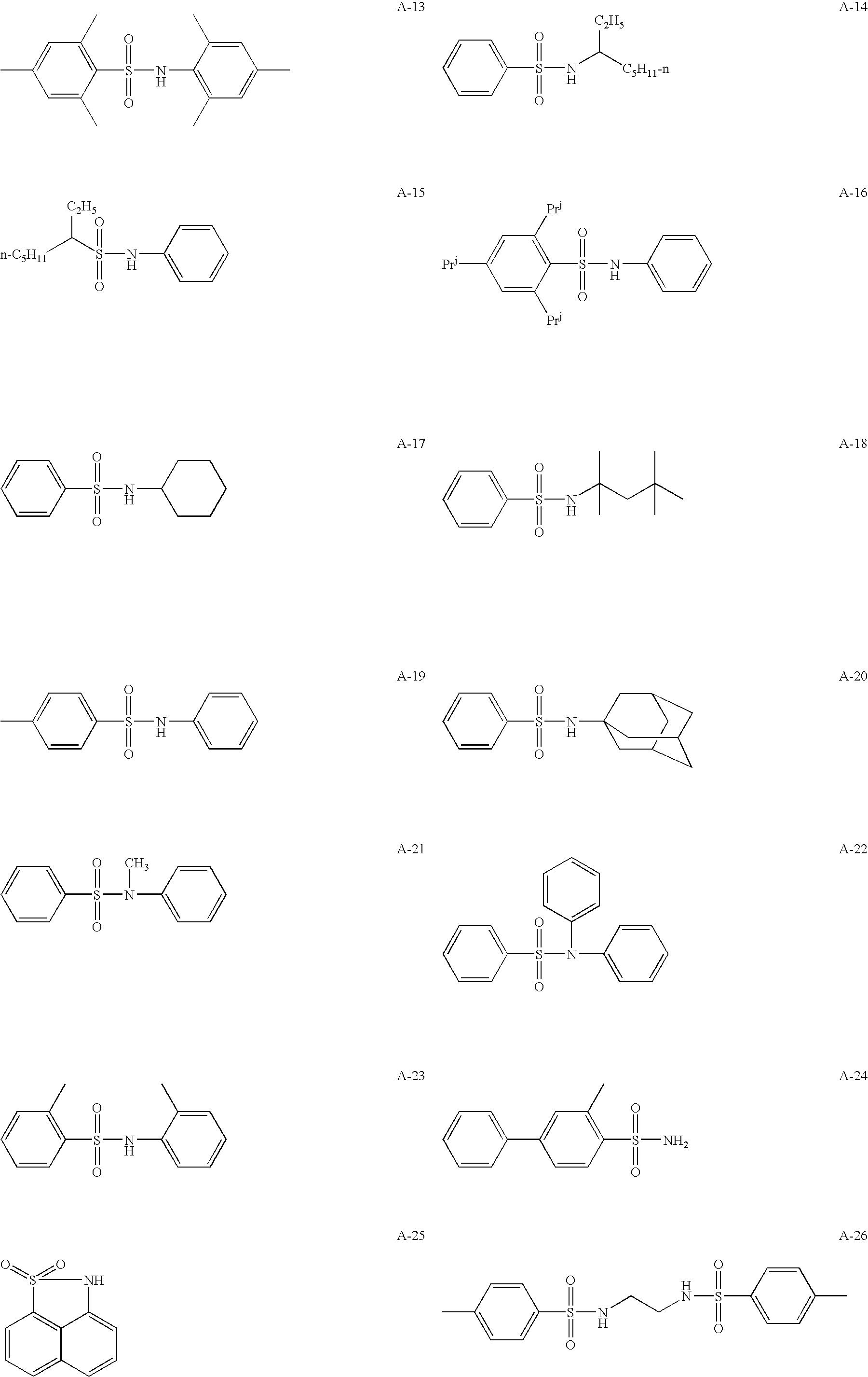

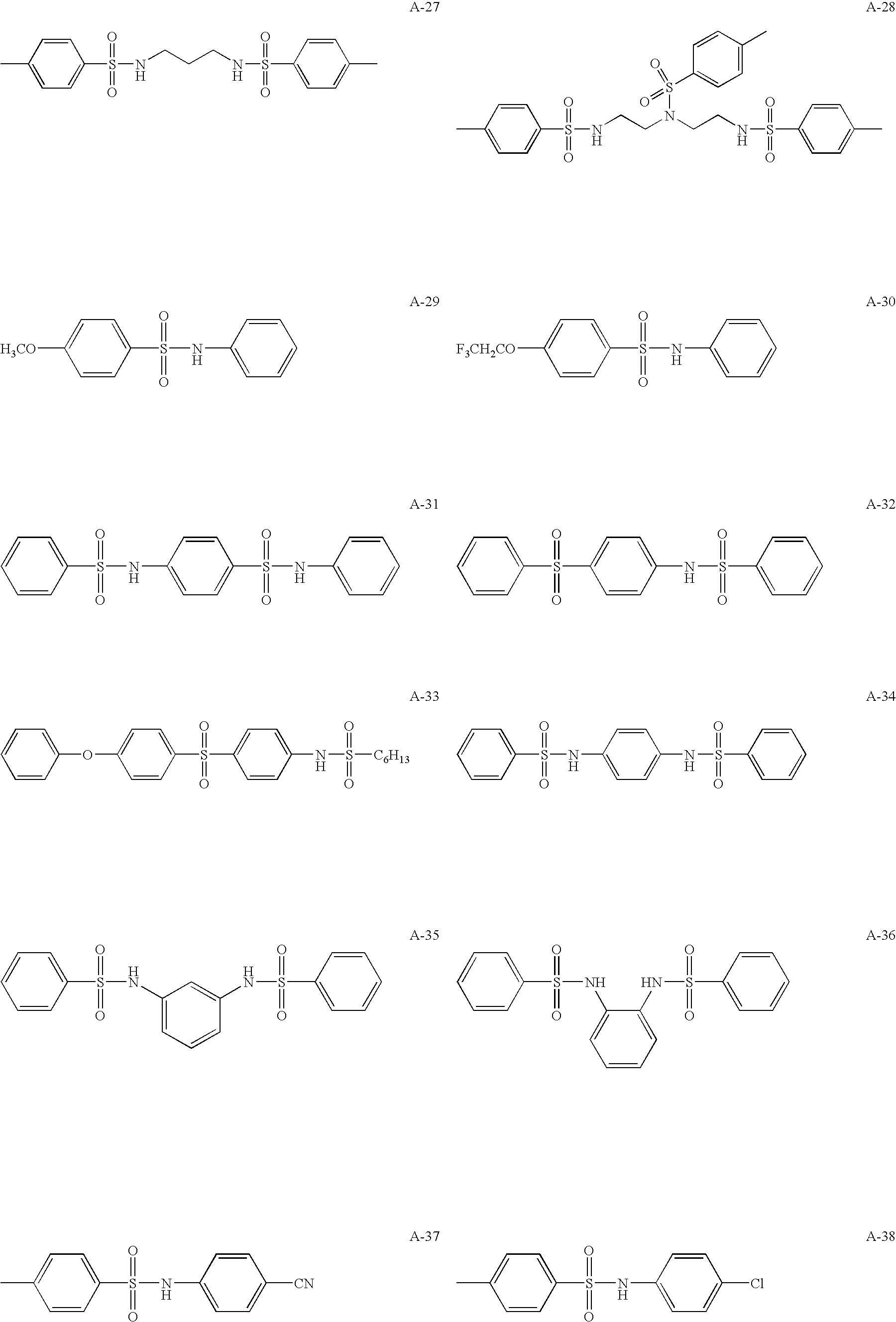

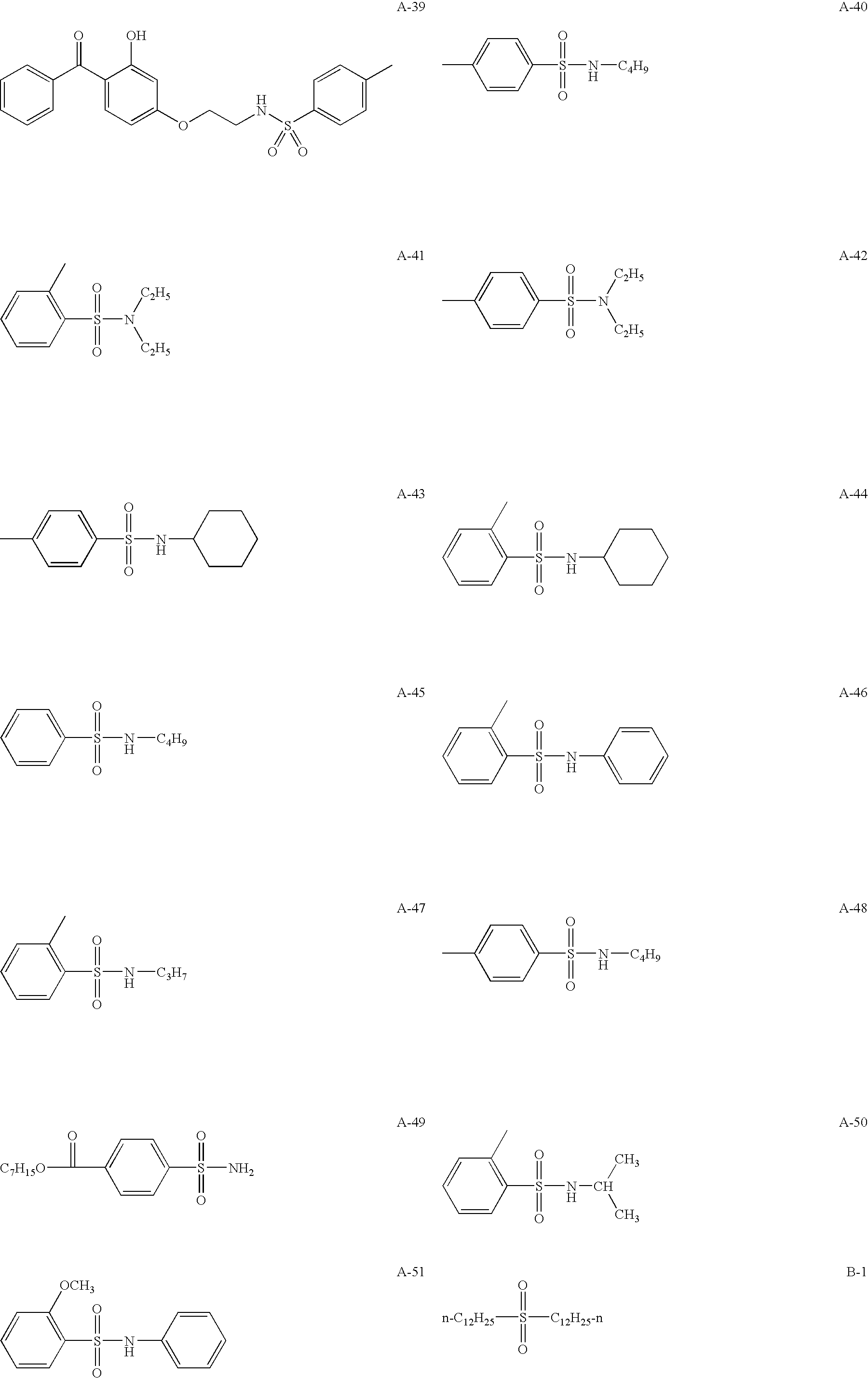

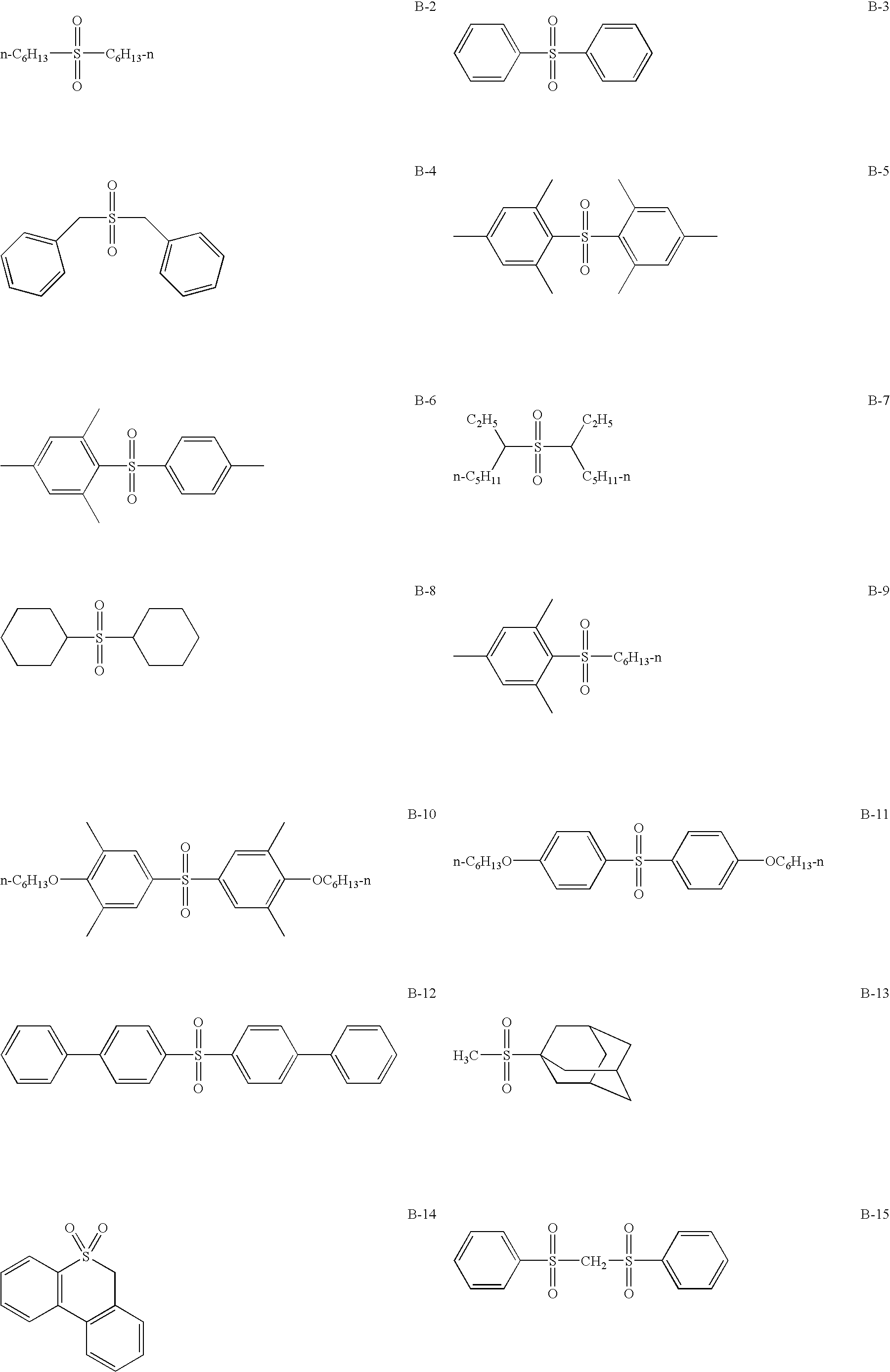

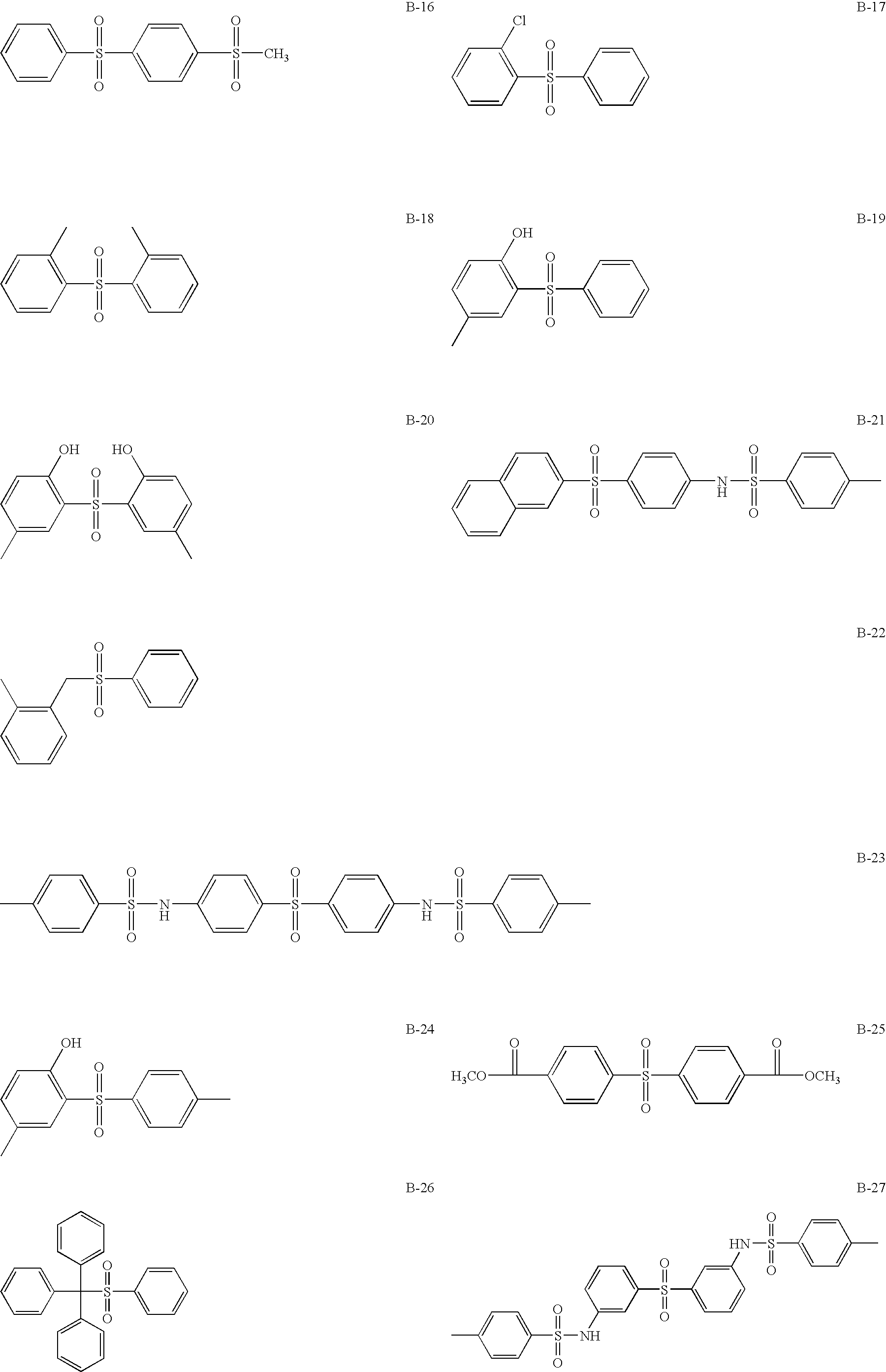

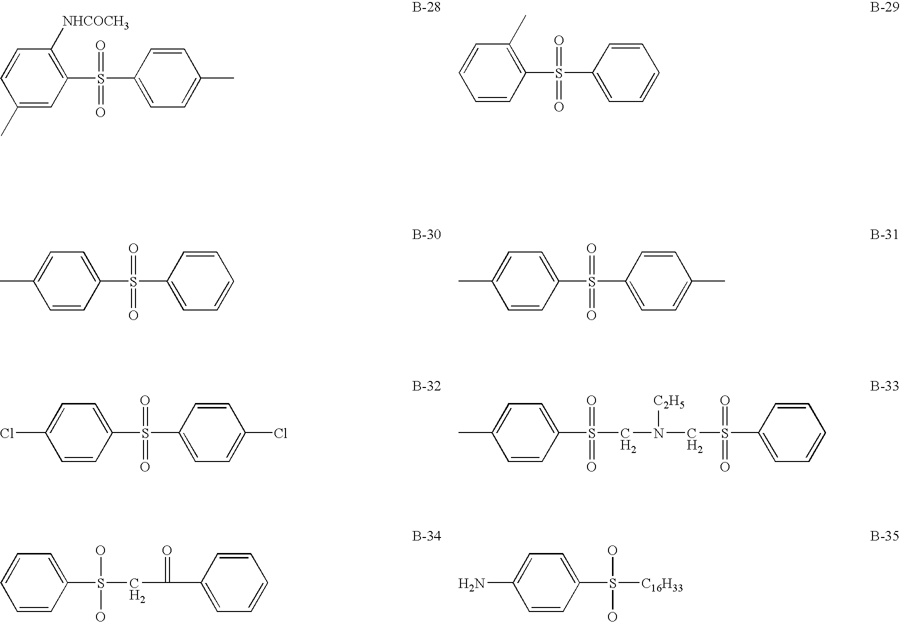

The compound represented by formula (15) is described below.

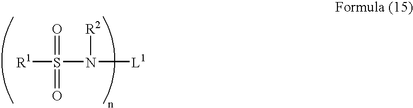

In formula (15), R¹ represents a substituted or unsubstituted aliphatic group, or a substituted or unsubstituted aromatic group; and R² represents a hydrogen atom, a substituted or unsubstituted aliphatic group, or a substituted or unsubstituted aromatic group. The substituent may be the substituent T as described in the below. L¹ represents a divalent to hexavalent linking group. L¹ preferably has a valency of 2 to 4, and more preferably 2 or 3. n represents an integer of 2 to 6 corresponding to the valency of L¹, preferably 2 to 4, and particularly preferably 2 or 3.

The two or more R¹ and R² contained in one compound may be the same or different from each other, and are preferably the same.

Preferred examples of the compound represented by formula (15) include a compound represented by formula (15a).

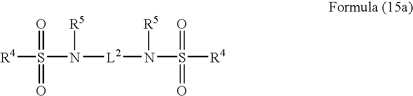

In formula (15a), R⁴ represents a substituted or unsubstituted aliphatic group, or a substituted or unsubstituted aromatic group. R⁴ is preferably a substituted or unsubstituted aromatic group, and more preferably an unsubstituted aromatic group. R⁵ represents a hydrogen atom, a substituted or unsubstituted aliphatic group, or a substituted or unsubstituted aromatic group. R⁵ is preferably a hydrogen atom, or a substituted or unsubstituted aliphatic group, and more preferably a hydrogen atom. L² represents a divalent linking group formed by at least one selected from —O—, —S—, —CO—, —NR³— (in which R³ represents a hydrogen atom, a substituted or unsubstituted aliphatic group, or a substituted or unsubstituted aromatic group), an alkylene group, and an arylene group. The combination of the linking groups is not particularly limited, and it is preferably selected from —O—, —S—, —NR³—, and an alkylene group, and particularly preferably selected from —O—, —S—, and an alkylene group. The linking group is preferably a linking group composed of two or more groups selected from —O—, —S—, and an alkylene group. The substituent for those groups may be the substituent T described below.

The substituted or unsubstituted aliphatic group may be linear, branched, or cyclic, and preferably has 1 to 25 carbon atoms, more preferably has 6 to 25 carbon atoms, and particularly preferably 6 to 20 carbon atoms. Specific examples of the aliphatic group include a methyl group, an ethyl group, a n-propyl group, an isopropyl group, a cyclopropyl group, a n-butyl group, an isobutyl group, a tert-butyl group, an amyl group, an isoamyl group, a tert-amyl group, a n-hexyl group, a cyclohexyl group, a n-heptyl group, a n-octyl group, a bicyclooctyl group, an adamantyl group, a n-decyl group, a tert-octyl group, a dodecyl group, a hexadecyl group, an octadecyl group, and a didecyl group.

The aromatic group may be an aromatic hydrocarbon group or an aromatic heterocyclic group, and more preferably an aromatic hydrocarbon group. The aromatic hydrocarbon group preferably has 6 to 24 carbon atoms, and more preferably 6 to 12 carbon atoms. Specific examples of the ring of the aromatic hydrocarbon group include benzene, naphthalene, anthracene, biphenyl, and terphenyl. The aromatic hydrocarbon group is particularly preferably a benzene, naphthalene, or biphenyl group. The aromatic heterocyclic group preferably contains at least one oxygen atom and/or nitrogen atom and/or sulfur atom. Specific examples of the heterocycle include furan, pyrrole, thiophene, imidazole, pyrazole, pyridine, pyradine, pyridazine, triazole, triazine, indole, indazole, purin, thiazoline, thiadiazole, oxazoline, oxazole, oxadiazole, quinoline, isoquinoline, phthalazine, naphthyridine, quinoxaline, quinazoline, cinnoline, pteridine, acridine, phenanthroline, phenazine, tetrazole, benzimidazole, benzoxazole, benzothiazole, benzotriazole, and tetrazaindene rings. The aromatic heterocycle is particularly preferably a pyridine, triazine or quinoline ring.

Further, more preferred examples of the compound represented by formula (15) include a compound represented by formula (15c),

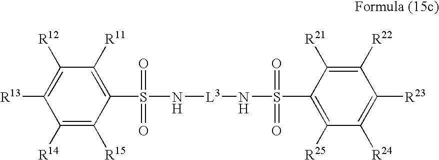

In formula (15c), R¹¹, R¹², R¹³, R¹⁴, R¹⁵, R²¹, R²², R²³, R²⁴ and R²⁵ each independently represent a hydrogen atom or a substituent. The substituent may be the substituent T described below. R¹, R¹², R¹³, R¹⁴, R¹⁵, R²¹, R²², R²³, R²⁴ and R²⁵ each are preferably an alkyl group, an alkenyl group, an alkynyl group, an aryl group, an amino group, an alkoxy group, an aryloxy group, an acyl group, an alkoxycarbonyl group, an aryloxycarbonyl group, an acyloxy group, an acylamino group, an alkoxycarbonylamino group, an aryloxycarbonylamino group, a sulfonylamino group, a sulfamoyl group, a carbamoyl group, an alkylthio group, an arylthio group, a sulfonyl group, a sulfinyl group, a ureido group, a phosphoric amido group, a hydroxy group, a mercapto group, a halogen atom (e.g., a fluorine atom, a chlorine atom, a bromine atom, and an iodine atom), a cyano group, a sulfo group, a carboxyl group, a nitro group, a hydroxamic acid group, a sulfino group, a hydrazino group, a imino group, a heterocyclic group (preferably a heterocyclic group having 1 to 30 carbon atoms, more preferably 1 to 12 carbon atoms, and containing a hetero atom such as a nitrogen atom, an oxygen atom or a sulfur atom, for example, an imidazolyl group, a pyridyl group, a quinolyl group, a furyl group, a piperidyl group, a morpholino group, a benzoxazolyl group, a benzimidazolyl group or a benzthiazolyl group), or a silyl group; more preferably an alkyl group, an aryl group, an aryloxycarbonylamino group, an alkoxy group, or an aryloxy group; and particularly preferably an alkyl group, an aryl group, or an aryloxycarbonylamino group. These substituents may be further substituted, and if they have two or more substituents, these substituents may be the same or different from each other, and may be combined each other to form a ring if possible. R¹¹ and R²¹, R¹² and R²², R¹³ and R²³, R¹⁴ and R²⁴, and R¹⁵ and R²⁵ are preferably the same each other. Further, each of R¹¹ to R²⁵ is more preferably a hydrogen atom.

L³ represents a divalent linking group formed by at least one selected from —O—, —S—, —CO—, —NR³— (in which R³ represents a hydrogen atom, an aliphatic group, or an aromatic group), an alkylene group, and an arylene group. The combination of the linking groups is not particularly limited, but is preferably selected from —O—, —S—, —NR³—, and an alkylene group, and particularly preferably selected from —O—, —S—, and an alkylene group.

Further, the linking group is more preferably a linking group composed of two or more groups selected from —O—, —S—, and an alkylene group.

Specific preferred examples of the compounds represented by formula (15), particularly formula (15a) or (15c), are shown below, but the present invention is not limited thereto.

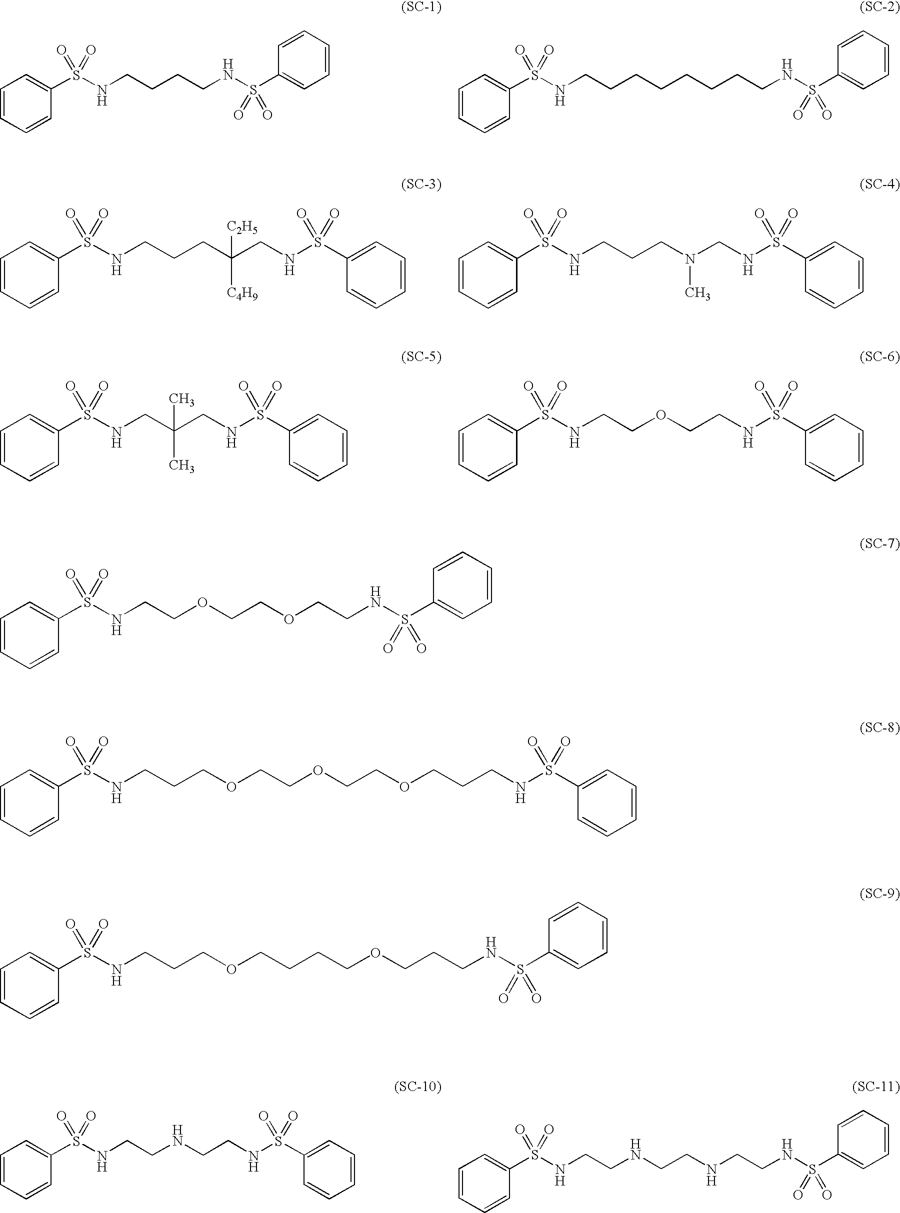

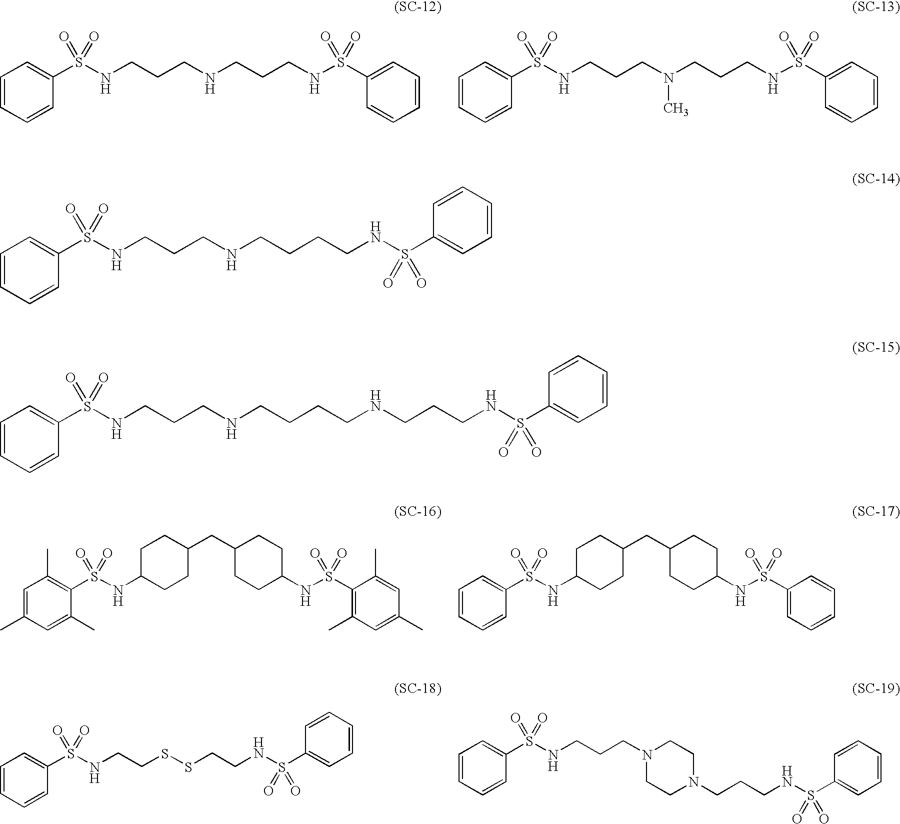

Each of the compounds that can be used in the present invention may be prepared from a known compound(s). The compound represented by formula (15), particularly formula (15a) or (15c), is generally prepared through the condensation reaction between sulfonyl chloride and a polyfunctional amine.

The compound represented by formula (16) is described below.

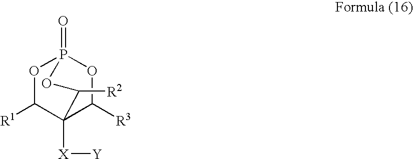

In formula (16), R¹, R², and R³ are each independently preferably a hydrogen atom or an alkyl group having 1 to 5 carbon atoms (e.g., methyl, ethyl, propyl, isopropyl, butyl, amyl, or isoamyl), and it is particularly preferable that at least one of R¹, R², and R³ is an alkyl group having 1 to 3 carbon atoms (e.g., methyl, ethyl, propyl, or isopropyl).

X is preferably a divalent linking group formed by at least one selected from the group consisting of a single bond, —O—, —CO—, —NR⁴— (R⁴ represents a hydrogen atom, an alkyl group, an aryl group, or an aralkyl group), an alkylene group (preferably having 1 to 6 carbon atoms, more preferably 1 to 3 carbon atoms, for example, methylene, ethylene, or propylene), and an arylene group (preferably having 6 to 24 carbon atoms, more preferably 6 to 12 carbon atoms, for example, phenylene, biphenylene, or naphthylene); and particularly preferably a divalent linking group formed by at least one group selected from —O—, an alkylene group, and an arylene group.

Y is preferably a hydrogen atom, an alkyl group (preferably an alkyl group having 2 to 25 carbon atoms, more preferably 2 to 20 carbon atoms, e.g., ethyl, isopropyl, t-butyl, hexyl, 2-ethylhexyl, t-octyl, dodecyl, cyclohexyl, dicyclohexyl, and adamantyl), an aryl group (preferably an aryl group having 6 to 24 carbon atoms, more preferably 6 to 18 carbon atoms, e.g., phenyl, biphenyl, terphenyl, and naphthyl), or an aralkyl group (preferably an aralkyl group having 7 to 30 carbon atoms, more preferably 7 to 20 carbon atoms, e.g., benzyl, cresyl, t-butylphenyl, diphenylmethyl, and triphenylmethyl); and particularly preferably an alkyl group, an aryl group, or an aralkyl group. As to the combination of the group —X—Y, the total carbon atoms of —X—Y is preferably from 0 to 40, more preferably from 1 to 30, and most preferably from 1 to 25.

Specific preferred examples of the compound represented by formula (16) are shown below, but the present invention is not limited thereto.

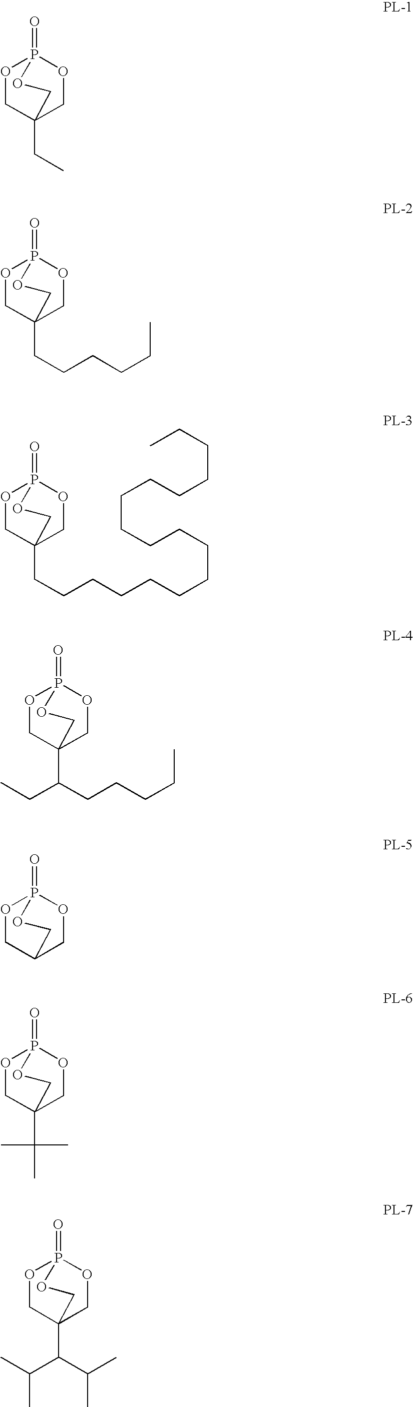

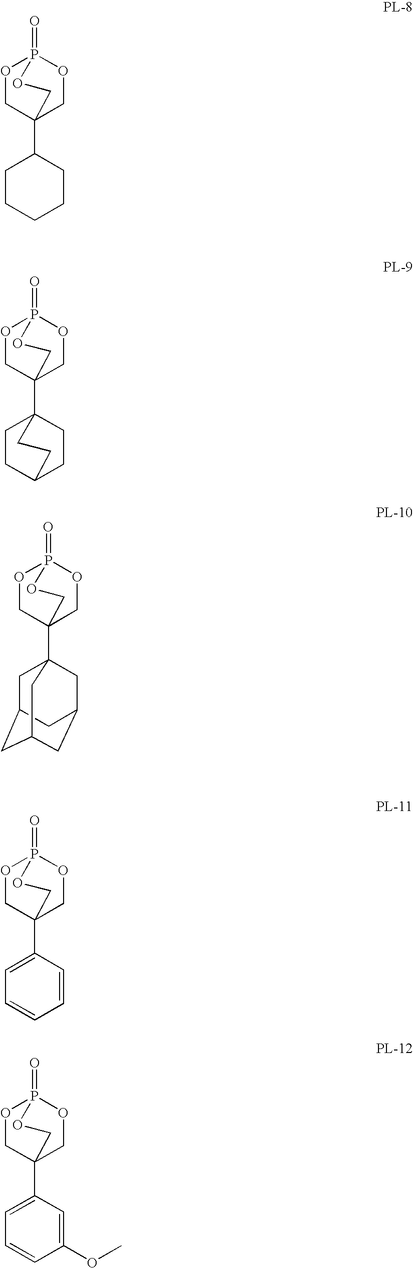

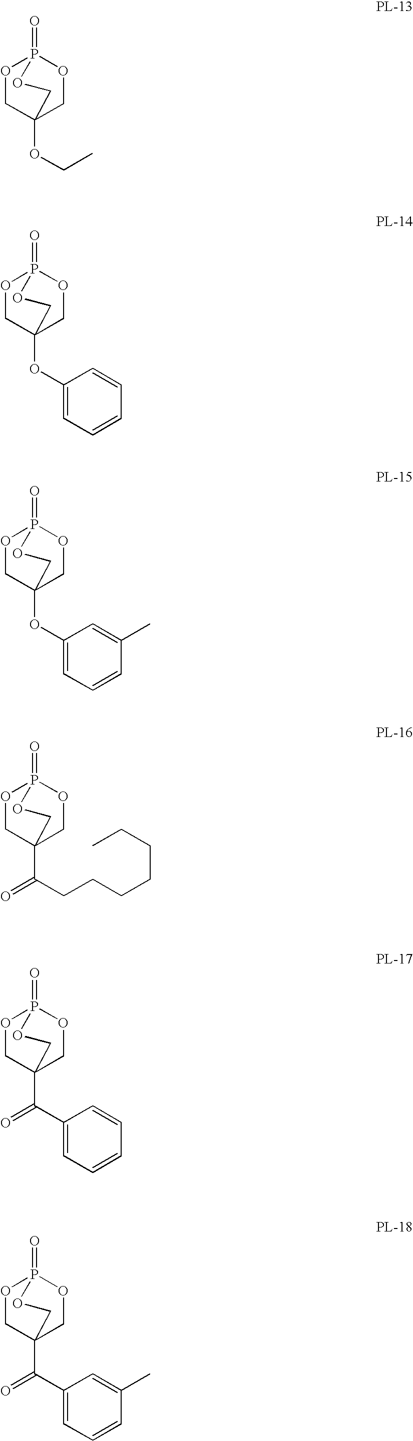

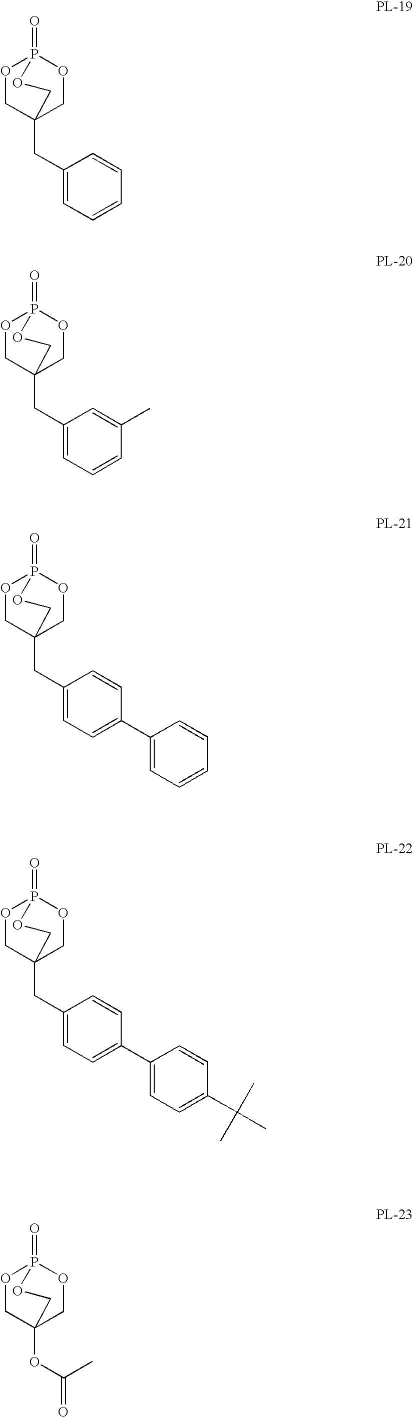

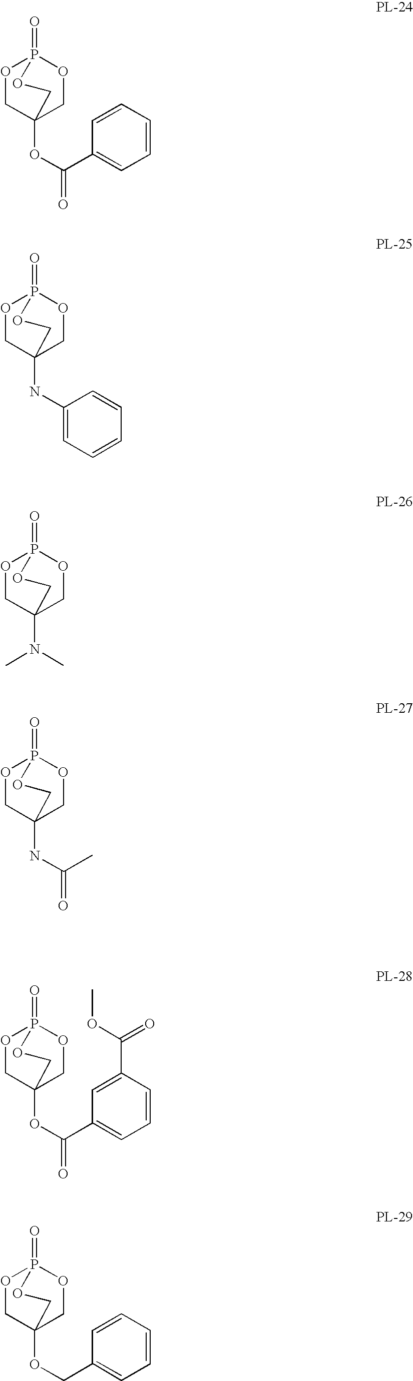

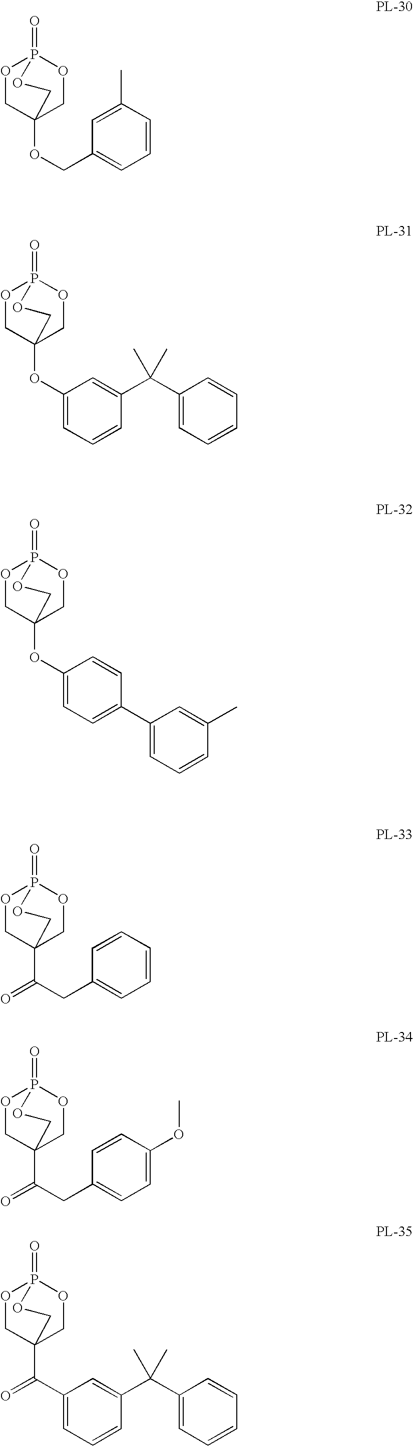

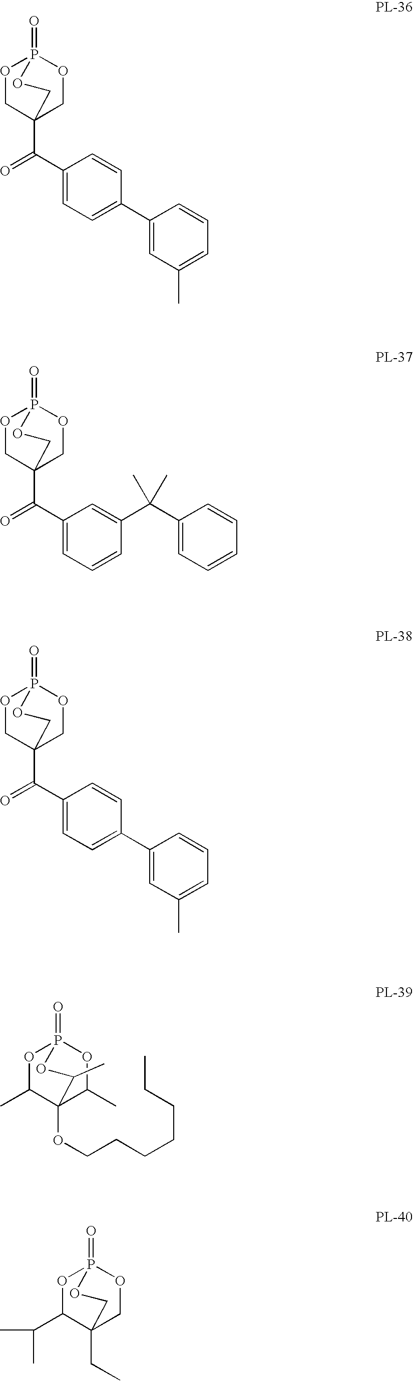

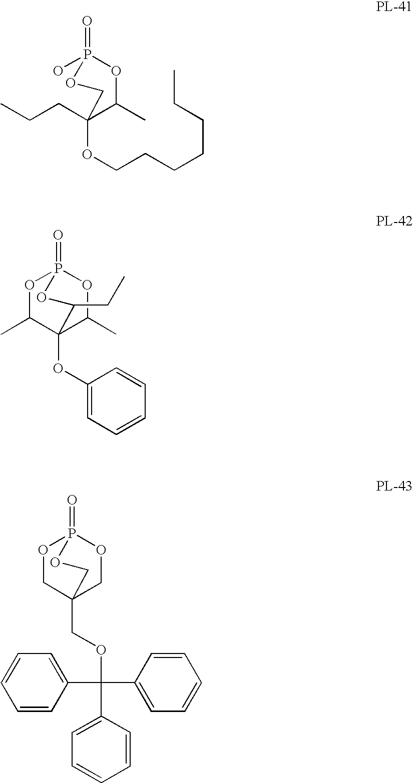

The compound represented by formula (17) is described below.

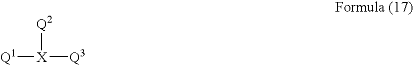

In formula (17), Q¹, Q², and Q³ each independently represent a 5- or 6-membered ring which may be a hydrocarbon ring or hetero ring, and may be monocyclic or form a condensed ring with another ring. The hydrocarbon ring is preferably a substituted or unsubstituted cyclohexane ring, a substituted or unsubstituted cyclopentane ring, or an aromatic hydrocarbon ring, and more preferably an aromatic hydrocarbon ring. The hetero ring is preferably a 5- or 6-membered ring containing at least one of oxygen atom, nitrogen atom, and sulfur atom. The hetero ring is more preferably an aromatic heterocycle containing at least one of oxygen atom, nitrogen atom, and sulfur atom.

Q¹, Q², and Q³ are each preferably an aromatic hydrocarbon ring or aromatic hetero ring. The aromatic hydrocarbon ring is preferably a monocyclic or bicyclic aromatic hydrocarbon ring having 6 to 30 carbon atoms (e.g., benzene ring or naphthalene ring), more preferably an aromatic hydrocarbon ring having 6 to 20 carbon atoms, further preferably an aromatic hydrocarbon ring having 6 to 12 carbon atoms, and further preferably a benzene ring.

The aromatic heterocycle is preferably an aromatic heterocycle containing an oxygen atom, nitrogen atom, or sulfur atom. Specific examples of the heterocycle include furan, pyrrole, thiophene, imidazole, pyrazole, pyridine, pyradine, pyridazine, triazole, triazine, indole, indazole, purin, thiazoline, thiazole, thiadiazole, oxazoline, oxazole, oxadiazole, quinoline, isoquinoline, phthalazine, naphthyridine, quinoxaline, quinazoline, cinnoline, pteridine, acridine, phenanthroline, phenazine, tetrazole, benzimidazole, benzoxazole, benzothiazole, benzotriazole, and tetrazaindene rings. The aromatic heterocycle is preferably pyridine, triazine, or quinoline Q¹, Q², and Q³ are each more preferably an aromatic hydrocarbon ring, and further preferably a benzene ring, Q¹, Q², and Q³ each may have a substituent, and the substituent may be the substituent T described below.

X represents B, C—R (R represents a hydrogen atom or a substituent), N, P, or P═O. X is preferably B, C—R (R is preferably an aryl group, a substituted or unsubstituted amino group, an alkoxy group, an aryloxy group, an acyl group, an alkoxycarbonyl group, an aryloxycarbonyl group, an acyloxy group, an acylamino group, an alkoxycarbonylamino group, an aryloxycarbonylamino group, a sulfonylamino group, a hydroxy group, a mercapto group, a halogen atom (e.g. fluorine atom, chlorine atom, bromine atom, or iodine atom), or a carboxyl group; more preferably an aryl group, an alkoxy group, an aryloxy group, a hydroxy group, or a halogen atom; further preferably an alkoxy group or a hydroxy group; and particularly preferably a hydroxy group), or N; and X is more preferably C—R or N, and particularly preferably C—R.

Preferred examples of the compound represented by formula (17) include a compound represented by formula (17a).

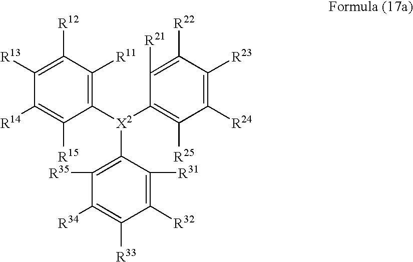

In formula (17a), X² represents B, C—R, N, P or P═O, in which R represents a hydrogen atom or a substituent; R¹¹, R¹², R¹³, R¹⁴, R¹⁵, R²¹, R²², R²³, R²⁴, R²⁵, R³¹, R³², R³³, R³⁴ and R³⁵ each independently represent a hydrogen atom or a substituent.

X² represents B, C—R (R represents a hydrogen atom or a substituent), N, P, or P═O. X² is preferably B, C—R (R is preferably an aryl group, a substituted or unsubstituted amino group, an alkoxy group, an aryloxy group, an acyl group, an alkoxycarbonyl group, an aryloxycarbonyl group, an acyloxy group, an acylamino group, an alkoxycarbonylamino group, an aryloxycarbonylamino group, a sulfonylamino group, a hydroxy group, a mercapto group, a halogen atom (e.g. fluorine atom, chlorine atom, bromine atom, or iodine atom), or a carboxyl group; more preferably an aryl group, an alkoxy group, an aryloxy group, a hydroxy group, or a halogen atom; further preferably an alkoxy group or a hydroxy group; and particularly preferably a hydroxy group), N, or P═O; and X² is more preferably C—R or N, and particularly preferably C—R.

R¹¹, R¹², R¹³, R¹⁴, R¹⁵, R²¹, R²², R²³, R²⁴, R²⁵, R³¹, R³², R³³, R³⁴ and R³⁵ each independently represent a hydrogen atom or a substituent. As the substituent, the substituent T as described below may be applied R¹¹, R¹², R¹³, R¹⁴, R¹⁵, R²¹, R²², R²³, R²⁴, R²⁵, R³¹, R³², R³³, R³⁴ and R³⁵ each are preferably an alkyl group, an alkenyl group, an alkynyl group, an aryl group, a substituted or unsubstituted amino group, an alkoxy group, an aryloxy group, an acyl group, an alkoxycarbonyl group, an aryloxycarbonyl group, an acyloxy group, an acylamino group, an alkoxycarbonylamino group, an aryloxycarbonylamino group, a sulfonylamino group, a sulfamoyl group, a carbamoyl group, an alkylthio group, an arylthio group, a sulfonyl group, a sulfinyl group, a ureido group, a phosphoric amido group, a hydroxy group, a mercapto group, a halogen atom (e.g., a fluorine atom, a chlorine atom, a bromine atom and an iodine atom), a cyano group, a sulfo group, a carboxyl group, a nitro group, a hydroxamic acid group, a sulfino group, a hydrazino group, an imino group, a heterocyclic group (preferably a heterocyclic group having 1 to 30 carbon atoms, more preferably 1 to 12 carbon atoms, and containing a hetero atom such as a nitrogen atom, an oxygen atom or a sulfur atom, for example, an imidazolyl group, a pyridyl group, a quinolyl group, a furyl group, a piperidyl group, a morpholino group, a benzoxazolyl group, a benzimidazolyl group or a benzthiazolyl group), or a silyl group; more preferably an alkyl group, an aryl group, a substituted or unsubstituted amino group, an alkoxy group, or an aryloxy group; and particularly preferably an alkyl group, an aryl group, or an alkoxy group.

These substituents may be further substituted, and if they have two or more substituents, these substituents may be the same or different from each other, and may be combined each other to form a ring if possible.

Specific preferred examples of the compound represented by formula (17) or (17a) are shown below, but the present invention is not limited thereto.

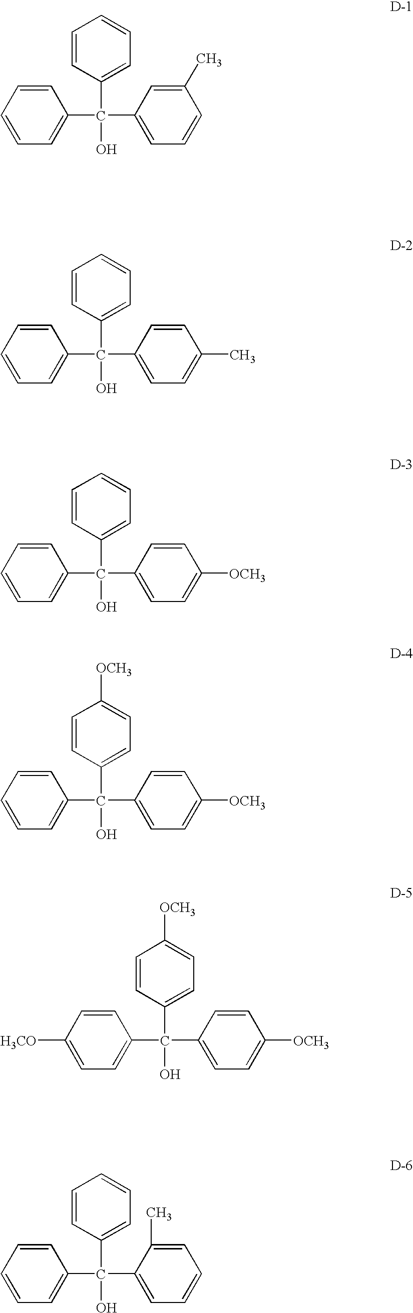

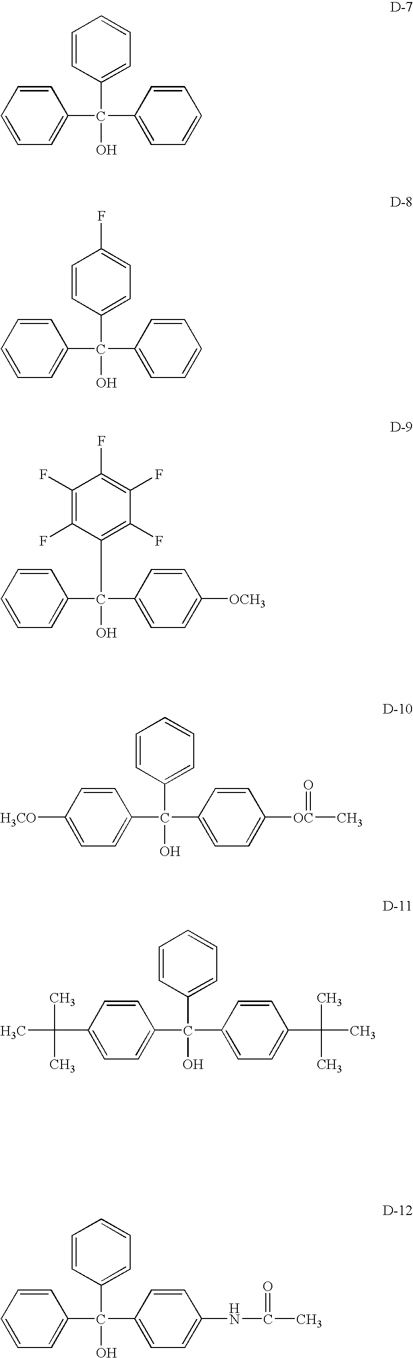

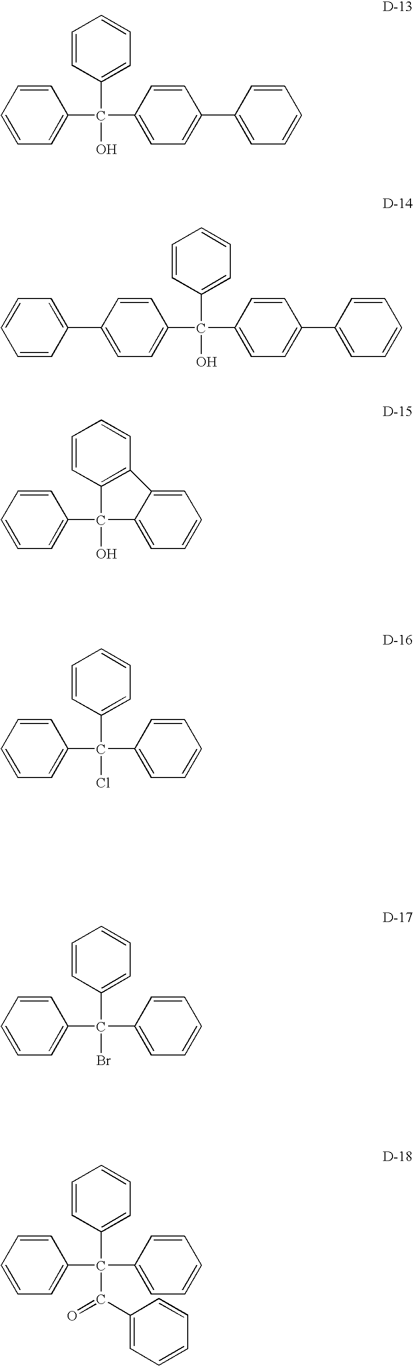

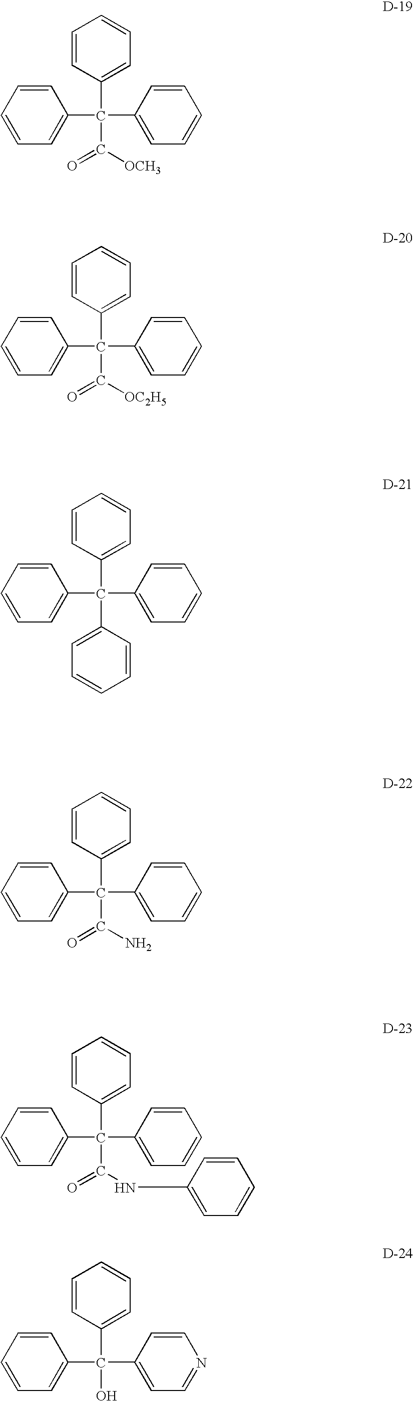

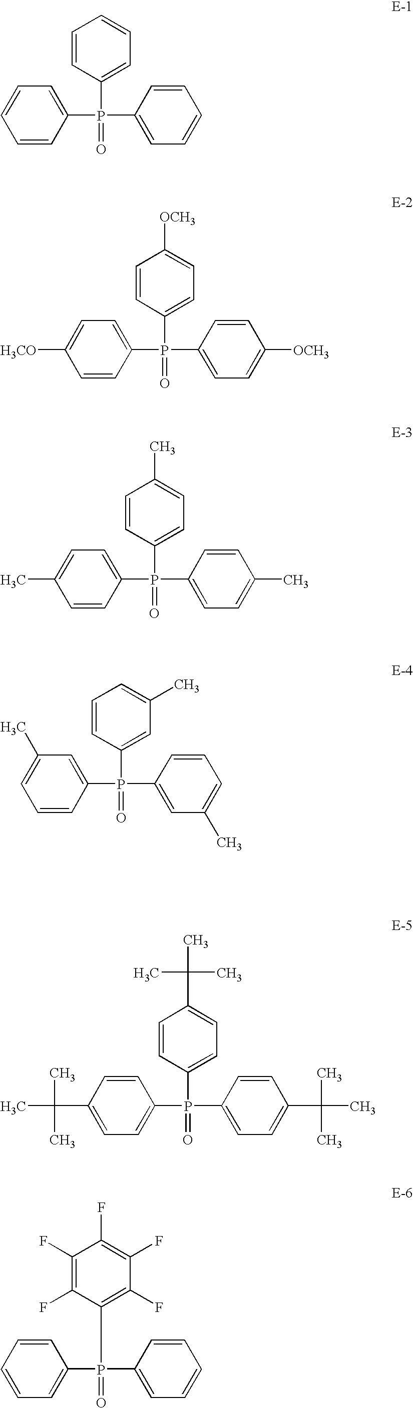

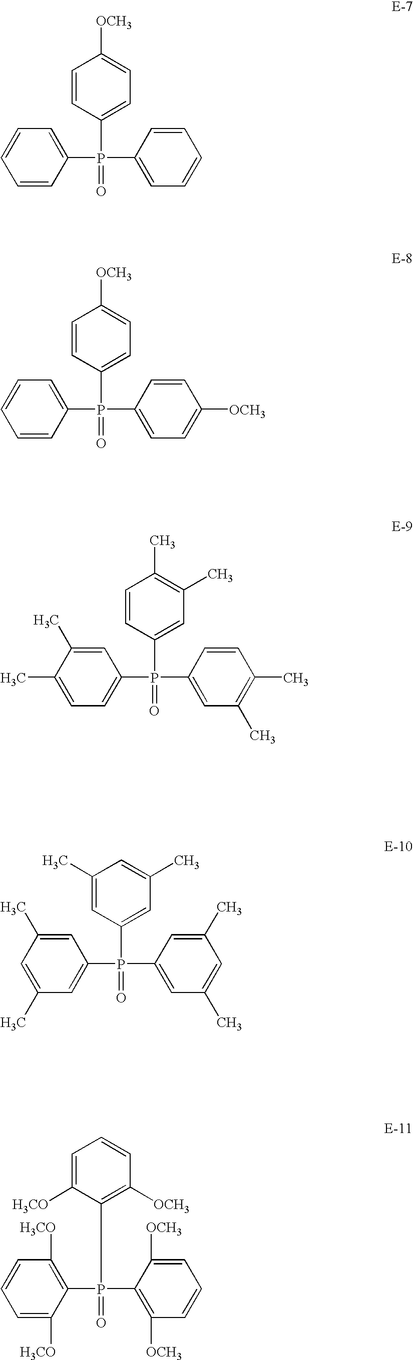

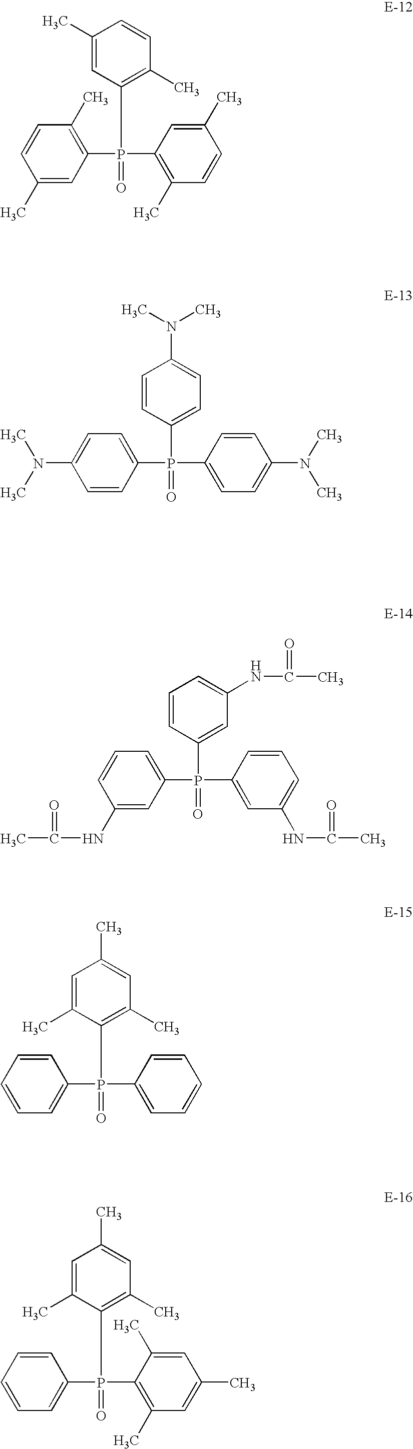

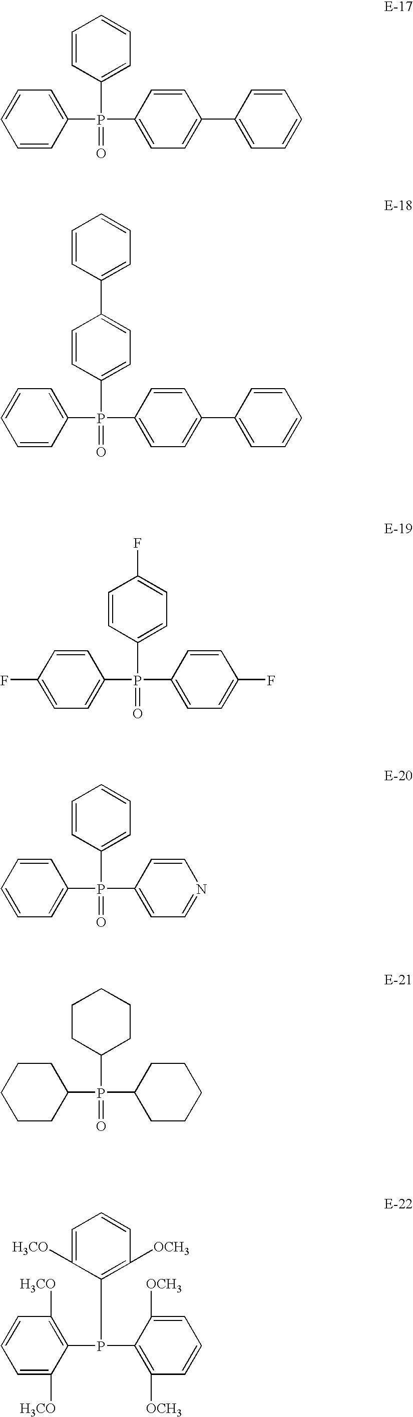

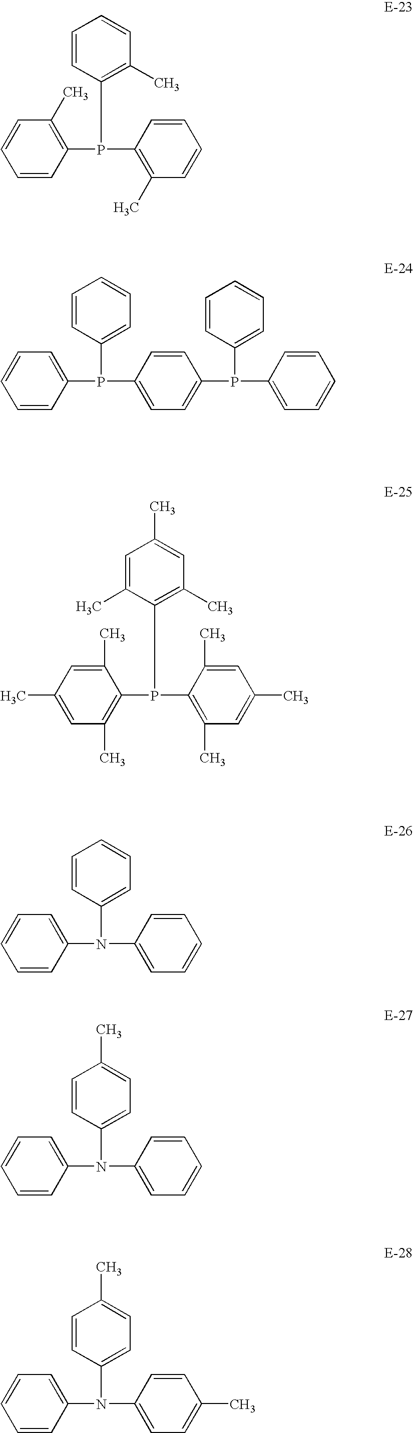

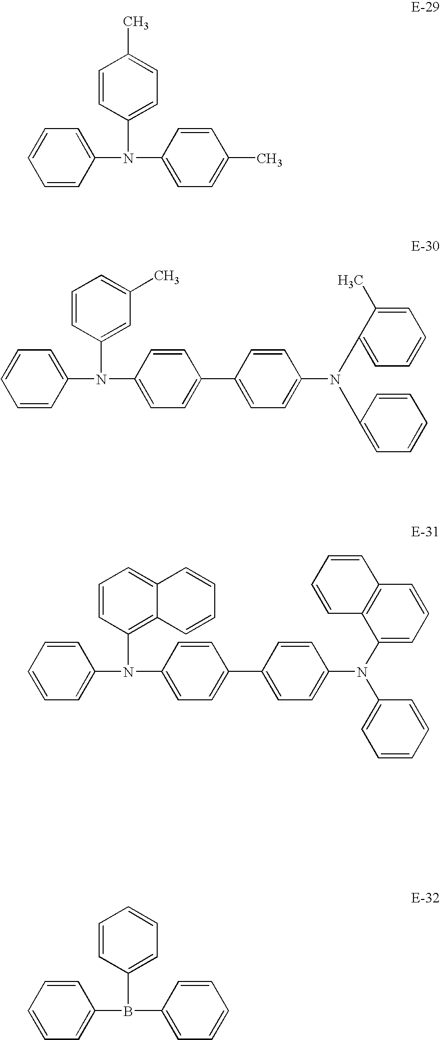

The compound represented by formula (18) is described below.

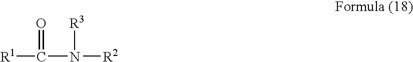

In formula (18), R¹ represents an alkyl group or an aryl group, R² and R³ each independently represent a hydrogen atom, an alkyl group, or an aryl group; and the alkyl group and the aryl group each may have a substituent.

Preferred examples of the compound represented by formula (18) include a compound represented by formula (18a).

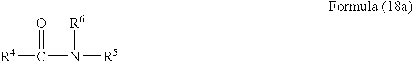

In formula (18a), R⁴, R⁵, and R⁶ each independently represent an alkyl group or an aryl group. The alkyl group may be linear, branched, or cyclic, and preferably has 1 to 20 carbon atoms, more preferably 1 to 15 carbon atoms, and most preferably 1 to 12 carbon atoms. The cyclic alkyl group is particularly preferably a cyclohexyl group. The aryl group preferably has 6 to 36 carbon atoms, and more preferably 6 to 24 carbon atoms.

In formulas (18) and (18a), the alkyl group and the aryl group may be further substituted with a substituent(s). The substituent is preferably a halogen atom (e.g., a chlorine atom, a bromine atom, a fluorine atom and an iodine atom), an alkyl group, an aryl group, an alkoxy group, an aryloxy group, an acyl group, an alkoxycarbonyl group, an aryloxycarbonyl group, an acyloxy group, a sulfonylamino group, a hydroxy group, a cyano group, an amino group, or an acylamino group; more preferably a halogen atom, an alkyl group, an aryl group, an alkoxy group, an aryloxy group, a sulfonylamino group, or an acylamino group; and particularly preferably an alkyl group, an aryl group, a sulfonylamino group, or an acylamino group.

Specific preferred examples of the compound represented by formula (18) or (18a) are shown below, but the present invention is not limited thereto.

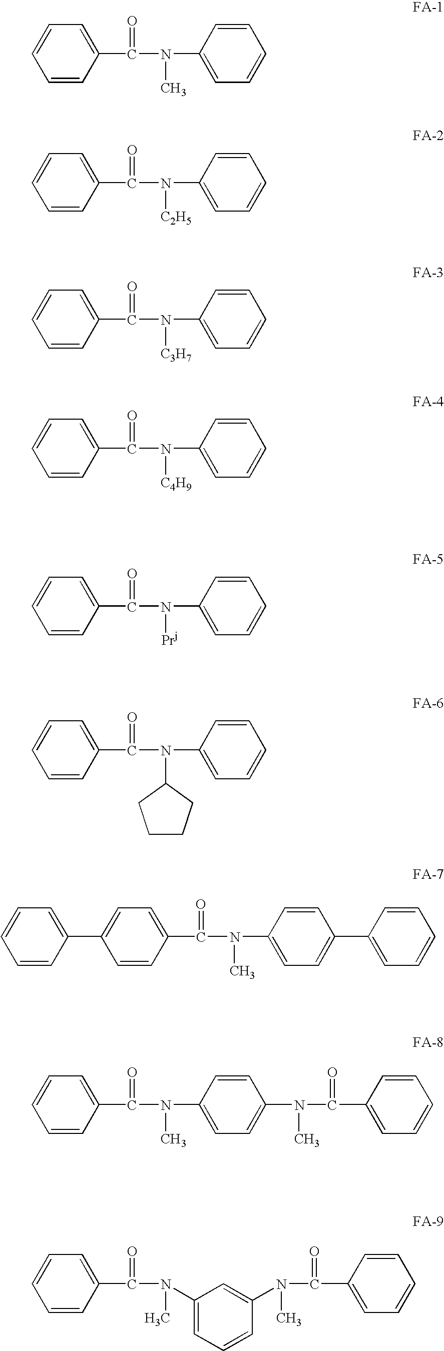

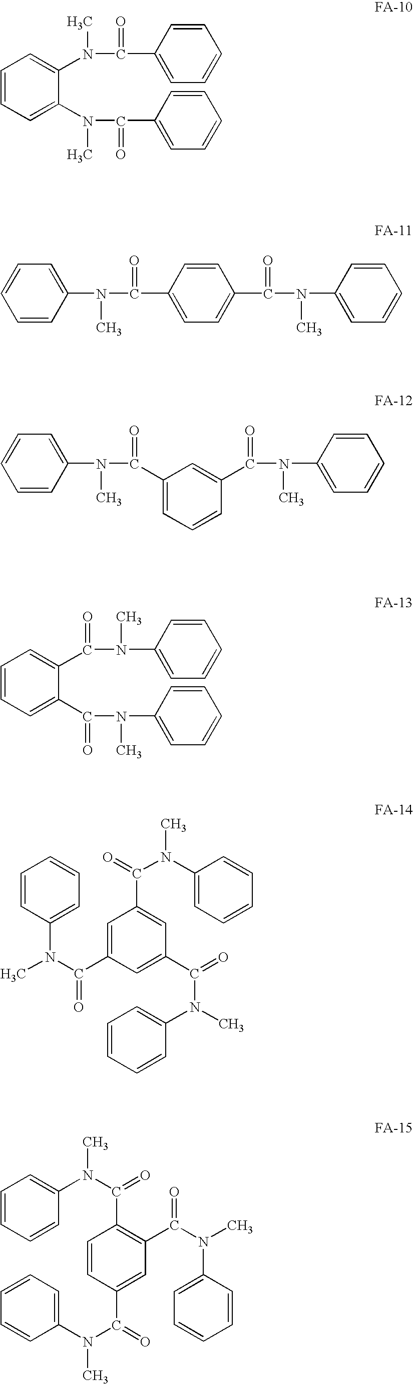

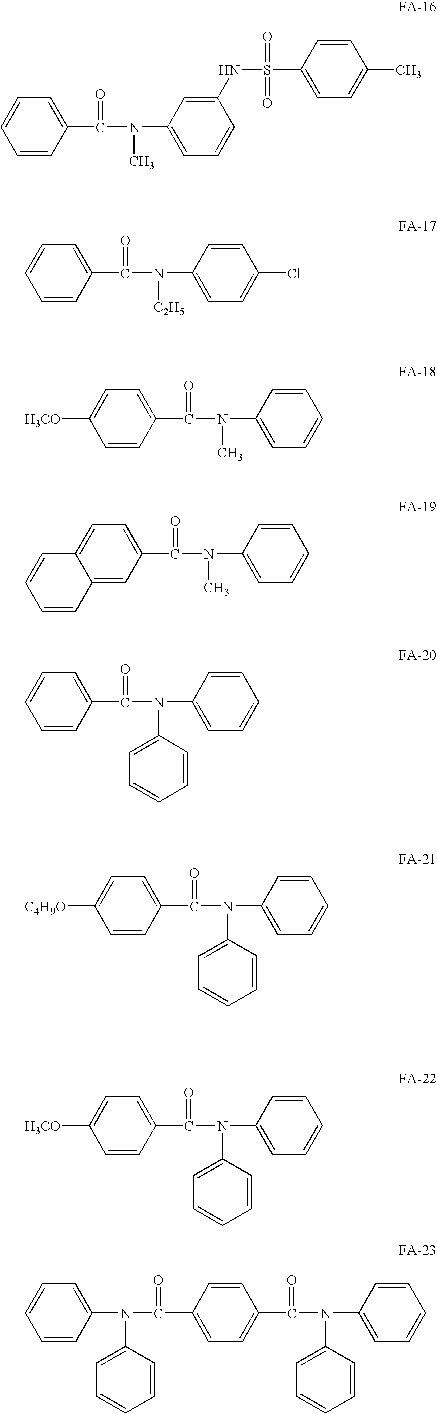

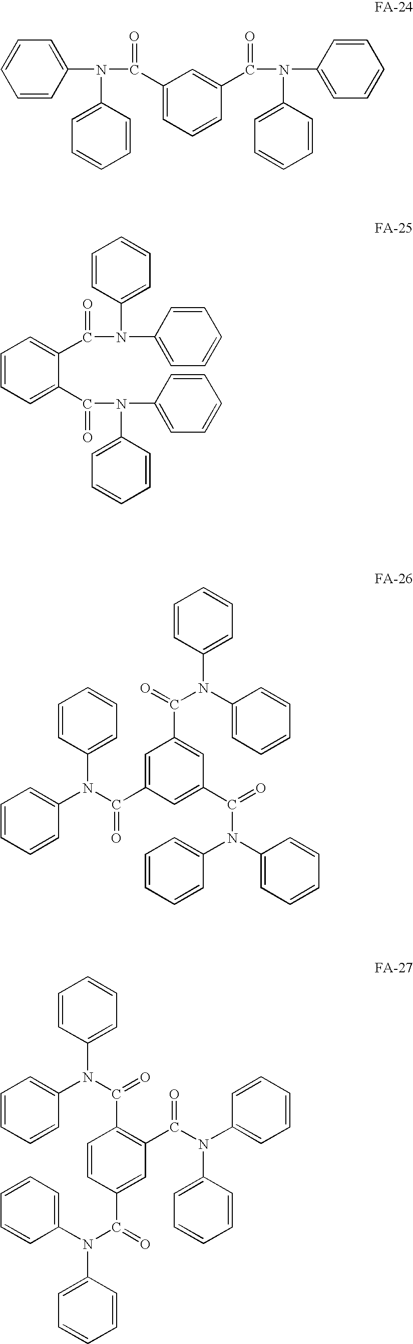

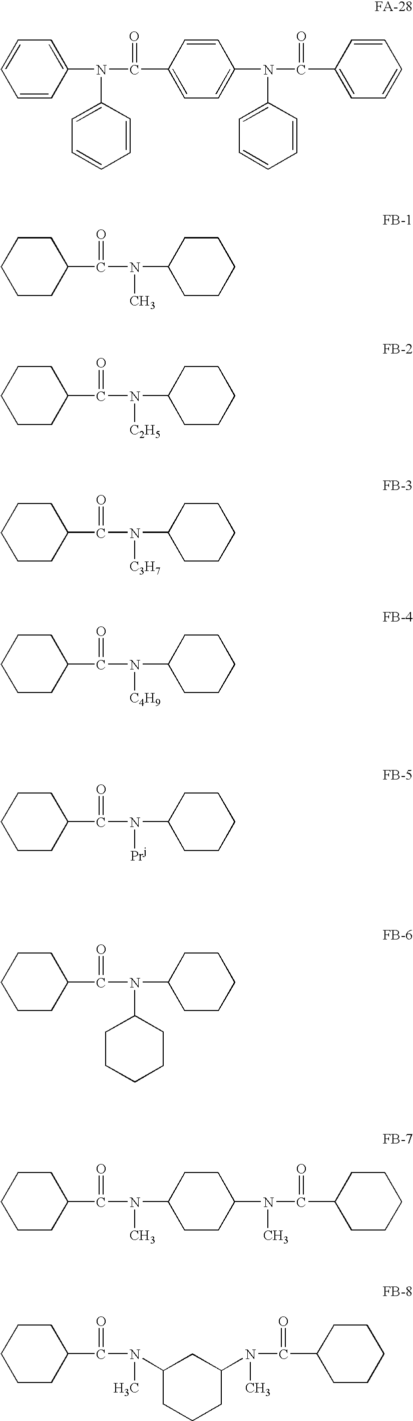

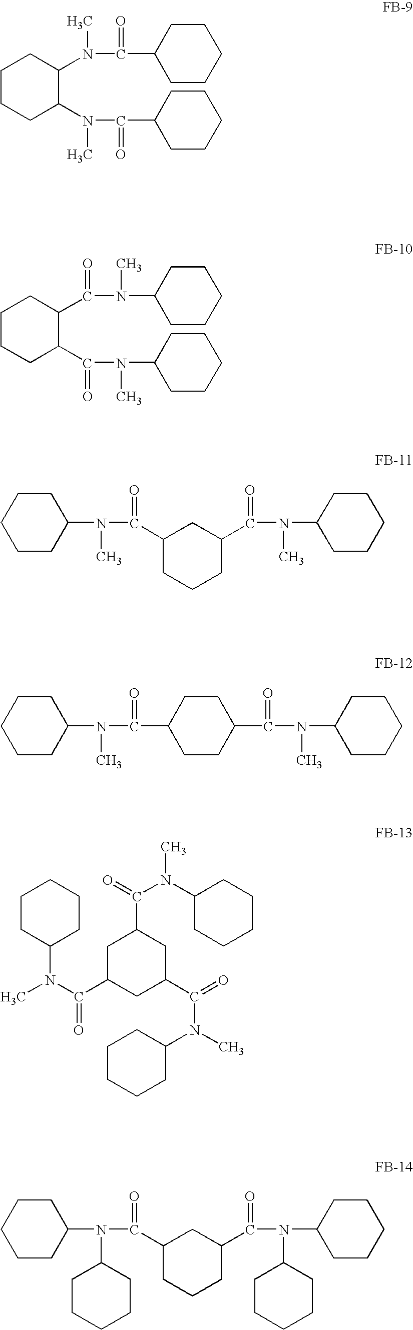

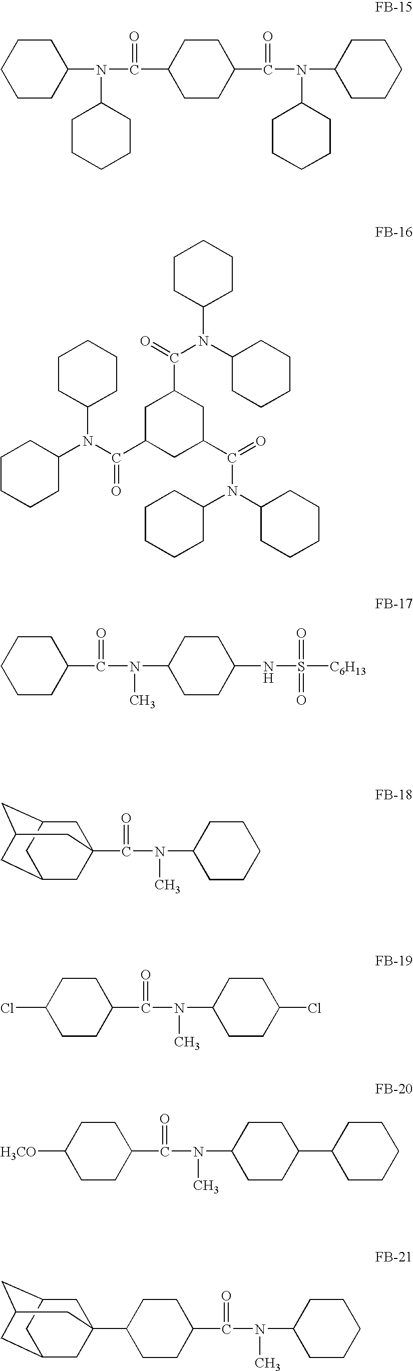

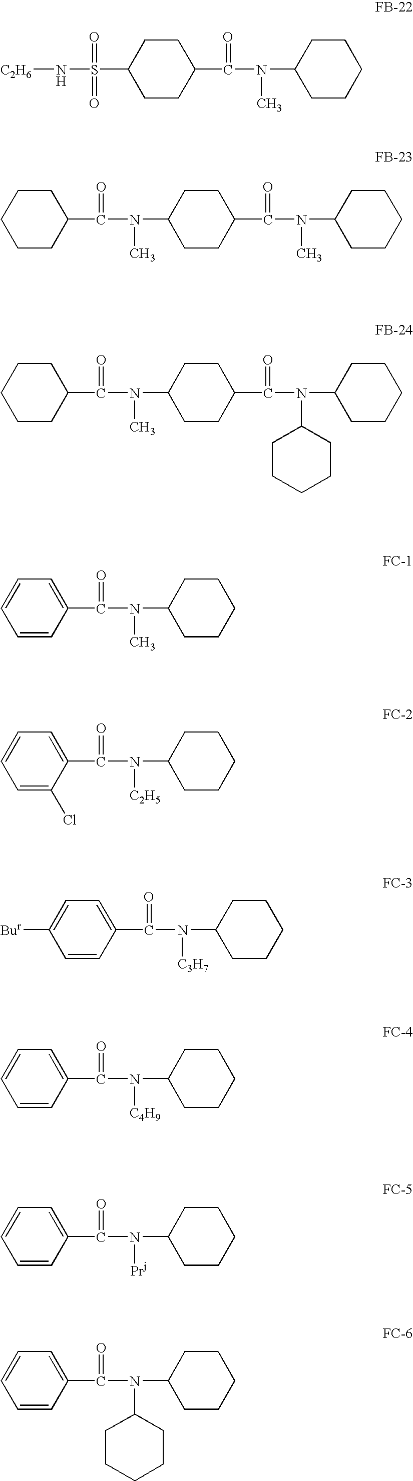

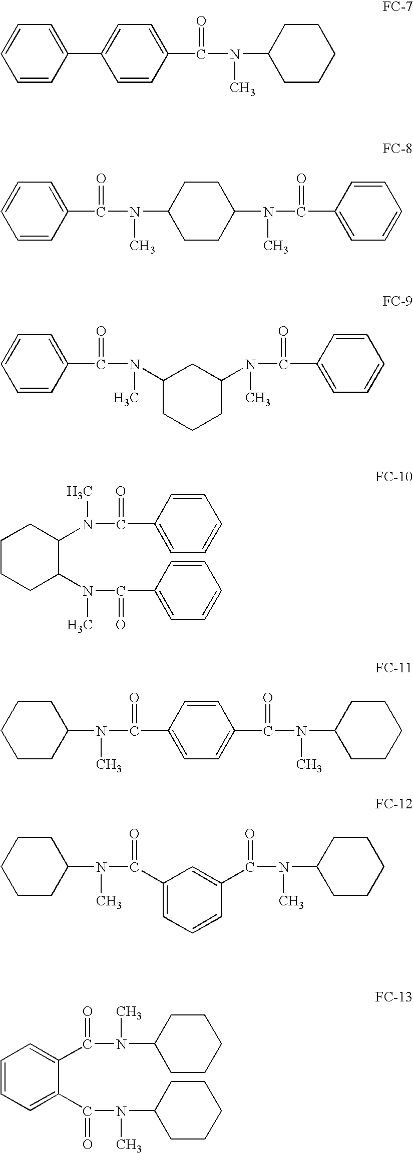

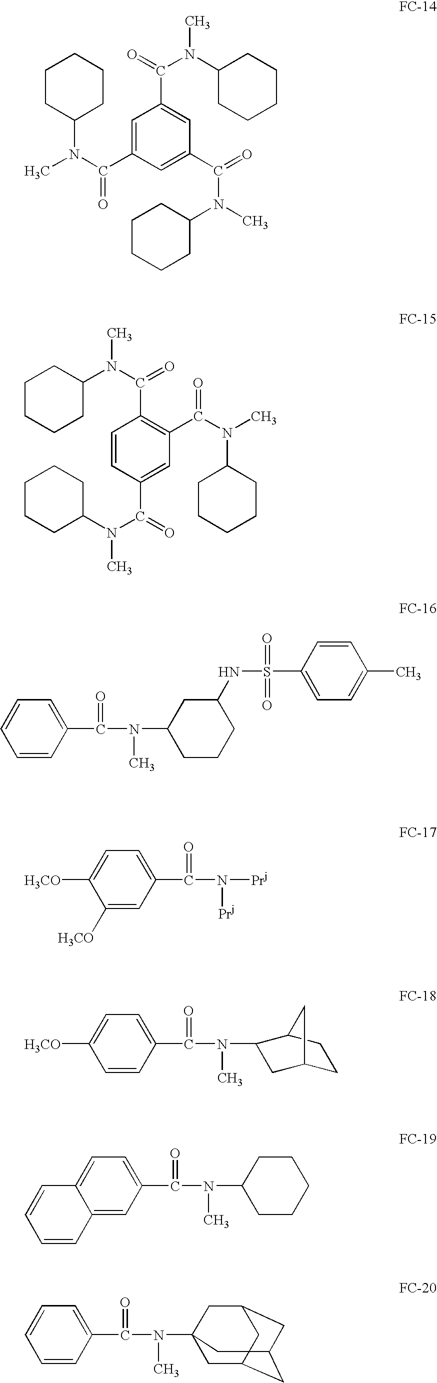

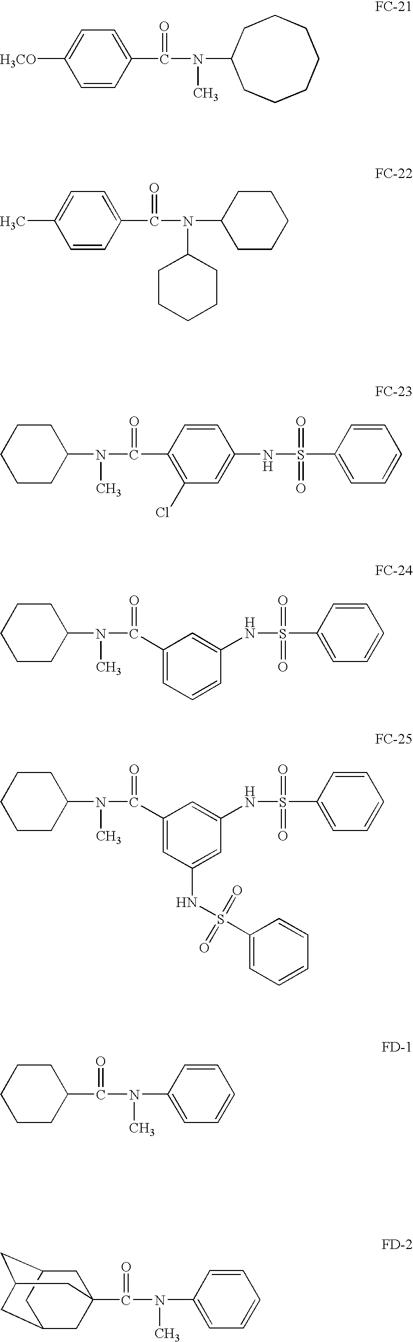

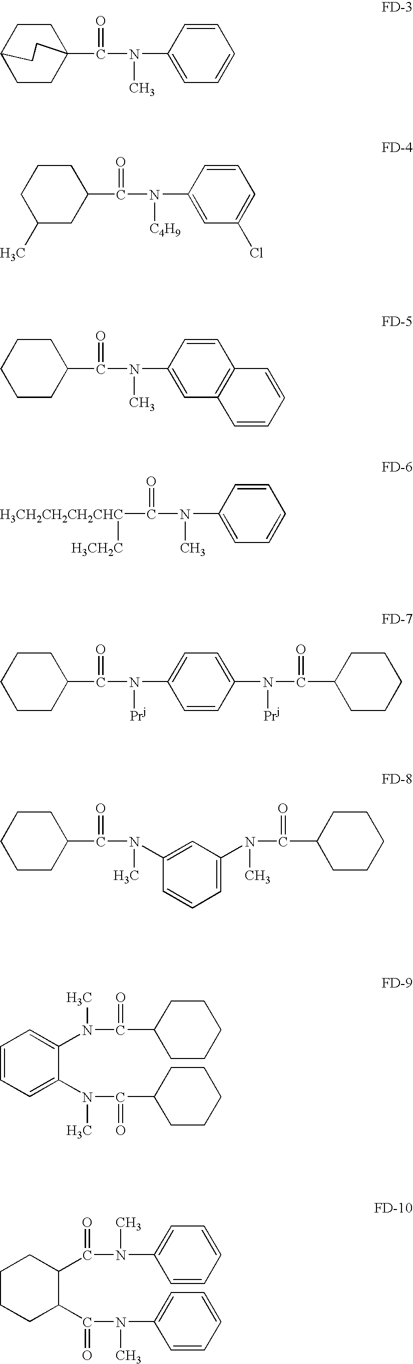

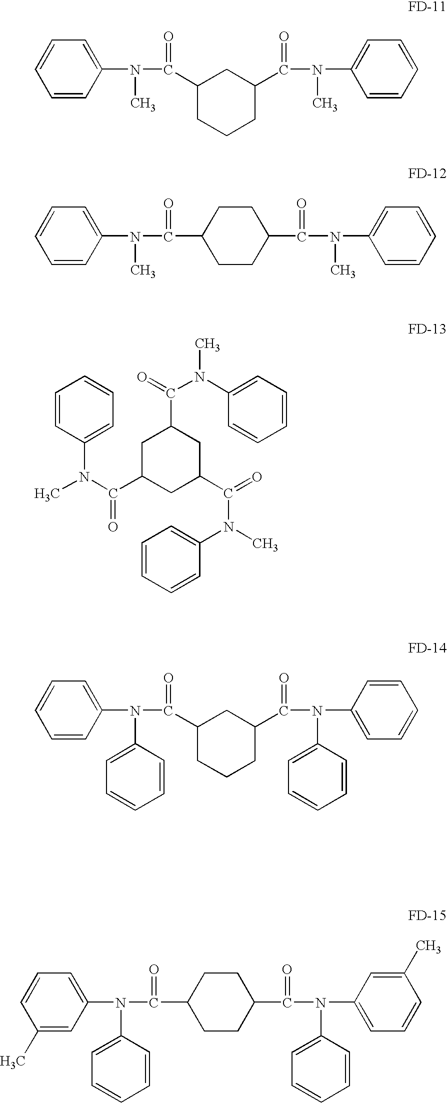

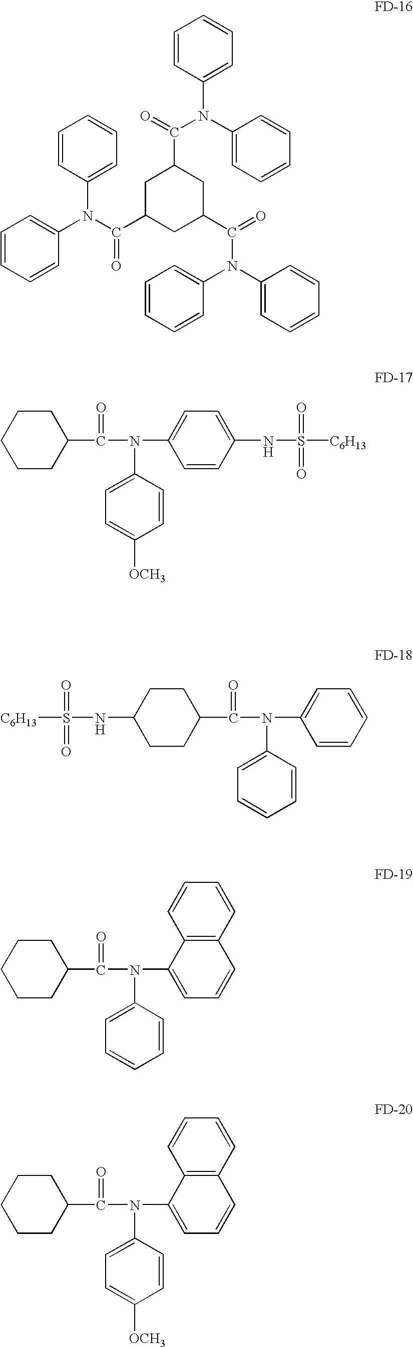

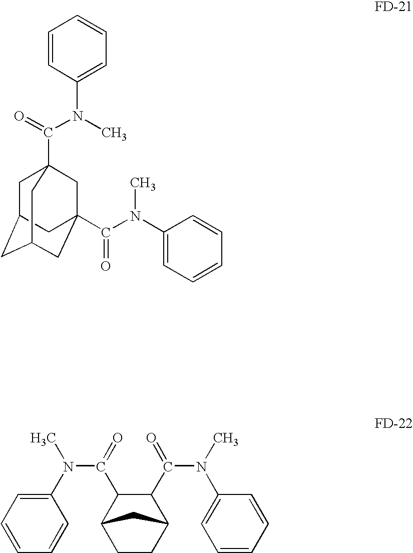

Next, the compound represented by formula (19) is described below.

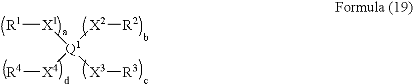

In formula (19), R¹, R², R³, and R⁴ each independently represent a hydrogen atom, a substituted or unsubstituted aliphatic group, or a substituted or unsubstituted aromatic group. X¹, X², X³, and X⁴ each independently represent a divalent linking group formed by at least one selected from the group consisting of a single bond, —CO—, and —NR⁵— (in which R⁵ represents a substituted or unsubstituted aliphatic group, or a substituted or unsubstituted aromatic group). a, b, c, and d each are an integer of 0 or more, and a+b+c+d is 2 or more. Q¹ represents an organic group having a valence of (a+b+c+d).

Preferred examples of the compound represented by formula (19) include compounds represented by any one of formulas (19a) to (19d).

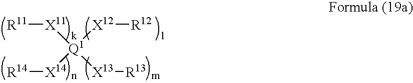

In formula (19a), R¹¹, R¹², R¹³, and R¹⁴ each independently represent a hydrogen atom, a substituted or unsubstituted aliphatic group, or a substituted or unsubstituted aromatic group. X¹¹, X¹², X¹³, and X¹⁴ each independently represent a divalent linking group formed by at least one selected from the group consisting of a single bond, —CO—, and —NR¹⁵— (in which R¹⁵ represents a substituted or unsubstituted aliphatic group, or a substituted or unsubstituted aromatic group). k, l, m, and n each are 0 or 1, and k+l+m+n is 2, 3 or 4. Q² represents an organic group having a valence of 2 to 4.
R²¹—Y¹-L¹-Y²—R²² Formula (19b)

In formula (19b), R²¹ and R²² each independently represent a substituted or unsubstituted aliphatic group, or a substituted or unsubstituted aromatic group. Y¹ and Y² each independently represent —CONR²³— or —NR²⁴CO— (in which R²³ and R²⁴ each represent a substituted or unsubstituted aliphatic group, or a substituted or unsubstituted aromatic group). L¹ represents a divalent organic group formed by at least one group selected from the group consisting of —O—, —S—, —SO—, —SO₂—, —CO—, —NR²⁵— (in which R²⁵ represents a hydrogen atom, a substituted or unsubstituted aliphatic group, or a substituted or unsubstituted aromatic group), an alkylene group, and an arylene group.

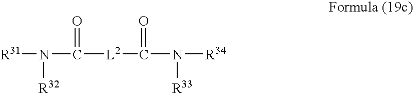

In formula (19c), R³¹, R^{32,} R³³ and R³⁴ each independently represent a substituted or unsubstituted aliphatic group, or a substituted or unsubstituted aromatic group. L² represents a divalent organic group formed by at least one group selected from the group consisting of —O—, —S—, —SO—, —SO₂—, —CO—, —NR³⁵— (in which R³⁵ represents a hydrogen atom, a substituted or unsubstituted aliphatic group, or a substituted or unsubstituted aromatic group), an alkylene group, and an arylene group.

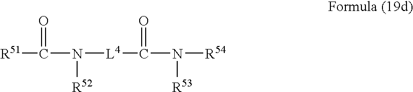

In formula (19d), R⁵¹, R^{52,} R⁵³ and R⁵⁴ each independently represent a substituted or unsubstituted aliphatic group, or a substituted or unsubstituted aromatic group. L⁴ represents a divalent organic group formed by at least one group selected from the group consisting of —O—, —S—, —SO—, —SO₂—, —CO—, —NR⁵⁵— (in which R⁵⁵ represents a hydrogen atom, a substituted or unsubstituted aliphatic group, or a substituted or unsubstituted aromatic group), an alkylene group, and an arylene group.

The compound represented by formula (19) is further described below.

In formula (19), R¹, R², R³, and R⁴ each independently represent a hydrogen atom, a substituted or unsubstituted aliphatic group, or a substituted or unsubstituted aromatic group, and are preferably an aliphatic group. The aliphatic group may be linear, branched, or cyclic, and is more preferably cyclic. The aliphatic group and the aromatic group may have a substituent such as the substituent T described below, but is preferably unsubstituted.

X¹, X², X³, and X⁴ each independently represent a divalent linking group formed by at least one selected from the group consisting of a single bond, —CO—, and —NR⁵— (in which R⁵ represents a substituted or unsubstituted aliphatic group, or a substituted or unsubstituted aromatic group, and is more preferably an unsubstituted group and/or an aliphatic group). The combination of X¹, X², X³, and X⁴ is not particularly limited, and is more preferably selected from —CO— and —NR⁵—.

a, b, c, and d each are an integer of 0 or more, and a+b+c+d is 2 or more. a+b+c+d is preferably from 2 to 8, more preferably from 2 to 6, and further preferably from 2 to 4. Q¹ represents an organic group having a valence of (a+b+c+d) (excluding cyclic groups). The valence of Q¹ is preferably from 2 to 8, more preferably from 2 to 6, and most preferably from 2 to 4. Herein, the term ‘organic group’ means a group or moiety which is formed from an organic compound.

In formula (19a), R¹¹, R¹², R¹³, and R¹⁴ each independently represent a hydrogen atom, a substituted or unsubstituted aliphatic group, or a substituted or unsubstituted aromatic group, and are preferably an aliphatic group. The aliphatic group may be linear, branched, or cyclic, and is more preferably cyclic. The aliphatic group and the aromatic group may have a substituent such as the substituent T described below, but is preferably unsubstituted.

X¹¹, X¹², X¹³, and X¹⁴ each independently represent a divalent linking group formed by at least one selected from the group consisting of a single bond, —CO—, and —NR¹⁵— (in which R¹⁵ represents a substituted or unsubstituted aliphatic group, or a substituted or unsubstituted aromatic group, and is more preferably an unsubstituted group and/or an aliphatic group). The combination of X¹¹, X¹², X¹³, and X¹⁴ is not particularly limited, and is more preferably selected from —CO— and —NR¹⁵—.

k, l, m, and n each are 0 or 1, and k+l+m+n=2, 3, or 4. Q¹ represents a divalent to tetravalent organic group (excluding cyclic groups). The valence of Q¹ is preferably 2 or 3.

In formula (19b), R²¹ and R²² each independently represent a substituted or unsubstituted aliphatic group, or a substituted or unsubstituted aromatic group, and are preferably an aliphatic group. The aliphatic group may be linear, branched, or cyclic, and is more preferably cyclic. The aliphatic group and the aromatic group may have a substituent such as the substituent T described below, but is preferably unsubstituted.

Y¹ and Y² each independently represent —CONR²³— or —NR²⁴CO—; in which R²³ and R²⁴ each represent a substituted or unsubstituted aliphatic group, or a substituted or unsubstituted aromatic group, and are more preferably an unsubstituted group and/or an aliphatic group. L¹ represents a divalent organic group (excluding cyclic groups) formed by at least one selected from the group consisting of —O—, —S—, —SO—, —SO₂—, —CO—, —NR²⁵—, an alkylene group, and an arylene group.

The combination of L¹ is not particularly limited, and is preferably selected from —O—, —S—, —NR²⁵—, and an alkylene group, more preferably selected from —O—, —S—, and an alkylene group, and most preferably selected from —O—, —S—, and an alkylene group.

In formula (19c), R³¹, R³², R³³, and R³⁴ each independently represent a substituted or unsubstituted aliphatic group, or a substituted or unsubstituted aromatic group, and are preferably an aliphatic group. The aliphatic group may be linear, branched, or cyclic, and is more preferably cyclic. The aliphatic group and the aromatic group may have a substituent such as the substituent T described below, but is preferably unsubstituted.

L² represents a divalent linking group formed by at least one selected from the group consisting of —O—, —S—, —SO—, —SO₂—, —CO—, —NR³⁵-(in which R³⁵ represents a substituted or unsubstituted aliphatic group, or a substituted or unsubstituted aromatic group, and is more preferably an unsubstituted group and/or an aliphatic group), an alkylene group, and an arylene group. The combination of L² is not particularly limited, and is preferably selected from —O—, —S—, —NR³⁵—, and an alkylene group, more preferably selected from —O—, —S—, and an alkylene group, and most preferably selected from —O—, —S—, and an alkylene group.

In formula (19d), R⁵¹, R⁵², R⁵³, and R⁵⁴ each independently represent a substituted or unsubstituted aliphatic group, or a substituted or unsubstituted aromatic group, and are preferably an aliphatic group. The aliphatic group may be linear, branched, or cyclic, and is more preferably cyclic. The aliphatic group and the aromatic group may have a substituent such as the substituent T described below, but is preferably unsubstituted.

L⁴ represents a divalent linking group formed by at least one selected from the group consisting of —O—, —S—, —SO—, —SO₂—, —CO—, —NR⁵⁵— (in which R⁵⁵ represents a substituted or unsubstituted aliphatic group, or a substituted or unsubstituted aromatic group, and is more preferably an unsubstituted group and/or an aliphatic group), an alkylene group, and an arylene group. The combination of L⁴ is not particularly limited, and is preferably selected from —O—, —S—, —NR⁵⁵—, and an alkylene group, more preferably selected from —O—, —S—, and an alkylene group, and most preferably selected from —O—, —S—, and an alkylene group.

The aliphatic group represented by R¹ to R⁵, R¹¹ to R¹⁵, R²¹ to R²⁵, R³¹ to R³⁵, and R⁵¹ to R⁵⁵ in formulae (19) and (19a) to (19d) is further described below. The aliphatic group may be linear, branched, or cyclic, and preferably has 1 to 25 carbon atoms, more preferably has 6 to 25 carbon atoms, and particularly preferably 6 to 20 carbon atoms. Specific examples of the aliphatic group include a methyl group, an ethyl group, a n-propyl group, an isopropyl group, a cyclopropyl group, a n-butyl group, an isobutyl group, a tert-butyl group, an amyl group, an isoamyl group, a tert-amyl group, a n-hexyl group, a cyclohexyl group, a n-heptyl group, a n-octyl group, a bicyclooctyl group, an adamantyl group, a n-decyl group, a tert-octyl group, a dodecyl group, a hexadecyl group, an octadecyl group, and a didecyl group.

The aromatic group represented by R¹ to R⁵, R¹¹ to R¹⁵, R²¹ to R²⁵, R³¹ to R³⁵, and R⁵¹ to R⁵⁵ in formulae (19) and (19a) to (19d) is further described below. The aromatic group may be an aromatic hydrocarbon group or an aromatic heterocyclic group, and more preferably an aromatic hydrocarbon group. The aromatic hydrocarbon group preferably has 6 to 24 carbon atoms, and more preferably 6 to 12 carbon atoms. Specific examples of the ring of the aromatic hydrocarbon group include benzene, naphthalene, anthracene, biphenyl, and terphenyl rings. The aromatic hydrocarbon group is particularly preferably a benzene, naphthalene, or biphenyl group. The aromatic heterocyclic group preferably contains at least one oxygen atom, nitrogen atom, and/or sulfur atom. Specific examples of the heterocycle include furan, pyrrole, thiophene, imidazole, pyrazole, pyridine, pyradine, pyridazine, triazole, triazine, indole, indazole, purin, thiazoline, thiadiazole, oxazoline, oxazole, oxadiazole, quinoline, isoquinoline, phthalazine, naphthyridine, quinoxaline, quinazoline, cinnoline, pteridine, acridine, phenanthroline, phenazine, tetrazole, benzimidazole, benzoxazole, benzothiazole, benzotriazole, and tetrazaindene rings. The aromatic heterocycle is particularly preferably a pyridine, triazine, or quinoline ring.

The substituent T as mentioned in formulae (15), (15a), (15c), (17), (17a), (19), and (19a) to (19d) is described in detail below.

Examples of the substituent T include an alkyl group (preferably an alkyl group having from 1 to 20, more preferably from 1 to 12, and particularly preferably from 1 to 8 carbon atoms, e.g., methyl, ethyl, iso-propyl, tert-butyl, n-octyl, n-decyl, n-hexadecyl, cyclopropyl, cyclopentyl, cyclohexyl), an alkenyl group (preferably an alkenyl group having from 2 to 20, more preferably from 2 to 12, and particularly preferably from 2 to 8 carbon atoms, e.g., vinyl, allyl, 2-butenyl, 3-pentenyl), an alkynyl group (preferably an alkynyl group having from 2 to 20, more preferably from 2 to 12, and particularly preferably from 2 to 8 carbon atoms, e.g., propargyl, 3-pentynyl), an aryl group (preferably an aryl group having from 6 to 30, more preferably from 6 to 20, and particularly preferably from 6 to 12 carbon atoms, e.g., phenyl, p-methylphenyl, biphenyl, naphthyl), a substituted or unsubstituted amino group (preferably an amino group having from 0 to 20, more preferably from 0 to 10, and particularly preferably from 0 to 6 carbon atoms, e.g., amino, methylamino, dimethylamino, diethylamino, dibenzylamino), an alkoxy group (preferably an alkoxy group having from 1 to 20, more preferably from 1 to 12, and particularly preferably from 1 to 8 carbon atoms, e.g., methoxy, ethoxy, butoxy), an aryloxy group (preferably an aryloxy group having from 6 to 20, more preferably from 6 to 16, and particularly preferably from 6 to 12 carbon atoms, e.g., phenyloxy, 2-naphthyloxy), an acyl group (preferably an acyl group having from 1 to 20, more preferably from 1 to 16, and particularly preferably from 1 to 12 carbon atoms, e.g., acetyl, benzoyl, formyl, pivaloyl), an alkoxycarbonyl group (preferably an alkoxycarbonyl group having from 2 to 20, more preferably from 2 to 16, and particularly preferably from 2 to 12 carbon atoms, e.g., methoxycarbonyl, ethoxycarbonyl), an aryloxycarbonyl group (preferably an aryloxycarbonyl group having from 7 to 20, more preferably from 7 to 16, and particularly preferably from 7 to 10 carbon atoms, e.g., phenyloxycarbonyl), an acyloxy group (preferably an acyloxy group having from 2 to 20, more preferably from 2 to 16, and particularly preferably from 2 to 10 carbon atoms, e.g., acetoxy, benzoyloxy), an acylamino group (preferably an acylamino group having from 2 to 20, more preferably from 2 to 16, and particularly preferably from 2 to 10 carbon atoms, e.g., acetylamino, benzoylamino), an alkoxycarbonylamino group (preferably an alkoxycarbonylamino group having from 2 to 20, more preferably from 2 to 16, and particularly preferably from 2 to 12 carbon atoms, e.g., methoxycarbonylamino), an aryloxycarbonylamino group (preferably an aryloxycarbonylamino group having from 7 to 20, more preferably from 7 to 16, and particularly preferably from 7 to 12 carbon atoms, e.g., phenyloxycarbonylamino), a sulfonylamino group (preferably a sulfonylamino group having from 1 to 20, more preferably from 1 to 16, and particularly preferably from 1 to 12 carbon atoms, e.g., methanesulfonylamino, benzenesulfonylamino), a sulfamoyl group (preferably a sulfamoyl group having from 0 to 20, more preferably from 0 to 16, and particularly preferably from 0 to 12 carbon atoms, e.g., sulfamoyl, methylsulfamoyl, dimethylsulfamoyl, phenylsulfamoyl), a carbamoyl group (preferably a carbamoyl group having from 1 to 20, more preferably from 1 to 16, and particularly preferably from 1 to 12 carbon atoms, e.g., carbamoyl, methylcarbamoyl, diethylcarbamoyl, phenylcarbamoyl), an alkylthio group (preferably an alkylthio group having from 1 to 20, more preferably from 1 to 16, and particularly preferably from 1 to 12 carbon atoms, e.g., methylthio, ethylthio), an arylthio group (preferably an arylthio group having from 6 to 20, more preferably from 6 to 16, and particularly preferably from 6 to 12 carbon atoms, e g., phenylthio), a sulfonyl group (preferably a sulfonyl group having from 1 to 20, more preferably from 1 to 16, and particularly preferably from 1 to 12 carbon atoms, e.g., mesyl, tosyl), a sulfinyl group (preferably a sulfinyl group having from 1 to 20, more preferably from 1 to 16, and particularly preferably from 1 to 12 carbon atoms, e.g., methanesulfinyl, benzenesulfinyl), a ureido group (preferably a ureido group having from 1 to 20, more preferably from 1 to 16, and particularly preferably from 1 to 12 carbon atoms, e.g., ureido, methylureido, phenylureido), a phosphoric acid amido group (preferably a phosphoric acid amido group having from 1 to 20, more preferably from 1 to 16, and particularly preferably from 1 to 12 carbon atoms, e.g., diethylphosphoric acid amido, phenylphosphoric acid amido), a hydroxy group, a mercapto group, a halogen atom (e.g., fluorine, chlorine, bromine, or iodine atom), a cyano group, a sulfo group, a carboxyl group, a nitro group, a hydroxamic acid group, a sulfino group, a hydrazino group, an imino group, a heterocyclic group (preferably a heterocyclic group having from 1 to 30, and more preferably from 1 to 12 carbon atoms; containing, as a hetero atom(s), for example, a nitrogen atom, an oxygen atom, or a sulfur atom, and specifically, e.g., imidazolyl, pyridyl, quinolyl, furyl, piperidyl, morpholino, benzoxazolyl, benzimidazolyl, benzothiazolyl can be exemplified), and a silyl group (preferably a silyl group having 3 to 40, more preferably 3 to 30, and particularly preferably 3 to 24 carbon atoms, e.g. trimethylsilyl, triphenylsilyl).

These substituents may be further substituted, and if they have two or more substituents, these substituents may be the same or different from each other; or alternatively they may be combined each other, to form a ring, if possible.

Specific preferred examples of the compound represented by any one of formulas (19), and (19a) to (19d) are shown below, but the present invention is not limited thereto.

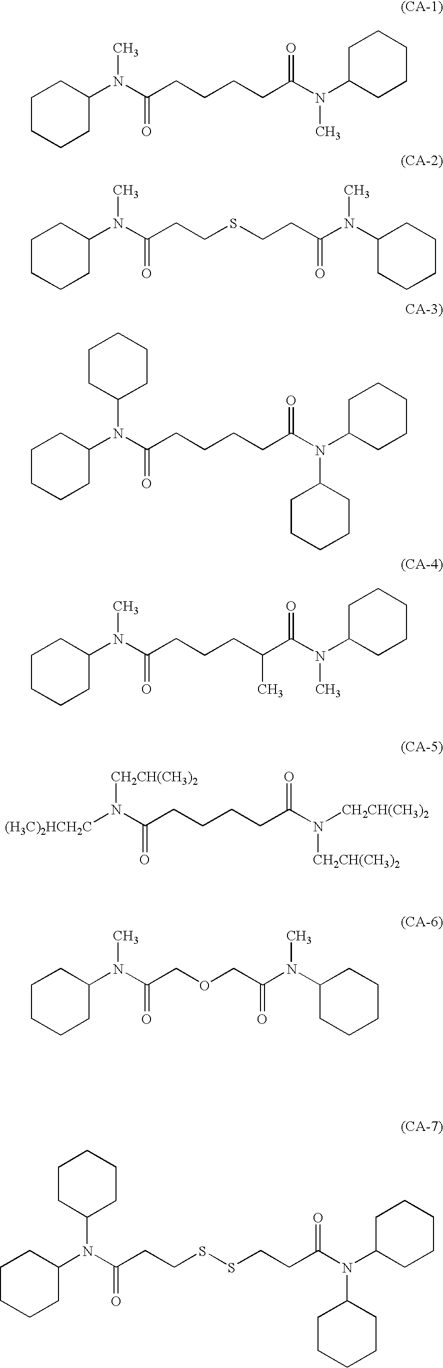

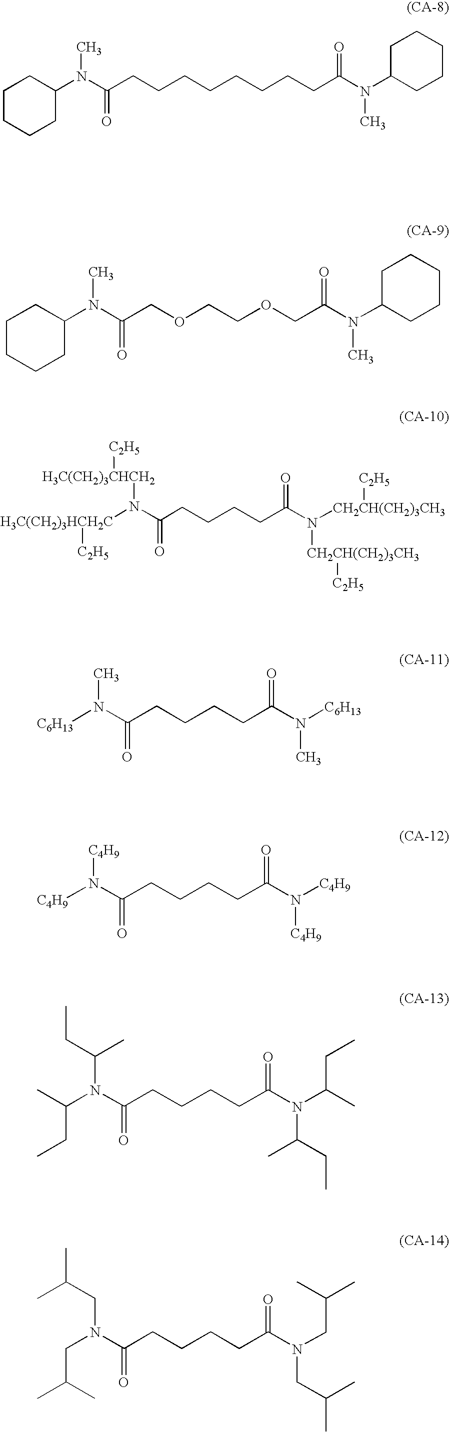

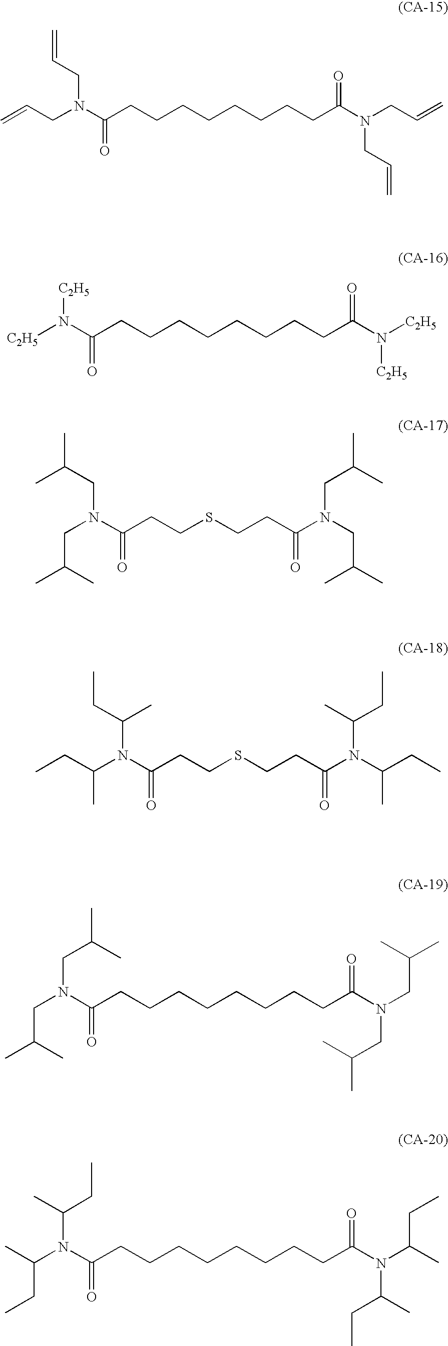

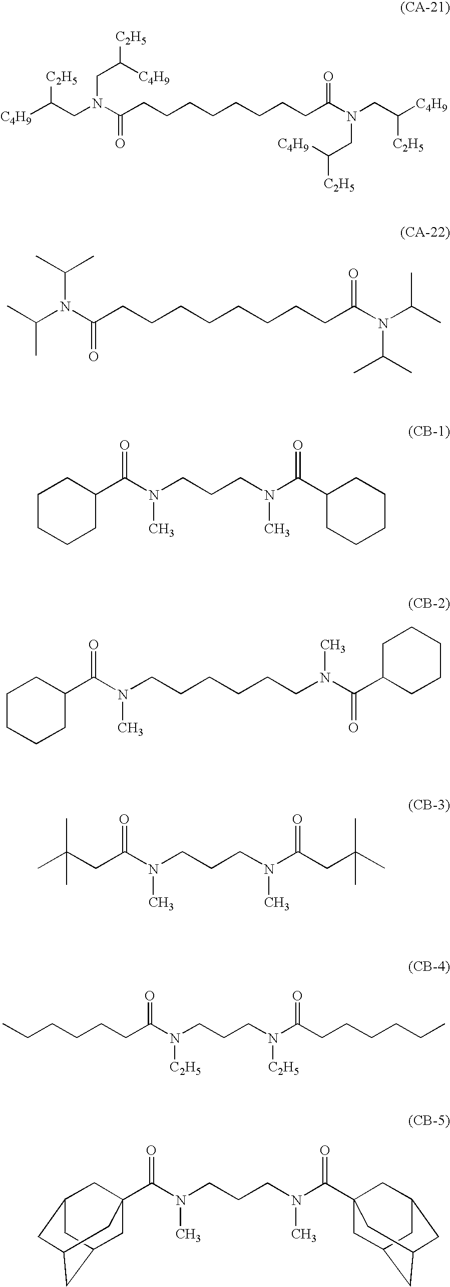

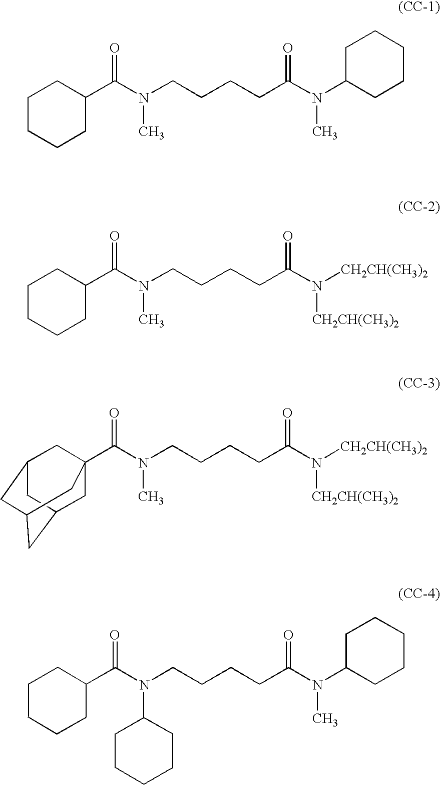

Each of the compounds that can be used in the present invention can be prepared from a known compound(s). The compound represented by any one of formulas (19), and (19a) to (19d) is prepared, for example, through the condensation reaction between carbonyl chloride and an amine.

In the present invention, Rth can be further reduced, by combining the above-described cellulose compound having substituents large in polarizability anisotropy (or high in polarizability anisotropy), with the above-described retardation-controlling agent. The mechanism of action of further reducing Rth is not made clear, but is assumed as follows. When the substituents of the cellulose compound having a high polarizability are combined with the retardation-controlling agent having high compatibility with the substituents, the substituents are more freely oriented during film formation, which increases the proportion of the substituents oriented along the film thickness direction, and resultantly reduces the Rth of the film.

<log P Value>

In the preparation of the cellulose compound film of the present invention, it is preferable that a compound having an octanol-water partition coefficient (log P value) of 1 to 10 be used as the retardation-controlling agent. This is because, as described above, the proportion of the substituents of the cellulose compound in the film which substituents be oriented along the film thickness direction, is further increased, as the increase in the compatibility of the retardation-controlling agent with the substituents having a high polarizability anisotropy. When the log P value is 10 or less, the retardation-controlling agent has favorable compatibility with the substituents on the cellulose compound, sufficiently reduces the Rth, and will not cause problems such as white turbid phenomenon or chalking (bleedout) on the film, thus this upper limit is preferable. On the other hand, when the log P value is 1 or more, problems such as excessive hydrophilicity or deterioration of water resistance of the cellulose compound film will not occur, thus this lower limit is preferable. The log P value is more preferably in the range of 1 to 6, and particularly preferably in the range of 1.5 to 5.

The octanol-water partition coefficient (log P value) may be measured by a flask shaking method as described in Japanese Industrial Standards (JIS) Z7260-107 (2000). Alternatively, in place of actual measurement, the octanol-water partition coefficient (log P value) may be estimated by a computational chemical method or an empirical method. Preferable examples of the computation that can be used include Crippen's fragmentation method (J. Chem. Inf. Comput. Sci., 27, 21 (1987)), Viswanadhan's fragmentation method (J. Chem. Inf. Comput. Sci., 29, 163 (1989)), and Broto's fragmentation method (Eur. J. Med. Chem.-Chim. Theor., 19, 71 (1984)); and among them, Crippen's fragmentation method (J. Chem. Inf. Comput. Sci., 27, 21 (1987)) is more preferable. If a compound has different log P values according to the methods of measurement or computation, it is preferable to apply the Crippen's fragmentation method to determine whether the compound in interest is within the range as specified in the present invention or not.

<Physical Properties of Retardation-Controlling Agent>

As described above, the retardation-controlling agent may have an aromatic group, or no aromatic group. The molecular weight of the retardation-controlling agent is preferably 3,000 or less, more preferably 150 or more but 3,000 or less, further preferably 170 or more but 2,000 or less, and particularly preferably 200 or more but 1,000 or less. The retardation-controlling agent may have a specific monomer structure, or an oligomer structure or polymer structure in which a plurality of the monomer units are combined together, as long as it has a molecular weight in the above-described preferable range.

The retardation-controlling agent is preferably liquid at 25° C., or solid having a melting point of 25 to 250° C., and it is more preferably liquid at 25° C. or solid having a melting point of 25 to 200° C. The retardation-controlling agent is preferably not volatilized in the course of dope casting and drying steps in the preparation of the cellulose compound film.

The amount to be added of the retardation-controlling agent is preferably 0.01 to 30% by mass, more preferably 1 to 25% by mass, and particularly preferably 3 to 20% by mass, to the cellulose compound.

The retardation-controlling agent may be used alone, or in combination of two or more kinds of compounds mixed at an arbitrary ratio.

The retardation-controlling agent may be added at any time during the dope making process, and may be added at the end of the dope making step.

(Other Optical Anisotropy Reducing Agent)

The optical anisotropy can be reduced also by adding, to the cellulose compound, a polyhydric alcohol ester compound, a carboxylate ester compound, a polycyclic carboxylic acid compound, or a bisphenol derivative, each having an octanol-water partition coefficient (log P value) of 0 to 7. More specifically, these compounds is also capable of reducing the optical anisotropy of the cellulose compound film, and any of those compounds may be used together with the retardation-controlling agent in the present invention.

Specific examples of the above-described polyhydric alcohol ester compound, carboxylate ester compound, polycyclic carboxylic acid compound, and bisphenol derivative, each having an octanol-water partition coefficient (log P value) of 0 to 7, are shown blow.

<Polyhydric Alcohol Ester Compound>

The polyhydric alcohol ester preferably used in the present invention is an ester of a polyhydric alcohol having a valence of 2 or more and one or more kinds of a monocarboxylic acid. Examples of the polyhydric alcohol ester compound include the followings, but the invention is not limited to them.

“Polyhydric Alcohol”

Preferable examples of the polyhydric alcohol include adonitol, arabitol, ethylene glycol, diethylene glycol, triethylene glycol, tetraethylene glycol, 1,2-propanediol, 1,3-propanediol, dipropylene glycol, tripropylene glycol, 1,2-butanediol, 1,3-butanediol, 1,4-butanediol, dibutylene glycol, 1,2,4-butanetriol, 1,5-pentanediol, 1,6-hexanediol, hexanetriol, galactitol, mannitol, 3-methylpentane-1,3,5-triol, pinacol, sorbitol, trimethylolpropane, trimethylolethane, and xylitol. Among them, triethylene glycol, tetraethylene glycol, dipropylene glycol, tripropylene glycol, sorbitol, trimethylol propane, and xylitol are particularly preferable.

“Monocarboxylic Acid”

Preferable monocarboxylic acid is not particularly limited, and may be selected from, for example, any of known aliphatic monocarboxylic acids, alicyclic monocarboxylic acids, aromatic monocarboxylic acids. It is preferable to use an alicyclic monocarboxylic acid or aromatic monocarboxylic acid for further improving the moisture permeability, moisture content, and retention properties of the cellulose compound film.

Preferable examples of the monocarboxylic acid include the followings, but the invention is not limited to them.

The aliphatic monocarboxylic acid is preferably a linear or branched fatty acid having 1 to 32 carbon atoms. The number of carbon atoms is more preferably 1 to 20, and particularly preferably 1 to 10. Inclusion of acetic acid is preferable for increasing the compatibility with a cellulose ester, and it is also preferable to combine acetic acid with another monocarboxylic acid for use.

Preferable examples of the aliphatic monocarboxylic acid include saturated fatty acids, such as acetic acid, propionic acid, butyric acid, valeric acid, caproic acid, enanthic acid, caprylic acid, pelargonic acid, capric acid, 2-ethyl-hexanecarboxylic acid, undecyl acid, lauric acid, tridecyl acid, myristic acid, pentadecyl acid, palmitic acid, heptadecyl acid, stearic acid, nonadecanoic acid, arachidic acid, behenic acid, lignoceric acid, cerinic acid, heptacosanic acid, montanic acid, melissic acid, and lacseric acid; and unsaturated fatty acids, such as undecylenic acid, oleic acid, sorbic acid, linolic acid, linolenic acid, and arachidonic acid. Those acids each may have a substituent.

Preferable examples of the alicyclic monocarboxylic acid include cyclopentanecarboxylic acid, cyclohexanecarboxylic acid, cyclooctanecarboxylic acid, and derivatives thereof.

Preferable examples of the aromatic monocarboxylic acid include benzoic acid; benzoic acid derivatives having an alky group introduced on the benzene ring thereof, such as toluic acid; aromatic monocarboxylic acids having two or more benzene rings, such as biphenyl carboxylic acid, naphthalene carboxylic acid, and tetralincarboxylic acid; and derivatives thereof. Among them, benzoic acid is particularly preferable.

The polyhydric alcohol ester that can be used in the present invention may contain a single kind of carboxylic acid or a combination of two or more kinds of carboxylic acids. Further, OH groups in the polyhydric alcohol may be wholly esterified, or partially esterified with some OH groups remained. The polyhydric alcohol ester preferably has three or more aromatic rings or cycloalkyl rings within the molecule.

Examples of the polyhydric alcohol ester compound include the following compounds, but the invention is not limited to them. 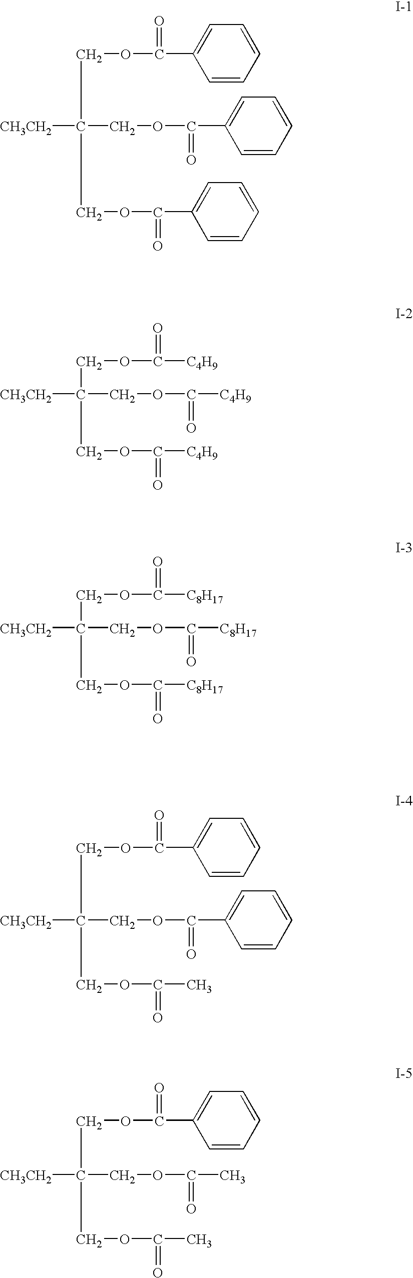 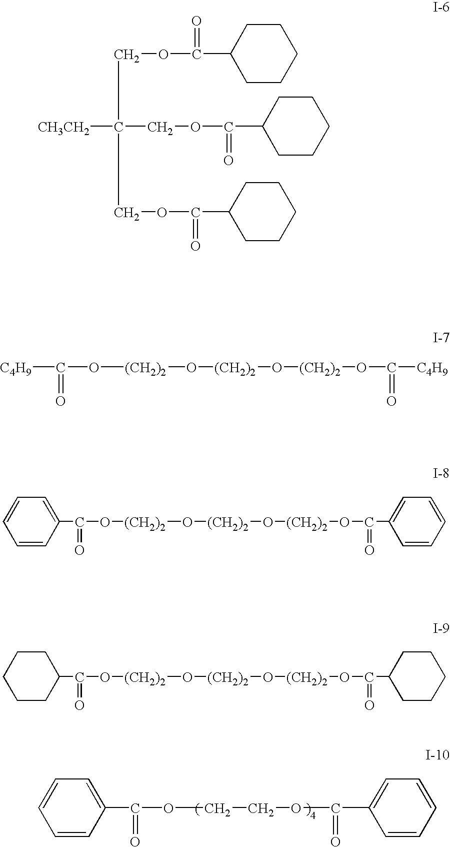
<Carboxylic Acid Ester Compound>

Examples of the carboxylic acid ester compound include the following compounds, but the invention is not limited to them. Specific examples thereof include phthalic acid esters and citric acid esters, including: phthalates, e.g. dimethyl phthalate, diethyl phthalate, dicyclohexyl phthalate, dioctyl phthalate, and diethylhexyl phthalate, and citrates, e g. acetyltriethyl citrate, and acetyltributyl citrate. Other examples include butyl oleate, methylacetyl ricinoleate, dibutyl sebacate, triacetin, and trimethylolpropane tribenzoate. Alkylphthalylalkyl glycolate is also preferable to be used for this purpose. The alkyl moiety in the alkylphthalylalkyl glycolate is an alkyl group having 1 to 8 carbon atoms. Examples of the alkyl phthalyl alkyl glycolate include methyl phthalyl methyl glycolate, ethyl phthalyl ethyl glycolate, propyl phthalyl propyl glycolate, butyl phthalyl butyl glycolate, octyl phthalyl octyl glycolate, methyl phthalyl ethyl glycolate, ethyl phthalyl methyl glycolate, ethyl phthalyl propyl glycolate, propyl phthalyl ethyl glycolate, methyl phthalyl propyl glycolate, methyl phthalyl butyl glycolate, ethyl phthalyl butyl glycolate, butyl phthalyl methyl glycolate, butyl phthalyl ethyl glycolate, propyl phthalyl butyl glycolate, butyl phthalyl propyl glycolate, methyl phthalyl octyl glycolate, ethyl phthalyl octyl glycolate, octyl phthalyl methyl glycolate, and octyl phthalyl ethyl glycolate. Among these, methyl phthalyl methyl glycolate, ethyl phthalyl ethyl glycolate, propyl phthalyl propyl glycolate, butyl phthalyl butyl glycolate, and octyl phthalyl octyl glycolate are preferable, and ethyl phthalyl ethyl glycolate is particularly preferable for use. Further, these alkylphthalylalkyl glycolate and others may be used in combination of two or more of them.

Examples of the carboxylic acid ester compound include the following compounds, but the invention is not limited to them. 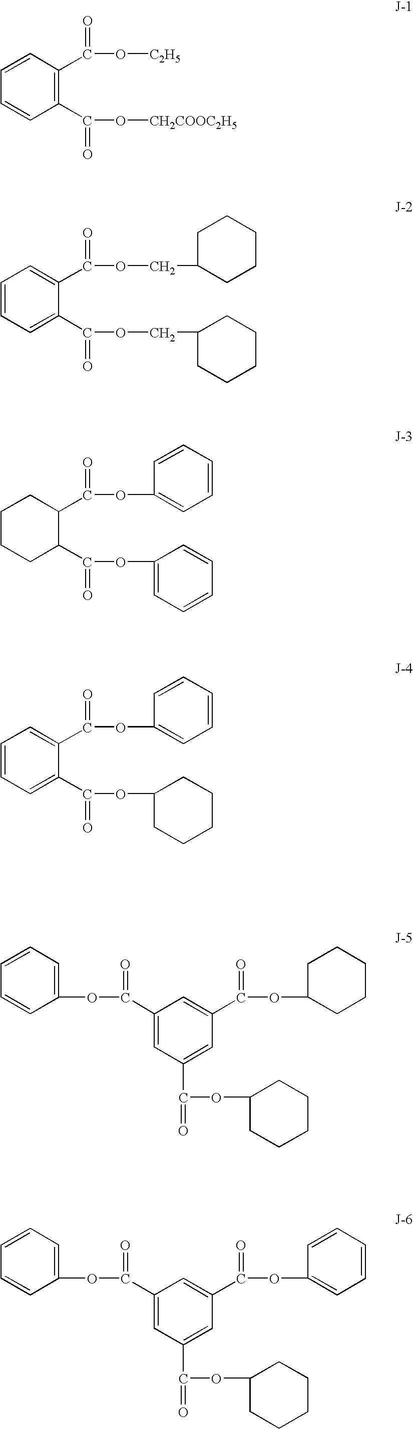 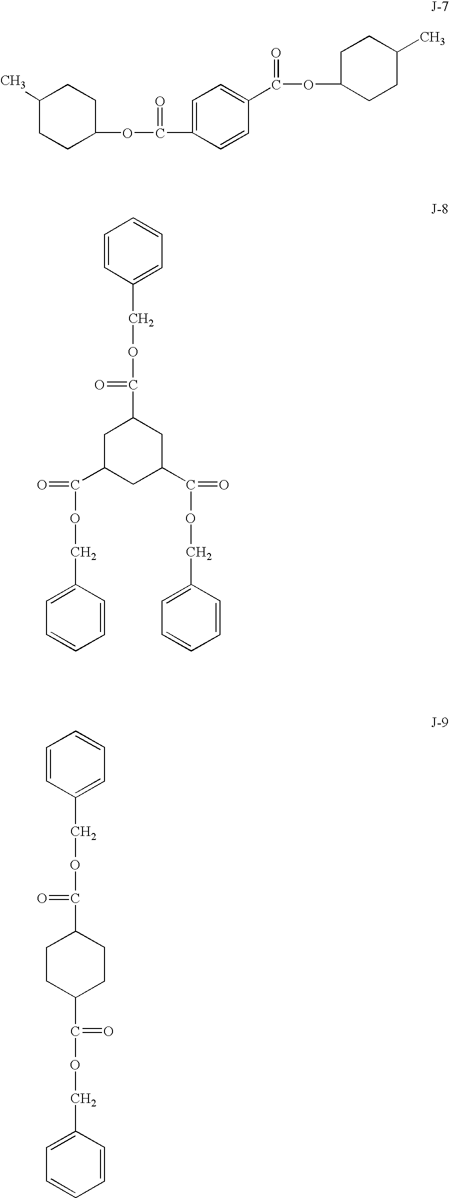
<Polycyclic Carboxylic Acid Compound>

The polycyclic carboxylic acid compound that can be used in the present invention preferably has a molecular weight of 3,000 or less, and particularly preferably from 250 to 2,000. The cyclic structure thereof is not particularly limited as to the size of the ring, but the ring is preferably composed of 3 to 8 atoms, and particularly preferably a 6-membered ring and/or 5-membered ring. These rings may contain carbon, oxygen, nitrogen, silicon, or other atoms, some bonds of the ring may be unsaturated, and the 6-membered ring may be, for example, a benzene ring or a cyclohexane ring. The compound that can be used in the present invention contains a plurality of such cyclic structures, and may contain within the molecule thereof, for example, both of a benzene ring and a cyclohexane ring, or two cyclohexane rings, or may be a derivative of naphthalene or anthracene. The compound more preferably contains within the molecule thereof three or more of the cyclic structures. Further, it is preferable that at least one bond of the cyclic structure be free of unsaturated bond. Specific examples thereof include abietic acid and derivatives thereof, such as dehydroabietic acid and parastrinic acid. These compounds have chemical formulae shown below, but the invention is not particularly limited to them.

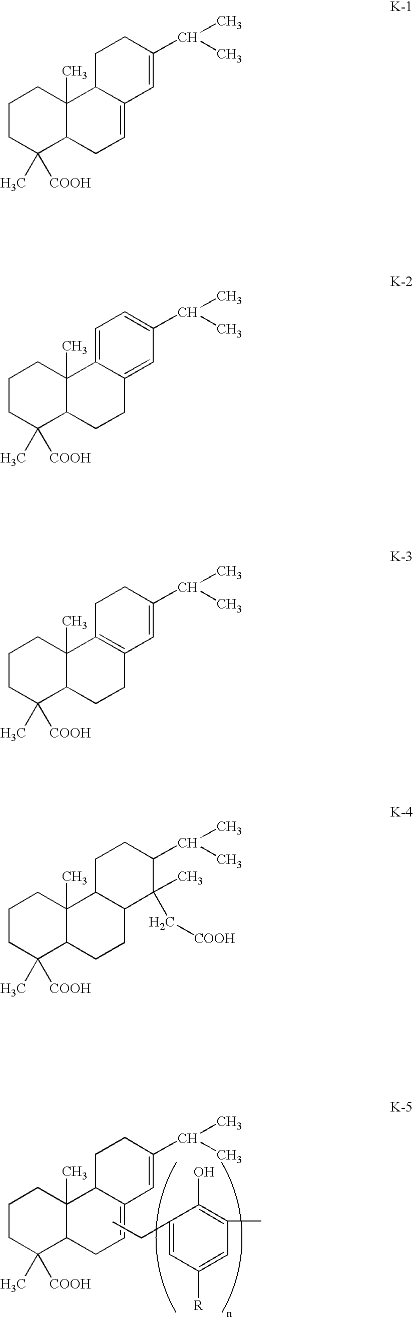

In the formula of K-5 above, R represents a hydrogen atom, a substituted or unsubstituted aliphatic group, or a substituted or unsubstituted aromatic group, and is preferably an aliphatic group. The aliphatic group may be linear, branched, or cyclic, and is more preferably cyclic. n is an integer of 1 or more, preferably 1≦n≦20, and more preferably 1≦n≦10.

<Bisphenol Derivative>

The bisphenol derivative that can be used in the present invention preferably has a molecular weight of 10,000 or less; and it may be a monomer, an oligomer, or a polymer, as long as it has the molecular weight within this range. Also, the bisphenol derivative may be a copolymer with another polymer, or may be modified at the terminal thereof by a reactive substituent.

These compounds have chemical formulae shown below, but the invention is not particularly limited to them.

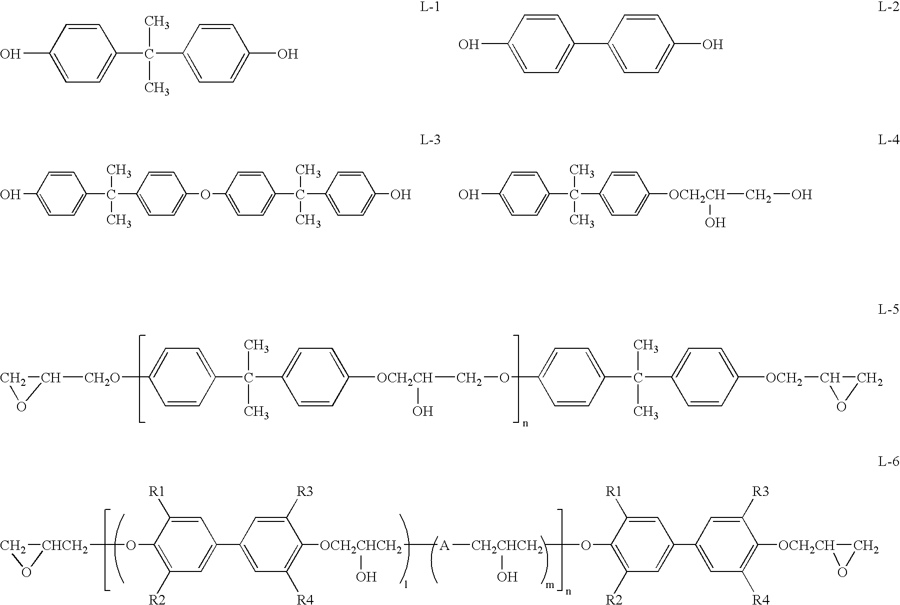

In the above formulas of the specific examples of the bisphenol derivative, R1, R2, R3, and R4 each represent a hydrogen atom or an alkyl group having 1 to 10 carbon atoms. l, m, and n each represent the number of repeating units, and, though not particularly limited, each are preferably an integer of 1 to 100, more preferably an integer of 1 to 20.

The amount to be added of the above-described polyhydric alcohol ester compound, carboxylate ester compound, polycyclic carboxylic acid compound, and bisphenol derivative, each having a log P value of 0 to 7, is preferably 0.1 to 30 parts by mass, more preferably 1 to 20 parts by mass, to 100 parts by mass of the cellulose compound.

(Plasticizer)

In the cellulose acylate film, a plasticizer may be added so as to improve the mechanical properties or increase the drying speed. As the plasticizer, a phosphoric acid ester or a carboxylic acid ester can be used. Examples of the phosphate ester include triphenyl phosphate (TPP) and tricresyl phosphate (TCP). Representative examples of the carboxylate ester include a phthalate and a citrate. Examples of the phthalate include dimethyl phthalate (DMP), diethyl phthalate (DEP), dibutyl phthalate (DBP), dioctyl phthalate (DOP), diphenyl phthalate (DPP), and diethylhexyl phthalate (DEHP). Examples of the citrate include triethyl O-acetylcitrate (OACTE), and tributyl O-acetylcitrate (OACTB). Typical examples of other carboxylate ester include butyl oleate, methyl acetyl ricinoleate, dibutyl sebacate, and various trimellitic acid esters. A phthalate-series plasticizer (DMP, DEP, DBP, DOP, DPP, or DEHP) can be preferably used, and DEP and DPP are particularly preferred.

The amount of the plasticizer to be added is preferably from 0.1 to 25 mass %, more preferably from 1 to 20 mass %, and most preferably 3 to 15 mass %, based on the amount of the cellulose ester.

(Ultraviolet Absorber)

The cellulose acylate film of the present invention may contain an ultraviolet absorber.

Examples of the ultraviolet absorber include oxybenzophenone-series compounds, benzotriazole-series compounds, salicylate-series compounds, benzophenone-series compounds, cyanoacrylate-series compounds, and nickel complex-series compounds. The ultraviolet absorber is preferably a less colored benzotriazole-based compound. Also, ultraviolet absorbers described in JP-A-10-182621 or JP-A-8-337574, and a polymer ultraviolet absorber described in JP-A-6-148430 are preferable. In the case where the cellulose acylate film of the present invention is used as a protective film for a polarizing plate, the ultraviolet absorber preferably has an excellent ability to absorb ultraviolet rays of wavelength 370 nm or less, from the viewpoint of preventing deterioration of polarizers or liquid crystals, and absorb less visible rays of wavelength 400 nm or more, from the viewpoint of liquid crystal display properties.

Specific examples of the benzotriazole-series ultraviolet absorber that is useful in the present invention will be shown below, but the present invention is not limited by these examples. The examples include a mixture of 2-ethylhexyl-3-[3-tert-butyl-4-hydroxy-5-(5-chloro-2H-benzotriazol-2-yl)phenyl]propionate and octyl-3-[3-tert-butyl-4-hydroxy-5-(chloro-2H-benzotriazol-2-yl)phenyl]propionate, 2-(2′-hydroxy-5′-methylphenyl)benzotriazole, 2-(2′-hydroxy-3′,5′-di-tert-butylphenyl)benzotriazole, 2-(2′-hydroxy-3′-tert-butyl-5′-methylphenyl)benzotriazole, 2-(2′-hydroxy-3′,5′-di-tert-butylphenyl)-5-chlorobenzotriazole, 2-[2′-hydroxy-3′-(3″,4″,5″,6″-tetrahydrophthalimidomethyl)-5′-methylphenyl]benzotriazole, 2,2-methylene-bis[4-(1,1,3,3-tetramethylbutyl)-6-(2H-benzotriazole-2-yl)phenol], 2-(2′-hydroxy-3′-tert-butyl-5′-methylphenyl)-5-chlorobenzotriazole, 2-(2H-benzotriazol-2-yl)-6-(linear chain and side chain dodecyl)-4-methylphenol.

Also use may be preferably made of a commercial product, e.g. “TINUVIN 109”, “TINUVIN 171”, “TINUVIN 326”, and “TINUVIN 328” (each trade name, manufactured by Ciba Specialty Chemicals).

The amount to be added of the ultraviolet absorber is preferably 0.1 to 5.0% by mass, more preferably 0.5 to 5.0% by mass, to the cellulose compound.

(Deterioration Preventing Agent (Deterioration Inhibitor))

To the cellulose acylate film, a deterioration inhibitor (for example, an antioxidant, a peroxide decomposer, a radical inhibitor, a metal deactivator, an acid-trapping agent, an amine) may be added. The deterioration inhibitor is described in JP-A-3-199201, JP-A-5-1907073, JP-A-5-194789, JP-A-5-271471, and JP-A-6-107854. The amount of the deterioration inhibitor to be added is preferably from 0.01 to 1 mass %, more preferably from 0.01 to 0.2 mass %, based oil the solution (dope) to be prepared, from the viewpoint of exhibiting the effect of deterioration inhibitor or preventing the deterioration inbibitor from bleeding out onto the film surface Example of a particularly preferable deterioration inhibitor include butylated hydroxytoluene (BHT), and tribenzyl amines (TBA).

(Matt Agent Fine-Particles)

To the cellulose acylate film of the present invention, fine particles as a matt agent are preferably added. Examples of the fine particles that can be used in the present invention include silicon dioxide, titanium dioxide, aluminum oxide, zirconium oxide, calcium carbonate, talc, clay, calcined kaolin, calcined calcium silicate, hydrated calcium silicate, aluminum silicate, magnesium silicate, and calcium phosphate. The fine particles are preferably those containing silicon, from the viewpoint of obtaining low turbidity, and particularly silicon dioxide is preferable. Fine particles of silicon dioxide are preferably those having a primary average particle diameter (size) of 1 nm to 20 nm and an apparent specific gravity of 70 g/L or more. Particles having a primary average particle diameter as small as 5 to 16 nm are able to reduce the haze of the film, and are more preferable. The apparent specific gravity is preferably 90 to 200 g/L or more, and more preferably 100 to 200 g/L or more. A larger apparent specific gravity makes it possible to prepare a high concentration dispersion, to thereby better haze and coagulation, which is preferable.

The fine particles generally form secondary particles having an average particle diameter of 0.05 to 2.0 μm; and the fine particles exist in the form of a coagulate of primary particles in the film, to thereby being capable of forming irregularities 0.05 to 2.0 μm in size on the surface of the film. The secondary average particle diameter is preferably 0.05 μm or more but 1.0 μm or less, more preferably 0.1 μm or more but 0.7 μm or less, and most preferably 0.1 μm or more but 0.4 μm or less. Herein, the primary particle diameter and the secondary particle diameter are determined in the following manner: Particles in the film are observed by a scanning type electron microscope to measure the diameter of a circumscribed circle of a particle as a particle diameter. Further, 200 particles each in a different site or place are observed, to calculate an average of the diameters of these particles to determine an average particle diameter.

As the fine particles of silicon dioxide, for example, commercially available products under such trade names as Aerosil R972, R972V, R974, R812, 200, 200V, 300, R202, OX50, TT600 (trade names, manufactured by Nippon Aerosil Co., Ltd.) may be used. The fine particles of zirconium oxide are commercially available, for example, under such trade names as Aerosil R976 and R811 (trade names, manufactured by Nippon Aerosil Co., Ltd.), which may be used in the present invention.

Of those fine particles, Aerosil 200V and Aerosil R972V are particularly preferable, since they are fine particles of silicon dioxide having an average primary particle diameter of 20 nm or less and an apparent specific gravity of 70 g/L or more, and having a large effect of dropping friction coefficient, while maintaining the low haze of a resulting optical film.

The matting agent that can be used in the present invention is preferably prepared by the following method: A solvent and fine particles are mixed by stirring, to make a fine particle dispersion liquid, and the fine particle dispersion liquid is added to a first additive solution, which is separately provided, contains less than 5% by mass of cellulose acylate and has a molecular weight of 200 to 2,000, followed by being dissolved by stirring, and the resultant mixture is added a second additive solution, followed by being dissolved by stirring, and then the resultant solution is mixed with the main cellulose acylate dope solution.

The surface of the matting agent has been hydrophobitized, and a hydrophobic additive tends to be adsorbed to the surface of the matting agent to form nuclei, to thereby cause nucleation of aggregates of the additive. It is thus preferable to add a relatively hydrophilic additive to a matting agent dispersion liquid, followed by adding a hydrophobic additive thereto, for suppressing the aggregation of the additive on the surface of the matting agent, decreasing the haze, and reducing light leakage during displaying black when incorporated into a liquid crystal display device.

It is preferable to use an in-line mixer for mixing a matting agent dispersant with an additive solution, and mixing the resultant mixture with a cellulose acylate solution. The present invention is not particularly limited by those methods, but the concentration of silicon dioxide when silicon dioxide fine-particles are mixed with and dispersed in, for example, a solvent is preferably 5 to 30 mass %, more preferably 10 to 25 mass %, and most preferably 15 to 20 mass %. The higher the concentration of the dispersion is, the lower the liquid turbidity in relation to the same amount to be added is and the more greatly the haze and coagulate are bettered, and thus a higher concentration of silicon dioxide is preferable. The amount of the matting agent to be added in the final dope solution of the cellulose acylate is preferably 0.001 to 1.0 mass %, more preferably 0.005 to 0.5 mass %, and most preferably 0.01 to 0.1 mass %.

[Production of a Cellulose Acylate Film]

The cellulose acylate film of the present invention is preferably prepared according to a solvent cast method. In the solvent cast method, a solution (dope) in which a cellulose acylate is dissolved in an organic solvent is utilized, to prepare a film.

The organic solvent is preferably comprised of a solvent selected from an ether having 3 to 12 carbon atoms, a ketone having 3 to 12 carbon atoms, an ester having 3 to 12 carbon atoms, and a halogenated hydrocarbon having 1 to 6 carbon atoms.

The ether, the ketone, or the ester may have a cyclic structure. A compound having two or more functional groups of ether, ketone or ester (i.e. —O—, —CO— or —COO—) is also usable as the organic solvent The organic solvent may have another functional group such as an alcoholic hydroxyl group. If the organic solvent is a compound having two or more functional groups, the number of carbon atoms is within any of the above ranges mentioned as the preferable ranges of the number of carbon atoms for the solvent having any of the functional groups.

Examples of the ether having 3 to 12 carbon atoms include diisopropyl ether, dimethoxymethane, dimethoxyethane, 1,4-dioxane, 1,3-dioxolane, tetrahydrofuran, anisole, and phenetole.

Examples of the ketone having 3 to 12 carbon atoms include acetone, methyl ethyl ketone, diethyl ketone, diisobutyl ketone, cyclohexanone, and methylcyclohexanone.

Examples of the ester having 3 to 12 carbon atoms include ethyl formate, propyl formate, pentyl formate, methyl acetate, ethyl acetate, and pentyl acetate.

Examples of the organic solvent having two or more kinds of functional groups include 2-ethoxyethyl acetate, 2-methoxyethanol, and 2-butoxyethanol.

The halogenated hydrocarbon preferably has one or two carbon atoms, most preferably one carbon atom. The halogen in the halogenated hydrocarbon is preferably chlorine. The hydrogen atom in the halogenated hydrocarbon is substituted with a halogen in an amount of preferably 25 to 75 mol %, more preferably 30 to 70 mol %, further preferably 35 to 65 mol %, most preferably 40 to 60 mol %. A typical halogenated hydrocarbon is methylene chloride.

As the organic solvent in the present invention, it is preferable to use a mixture of methylene chloride and an alcohol. The ratio of the alcohol to methylene chloride is preferably 1 mass % or more but 50 mass % or less, more preferably 10 mass % or more but 40 mass % or less, and most preferably 12 mass % or more but 30 mass % or less. As the alcohol, methanol, ethanol or n-butanol is preferable, and two or more of these alcohols may be mixed for combination use.

The cellulose acylate solution can be prepared in an ordinary manner. The term “ordinary manner” means that the preparation is carried out at a temperature of 0° C. or higher (a room temperature or an elevated temperature). The cellulose acylate solution (dope) can be prepared through a usual process by means of a usual apparatus in the solvent cast method. In the usual process, a halogenated hydrocarbon (particularly, methylene chloride) is preferably used as the organic solvent.

The amount of cellulose acylate in the solution is preferably set in the range of 10 to 40 mass %, more preferably in the range of 10 to 30 mass %. To the organic solvent (primary or main solvent), any of additives described later may be optionally added.

Cellulose acylate and the organic solvent are mixed and stirred at a normal temperature (0 to 40° C.), to prepare the cellulose acylate solution. For preparing a high concentration solution, the preparation may be carried out at an elevated temperature under a high pressure. In that case, the cellulose acylate and the organic solvent are placed in a vessel resisting pressure. After the vessel is sealed, the mixture is stirred under an increased pressure at an elevated temperature. The temperature is controlled so that it may be higher than the boiling point of the solvent at atmospheric pressure but so that the solvent may not boil.

The temperature under heating is generally in the range of 40° C. or more, preferably in the range of 60 to 200° C., more preferably in the range of 80 to 110° C.

Before placed in the vessel, the components of the solution may be roughly mixed. Alternately, the components may be added one by one into the vessel. The vessel must be equipped with a stirring means. An inactive gas such as nitrogen gas may be charged in the vessel, to increase the inner pressure. Otherwise, the vessel may be heated to elevate the vapor pressure of the solvent so that the inner pressure may increase. After the vessel is sealed, each component may be added under an elevated pressure.

When heating, the vessel is preferably heated from the outside. For example, a jacket-type heater can be preferably used. Alternately, a liquid heated with a plate heater placed outside of the vessel may be made to flow through a pipe wound around the vessel, to heat the whole vessel.

The mixture is preferably stirred with a propeller mixer provided in the vessel. The wing of the propeller preferably has a length reaching the inside wall of the vessel. Further, at the tip of the wing, a scratching mean is preferably provided to scratch and renew a liquid layer attached on the inside wall.

In the vessel, various meters such as pressure gauge and thermometer may be provided. The components are dissolved in the solvent in the vessel. The thus prepared dope may be cooled and then taken out of the vessel, or may be taken out and then cooled with a heat exchanger, or the like.

The solution can be prepared, according to a cooling dissolution method. The cooling dissolution method makes it possible to dissolve cellulose acylate in an organic solvent which hardly dissolves said cellulose acylate in a usual process. Further, according to that method, cellulose acylate can be rapidly and homogeneously dissolved even in a solvent which can dissolve said cellulose acylate in a usual process.

In the process of the cooling (or chilling) dissolution method, first, cellulose acylate is gradually added, with stirring, into an organic solvent, at room temperature. The amount of cellulose acylate in the mixture is preferably in the range of 10 to 40 mass %, more preferably in the range of 10 to 30 mass %. Any of various additives described later may be added in the mixture.

Then, the prepared mixture is cooled to a temperature of −100 to −10° C., preferably −80 to −10° C., more preferably −50 to −20° C., most preferably −50 to −30° C. The cooling procedure can be carried out, for example, with a dry ice/methanol bath (−75° C.) or with a cooled diethylene glycol solution (−30 to −20° C.). Through the cooling procedure, the mixture of the cellulose acylate and the organic solvent is solidified.

The cooling speed is preferably 4° C./minute or more, more preferably 8° C./minute or more, and most preferably 12° C./minute or more. The cooling speed is preferably as fast as possible. However, a theoretical upper limit of the cooling rate is 10,000° C. per second, a technical upper limit is 1,000° C. per second, and a practical upper limit is, 100° C. per second. The cooling rate means the change of temperature at the cooling step per the period of time taken to complete the cooling step. The change of temperature means the difference between the temperature at which the cooling step is started and the temperature at which the cooling step is completed. The period of time taken to complete the cooling step means the period of time from the start of the cooling step to the end of the cooling at which the final cooling temperature is attained.

The thus-cooled mixture is then warmed to a temperature of generally 0 to 200° C., preferably 0 to 150° C., more preferably 0 to 120° C., and most preferably 0 to 50° C. Through the warming procedure cellulose acylate is dissolved in the organic solvent. For warming, the mixture may be left at room temperature or may be heated in a warm bath.

The warming speed is preferably 4° C./minute or more, more preferably 8° C./minute or more, and most preferably 12° C./minute or more. The warming rate is preferably as fast as possible. However, a theoretical upper limit of the warming rate is 10,000° C. per second, a technical upper limit is 1,000° C. per second, and a practical upper limit is 100° C. per second. The warming rate means the change of temperature at the warming step per the period of time taken to complete the warming step. The change of temperature means the difference between the temperature at which the warming step is started and the temperature at which the warming step is completed. The period of time taken to complete the warming step means the period of time from the start of the warming step to the end of the warming at which the final warming temperature is attained.

Thus, a homogeneous solution can be prepared. If the cellulose acetate is not sufficiently dissolved, the cooling and warming procedures may be repeated. It can be judged by observation of the outer appearance of the solution with the naked eye, whether the cellulose acetate is sufficiently dissolved or not.

In the chilling dissolution method, use of a closed vessel is preferred to prevent inclusion of moisture that is caused owing to dew formation at the time of cooling. In the operations of cooling and warming, pressurization at the time of cooling and decompression at the time of warming may shorten the dissolution time period. In order to practice pressurization or decompression, use of a pressure-resistant vessel is preferred.

According to differential scanning calorimetric (DSC) measurement, a 20-mass % solution prepared by dissolving a cellulose acetate (acetylation degree: 60.9%, viscosity average polymerization degree: 299) in methyl acetate through the cooling dissolution process, has a pseudo-phase transition point between gel and sol at about 33° C. Below that temperature, the solution is in the form of homogeneous gel. The solution, therefore, must be kept at a temperature above the pseudo-phase transition point, preferably at a temperature higher by about 10° C. than the gel-phase transition point. The pseudo-phase transition point varies, depending upon various conditions, such as the organic solvent to be used, and the acetylation degree, the viscosity average polymerization degree, or the concentration, of the cellulose acylate to be used.

It is preferable to produce the cellulose acylate film, from the thus-prepared cellulose acylate solution (dope), by a solvent casting method. To the dope, the retardation-controlling agent is preferably added.

The dope is cast on a drum or a band, and the solvent is evaporated to form a film. The concentration of the dope before casting is preferably adjusted to give a solid content of 18 to 35%. The surface of the drum or band is preferably finished to provide a mirror state The dope is preferably cast on a drum or band having a surface temperature of 10° C. or less.

The drying method in the solvent casting method is described in U.S. Pat. Nos. 2,336,310, 2,367,603, 2,492,078, 2,492,977, 2,492,978, 2,607,704, 2,739,069, and 2,739,070, British Patent Nos. 640,731 and 736,892, JP-B-45-4554 (the term “JP-B” as used herein means examined Japanese patent publication), JP-B-49-5614, JP-A-60-176834, JP-A-60-203430, and JP-A-62-115035. The drying on a band or a drum may be accomplished by blowing an inert gas such as the air or nitrogen.

The cellulose acylate film of the present invention is dried on a band or drum preferably at as low temperature as possible. When the content of the remaining solvent is 30% by mass or more, the drying temperature is preferably 150° C. or lower, more preferably 120° C. or lower, and most preferably 90° C. or lower.

Formation of fine crystals in the film can be reduced, by drying at temperatures in the above-described range.

From the thus-prepared cellulose acylate solution (dope), a film having two or more layers can be formed via casting. Also in that case, the cellulose acylate film is preferably formed by a solvent cast method. The dope is cast over a drum or a band, and then the solvent is removed therefrom by vaporization, thereby forming a film. The solid-component concentration of the dope before casting is preferably adjusted to the range of 10 to 40 mass %. The drum or band surface is preferably subjected in advance to a mirror-smooth finish.

When casting two or more cellulose acylate solutions, the cellulose acylate solutions may be cast, while the cellulose acylate-containing solutions are cast successively from their respective casting dies disposed at an interval in the direction of progress of the support (i.e. the machine direction), to prepare a lamination to form a film. For example, the methods disclosed in JP-A-61-158414, JP-A-1-122419, and JP-A-11-198285 can be adopted. The film formation by casting cellulose acylate solutions from two casting dies may be employed, and this can be conducted by the methods disclosed, for example, in JP-B-60-27562, JP-A-61-94724, JP-A-61-947245, JP-A-61-104813, JP-A-61-158413, and JP-A-6-134933. Further, the casting method disclosed in JP-A-56-162617 may also be adopted, wherein the flow of a high-viscosity cellulose acylate solution is enveloped in a low-viscosity cellulose acylate solution and both of the high- and low-viscosity cellulose acylate solutions are extruded simultaneously, to form a cellulose acylate film.

Alternatively, the film may be produced by a method of using two casting dies (cast openings), which method comprises the steps of: peeling off a film formed on a support from the first casting die; and then conducting the second casting using the second casting die on the side of the film contacted with the support surface. This method is described in, for example, JP-B-44-20235.

The cellulose acylate solutions to be cast may be the same or different from each other. To impart a plural of cellulose acylate layers functions different from each other, the cellulose acylate solutions corresponding to the respective functions may be extruded from different casting dies, respectively. The cellulose acylate solution for use in the present invention may be cast simultaneously together with another functional layer(s) (for example, an adhesive layer, a dye layer, an antistatic layer, an antihalation layer, a UV absorbing layer, a polarizing layer).

Referring to a conventional single layer solution, extrusion of a cellulose acylate solution with a high concentration and high viscosity is necessary to obtain a desired film thickness. In this case, often caused were problems such as inferior flatness, and spot (granular structure) failure due to solid substances occurred due to poor stability of the cellulose acylate solution. A measure to solve these problems is to cast two or more cellulose acylate solutions from casting dies. By this method, high viscosity solutions can be co-extruded on a support, and a film with a good flatness and an excellent face quality can be prepared. In addition, a drying load can be reduced by use of a concentrated cellulose acylate solution, so that a production speed of the film can be enhanced.

(Orientation (or Drawing or Stretching) Treatment)

The oriented cellulose acylate film of the present invention is oriented in the film conveyance direction (the longitudinal direction), and/or a direction perpendicular to the film conveyance direction (the transverse direction).

The method of orienting a film in the transverse direction is described, for example, in JP-A-62-115035, JP-A-4-152125, JP-A-4-284211, JP-A-4-298310, and JP-A-11-48271. In the case where the film is oriented in the longitudinal direction, the film is oriented, for example, by controlling the speed of the film transfer roller such that the film take-up speed is higher than the film stripping speed. In the case where the film is oriented in the transverse direction, for example, the film is transferred with the film width maintained by a tenter, and the width of the tenter is gradually expanded, thereby to orient the film. Alternatively, a dried film may be oriented using a orienting machine, preferably oriented by uniaxial orienting using a long orienting machine.

For improving both the Re developability and the Rth developability, it is particularly preferable that the film be oriented in both the conveyance direction and the transverse direction.

The cellulose acylate film of the present invention is preferably oriented at a constant orienting speed with the residual solvent content kept within a specified range. The residual solvent content at the beginning of orienting is generally 1% by mass or more but 80% by mass or less, preferably 1% by mass or more but 70% by mass or less, and more preferably 1% by mass or more but 60% by mass or less.

The orienting temperature is preferably {(the glass transition temperature of the film) −20° C.} or higher but {(the glass transition temperature of the film)+20° C.} or lower.

The orienting ratio of the film is preferably from 1% to 100%, and more preferably from 5% to 90%. In the present invention, the term ‘orienting ratio of film’ means the value determined by mathematical formula (6):

$$( \frac{Size after orienting}{Size before orienting} - 1 ) \times 100 ( \% ) \qquad Mathematical formula ( 6 )$$

The ratio of {(the orienting ratio in the transverse direction)/(the orienting ratio in the longitudinal direction)} is preferably 1 or more but 10 or less, and more preferably 2 or more but 8 or less.

[Properties of Cellulose Acylate Film]

(Film Thickness)

The thickness of the cellulose acylate film of the present invention is preferably 30 μm or more but 120 μm or less, more preferably 40 μm or more but 100 μm or less, and most preferably 40 μm or more but 70 μm or less.

(Retardation of Film)

Herein, in the present specification, the Re(λ) and the Rth(λ) indicate the in-plane retardation and the retardation in the direction of the thickness, respectively, at the wavelength λ (nm). The Re(λ) can be measured by making light of wavelength λ nm incident in the direction of the normal of the film, in KOBRA 21ADH or WR (each trade name, manufactured by Oji Scientific Instruments).

In the case where the film to be measured can be expressed by a uniaxial or biaxial index ellipsoid (polarizability ellipsoid), the Rth(λ) thereof is calculated as follows.

Rth(λ) is calculated using KOBRA 21ADH or WR on the basis of: the above-described Re(λ); a retardation value measured by making light of wavelength of 590 nm incident in the direction inclined to +40° over the normal direction of the film with the in-plane retardation (slow) axis (judged by the KOBRA 21ADH or WR) as an inclined axis (a rotation axis); retardation values in total six directions measured by making light of wavelength λ nm incident in the normal direction and directions inclined to 50° at an interval of 10° over the normal direction of the film with the in-plane retardation axis as an inclined axis (a rotation axis) (or with an arbitrary direction in the film plane as a rotation axis when there is no retardation axis); the estimated average refractive index; and, the input value of the film thickness.

In the above-described method, when the film has a retardation value of zero in a direction inclined to a certain degree over the normal direction with the in-plane retardation axis as a rotation axis, the retardation value in a direction inclined to a larger degree than the above-described direction is calculated by KOBRA 21ADH or WR, after the sign of the retardation value is converted to negative.

Alternatively, Rth may also be calculated by mathematical formulae (13) and (14), on the basis of: retardation values measured from arbitrary inclined two directions, with the retardation axis as an inclined axis (a rotation axis) (or with the in-plane arbitrary direction as a rotation axis when there is no retardation axis); the estimated average refractive index; and the input value of the film thickness.

$$Re ( θ ) = \begin{matrix}[ nx - \frac{ny \times nz}{ \sqrt{\begin{matrix} {( ny sin ( {sin}^{- 1} ( \frac{sin ( - θ )}{nx} ) ) )}^{2} + \\ {( nz cos ( {sin}^{- 1} ( \frac{sin ( - θ )}{nx} ) ) )}^{2}\end{matrix} }} ] \times \end{matrix} \frac{d}{ cos ( {sin}^{- 1} ( \frac{sin ( - θ )}{nx} ) )} \qquad Mathematical formula ( 13 )$$

In the mathematical formula (13), Re(θ) represents a retardation value in the direction inclined by an angle θ from the normal direction. nx represents a refractive index in the retardation axis direction in the plane, ny represents a refractive index in the direction orthogonal to nx in the plane, and nz represents a refractive index in the direction orthogonal to nx and ny.

$$Rth = ( \frac{nx + ny}{2} - nz ) \times d \qquad Mathematical formula ( 14 )$$

In the case where the film to be measured cannot be expressed by a uniaxial or biaxial index ellipsoid, i.e. a film having no so-called optic axis, the Rth(λ) thereof is calculated as follows.

Rth(λ) is calculated using KOBRA 21ADH or WR, on the basis of: the above-described Re(λ); retardation values measured in eleven directions, by making light of wavelength λ nm incident in the directions inclined to 50° to +50° at an interval of 10° over the normal direction of the film with the in-plane retardation axis (judged by the KOBRA 21ADH or WR) as an inclined axis (a rotation axis); the estimated average refractive index; and the input value of the film thickness.

In the above measurement methods, as the estimated (hypothetical) value of the average refractive index, use may be made, for example, of values described in “Polymer Handbook” (JOHN WILEY & SONS, INC.) and values described in catalogues of various optical films. Unknown average refractive indexes may be measured to determine by an Abbe refractometer. Average refractive indexes of major optical films are exemplified in below: cellulose acylate (1.48), cycloolefin polymer (1.52), polycarbonate (1.59), polymethyl methacrylate (1.49), and polystyrene (1.59). KOBRA 21ADH or WR can calculate nx, ny, and nz, by inputting these estimated values of the average refractive index and the film thickness. From the thus-calculated nx, ny, and nz, Nz=(nx-nz)/(nx-ny) is further calculated.

The Rth(590) of the cellulose acylate film of the present invention is preferably negative, more preferably −400 nm or more but −20 nm or less, and further preferably −300 nm or more but −30 nm or less.

Further, the Re(590) is preferably −200 nm or more but −5 nm or less, and more preferably −150 nm or more but −10 nm or less.

(Haze)

The cellulose acylate film of the present invention has a haze value of preferably 0.1 to 0.8, more preferably 0.1 to 0.7, and most preferably 0.1 to 0.6, when measured using, for example, a haze meter (trade name: 1001DP model, manufactured by Nippon Denshoku Industries Co., Ltd.). When the haze is controlled in the above-described range, a liquid crystal display device incorporating the film as an optical compensation film provides an image of high contrast.

(Equilibrium Water Content of Film)

The water content of the cellulose acylate film may be evaluated by measuring an equilibrium water content at a fixed temperature and humidity. The equilibrium water content may be determined, by allowing the film sample to stand at the fixed temperature and humidity for 24 hours, and then by measuring the amount of water of the sample which reaches the equilibrium, by a Karl Fisher's method, to divide the amount (g) of water by the mass (g) of the sample.

The equilibrium water content of the cellulose acylate film of the present invention at 25° C. under a relative humidity (RH) of 80% is preferably 3.0% by mass or less, more preferably 2.5% by mass or less, and most preferably 2.0% by mass or less.

When the equilibriumn moisture content of the film is in the above-described range, the change in the film retardation can be made small.

(Retardation Change Upon Environmental Humidity Change)

The cellulose acylate film of the present invention preferably undergoes little retardation change upon environmental humidity change, and the Re and Rth thereof preferably satisfy the relationships of mathematical formulae (7) and (8).
0 nm≦{(Re at 25° C.−10% RH)−(Re at 25° C.−80% RH)}≦20 nm Mathematical formula (7)
0 nm≦{(Rth at 25° C.−10% RH)−(Rth at 25° C.−80% RH)}≦30 nm Mathematical formula (8)

The mathematical formula (7) is further preferably:
0 nm≦{(Re at 25° C.−10% RH)−(Re at 25° C.−80% RH)}≦15 nm
and, most preferably:
0 nm≦{(Re at 25° C.−10% RH)−(Re at 25° C.−80% RH)}≦10 nm

The mathematical formula (8) is further preferably:
0 nm≦{(Rth at 25° C.−10% RH)−(Rth at 25° C.−80% RH)}≦20 nm
and, most preferably:
0 nm≦{(Rth at 25° C.−10% RH)−(Rth at 25° C.−80% RH)}≦15 nm

When the change in the retardation upon environmental humidity change is controlled in the above-described range, a liquid crystal display device incorporating the film shows little chromatic change due to environmental humidity change.

(Surface Deficiency)

The cellulose acylate film of the present invention preferably has the following surface state: For example, when the cellulose ester film is sampled to count the number of foreign substances and/or coagulates 30 μm or more in size present in an area of width 30 cm and length 1 m on both edged sides of the resulting film, the number of these foreign substances and/or coagulates is preferably 0 to 50, more preferably 0 to 40, and particularly preferably 0 to 30.

(Surface Treatment of Cellulose Acylate Film)

The surface energy of the cellulose acylate film is preferably 55 to 75 mN/m. In order to attain this, it is preferable to carry out a surface treatment. Examples of the surface treatment include a saponification treatment, a plasma treatment, a flame treatment, and an ultraviolet radiation treatment. The saponification treatment includes an acid saponification treatment and an alkali saponification treatment. The plasma treatment include a corona discharge treatment and a glow discharge treatment. In order to retain the flatness of the film, the temperature of the cellulose acylate film in the surface treatment is preferably made to be lower than the glass transition temperature (Tg), specifically 150° C. or less. The surface energy of the cellulose acetate film after the surface treatment is preferably 55 to 75 mN/m.

The glow discharge treatment may be a treatment with low-temperature plasma (thermal plasma) generated in a low-pressure gas having a pressure of 10⁻³ to 20 Torr (0.133 Pa to 2.67 kPa), or a treatment with plasma under the atmospheric pressure is also preferable. A plasma excitation gas is a gas which can be excited to plasma under conditions as described above, and examples thereof include argon, helium, neon, krypton, xenon, nitrogen, carbon dioxide, frons such as tetrafluoromethane, and a mixture thereof. Details thereof are described in “Kokai Giho of Japan Institute of Invention & Innovation” (Kogi No. 2001-1745, published on Mar. 15, 2001), pp. 30-32. In the plasma treatment under the atmospheric pressure, to which attention has been paid in recent years, for example, a radiating energy of 20 to 500 kGy is used under a condition of 10 to 1,000 keV, and preferably a radiating energy of 20 to 300 kGy is used under a condition of 30 to 500 keV. Of these treatments, an alkali saponifying treatment is particularly preferable, which treatment is quite effective as the surface treatment for the cellulose acylate film.

The alkali saponifying treatment is preferably conducted, by directly immersing the cellulose acylate film into a bath of a saponifying solution, or by applying a saponifying solution onto the cellulose acylate film. Examples of the application method include a dip coating method, a curtain coating method, an extrusion coating method, a bar coating method, and an E-type coating method. As the solvent in the alkali saponifying treatment coating solution, it is preferable to employ a solvent which has an excellent wettability appropriate for applying the saponifying solution to a transparent support and which can hold a favorable surface state without forming any irregularity on the transparent support surface. More specifically, it is preferable to use an alcohol-based solvent, and isopropyl alcohol is particularly preferable therefor. It is also possible to employ an aqueous solution of a surfactant as the solvent. As the alkali in the alkali saponifying solution, it is preferable to use an alkali soluble in the above-described solvent, and KOH or/and NaOH is further preferable therefor. It is preferable that the saponifying solution has a pH value of 10 or more, still preferably 12 or more. Concerning the reaction conditions, it is preferable to perform the alkali saponification at room temperature for 1 second or longer but 5 minutes or shorter, still preferably for 5 seconds or longer but 5 minute or shorter, and particularly preferably for 20 seconds or longer but 3 minutes or shorter. After the completion of the alkali saponification reaction, it is preferable to wash with water; or wash with an acid and then wash with water, the face coated with the saponifying solution.

The surface energy of the solid obtained by these methods can be measured by the contact angle method, the wet heating method, or the adsorption method, which methods are described in “The Basic Theory and Application of Wetting”, Realize Co., Ltd, published on Dec. 10, 1989. In the case of the cellulose acylate film of the present invention, the contact angle method is preferably used. In that method, specifically, two solutions having known surface energies are dropped onto the cellulose acylate film. The contact angle of each drop is measured, and the surface energy of the film can be determined by calculation from the measured contact angles. The contact angle is defined to be an angle which is formed by a tangent line and the film surface, the tangent line being a line tangent to the curve of the droplet which line is oriented at the point where the droplet surface intersects the film surface, and the contact angle being the angle at the droplet side.

It is possible to obtain a cellulose acylate film having a surface energy of 55 to 75 mN/m, by carrying out the above surface treatment of the film. By using this cellulose acylate film as a transparent protective film of a polarizing plate, the adhesion of a polarizing film to the cellulose acylate film can be improved. Also, when the cellulose acylate film of the present invention is used in an OCB mode liquid crystal display device, the optical compensation sheet of the present invention may be provided with an oriented film formed on the cellulose acylate film and with an optically anisotropic layer containing a disk-like compound or a rod-like liquid crystal compound on the oriented film. The optically anisotropic layer is formed by orienting the disk-like compound (or the rod-like liquid crystal compound) on the oriented film, to fix the orientation state. When the optically anisotropic layer is formed on the cellulose acylate film in this manner, it is conventionally necessary to form a gelatin undercoat layer between the cellulose acylate film and the oriented film to secure the adhesion between the both. However, it is unnecessary to form the gelatin undercoat layer, by using the cellulose acylate film of the present invention which has a surface energy of 55 to 75 mN/m.

[Optical Material Using Cellulose Acylate Film]

[Optical Compensation Sheet]

The aforementioned cellulose acylate film containing at least one retardation-controlling agent, being oriented, satisfying the aforementioned conditions on the Re and Rth retardation values and the Re/Rth ratio, and having a film thickness of 40 μm to 110 μm, functions as an optical compensation sheet even if it is used singly.

The cellulose acylate film of the present invention can be preferably used as an optical compensation sheet.

[Polarizing Plate]

The polarizing plate comprises a polarizer (polarizing film) and two protective films (transparent protective films) disposed on the both sides of the polarizer. When an optical compensation sheet constituted by using the aforementioned cellulose acylate film is used as one of the protective films, a usual cellulose acetate film may be used as the other protective film.

Examples of the polarizing film include an iodine-based polarizing film, a dye-based polarizing film composed of a dichromatic dye, and a polyene-based polarizing film. The iodine-based polarizing film or dye-based polarizing film is generally prepared from a polyvinyl alcohol-based film.

The retardation axis of the optical compensation sheet composed of the cellulose acylate film is disposed substantially parallel to the transmission axis of the polarizing film.

(Antireflection Layer)

It is preferable that the transparent protective film disposed on the side opposite to the liquid crystal cell in the polarizing plate be provided with an antireflection layer. Particularly, in the present invention, (1) an antireflection film obtained by laminating at least a light scattering layer and a low-refractive index layer, in this order on a transparent protective film; or (2) an antireflection layer obtained by laminating a middle-refractive index layer, a high-refractive index layer, and a low-refractive index, in this order on a transparent protective film, is preferably used. Preferable examples of these is explained below.

(1) Antireflection Layer Provided with a Light-Scattering Layer and a Low-Refractive Index Layer on a Transparent Protective Film

In the light-scattering layer that can be used in the present invention, matt particles are dispersed, and the refractive index of base materials of the parts other than matt particles of the light-scattering layer is preferably in a range from 1.50 to 2.00. The refractive index of the low-refractive index layer is preferably in a range from 1.35 to 1.49. In the present invention, the light scattering layer is provided with a combination of antiglare characteristics and hardcoat characteristics, and may be constituted of a single layer or multilayer, for example, two layers to four layers.

It is preferable to design the antireflection layer to have the following surface irregularity conditions: the center line average roughness Ra being 0.08 to 0.40 μm, the ten-point-average roughness Rz being 10 times or less the value of Ra, the average distance Sm between the top of the convex and the bottom of the concave next to the convex being 1 to 100 μm, a standard deviation in the height from the deepest bottom of the concave portion to each top of the convex portion being 0.5 μm or less, a standard deviation of the average distance Sm between the top of the convex and the bottom of the concave based on the center line being 20 μm or less, and a plane of which the angle of inclination is 0 to 5° being 10% or more; and such an antireflection layer makes it possible to attain sufficient antiglare characteristics and visually uniform matte texture, which are preferable. Also, it is preferable that the chromaticness of reflecting light under a C light source satisfies the following conditions: a value a* being −2 to 2; a value b* being −3 to 3; and a ratio of the minimum value to the maximum value of the reflectance in the range of 380 nm to 780 nm being within a range of 0.5 to 0.99. This allows the chromaticness of the reflecting light to be neutral, which is preferable. The value b* of transmission light under a C light source is preferably designed to be 0 to 3, which is preferable because yellowish during displaying white is reduced when the antireflection layer is applied to a display device. Also, it is preferable that a standard deviation of the distribution of luminescence is 20 or less, when a grating of 120 μm×40 μm is inserted between a plane light source and the antireflection film in the present invention to measure the distribution of luminescence on the film. This is because glaring when the film of the present invention is applied to a high precision panel is reduced, which is preferable.

The antireflection layer that can be applied to the present invention is preferably designed to have the following optical characteristics: a mirror reflectance 2.5% or less, a transmittance 90% or more, and a 60-degree glossiness 70% or less, thereby the reflection of external light can be suppressed to improve visibility. In particular, the minror reflectance is more preferably 1% or less, and most preferably 0.5% or less. Also, the antireflection layer preferably has the following characteristics: a haze 20% to 50%, a ratio of (an internal haze)/(the total haze) 0.3 to 1; a reduction in the haze value obtained after the formation of the low-refractive index layer, from the haze value obtained from layers including the light scattering layer, being within 15%; a transmission image sharpness in a comb width 0.5 mm, being 20% to 50%; and a ratio of (a transmittance of a vertical transmission light)/(a transmittance of a transmission light incident at a slanting angle of 20 with the vertical direction) being 1.5 to 5.0, to thereby attain prevention of glaring on a high precision LCD panel and reduction in blurring of a character or the like, from occurrence.

<Low-Refractive-Index Layer>

The refractive index of the low-refractive-index layer in the anti-reflection film is generally in the range of 1.20 to 1.49, preferably 1.30 to 1.44. Further, the low refractive index layer preferably satisfies the relationship as defined by mathematical formula (9), in view of low reflectance.

$$\frac{m}{4} \times 0.7 < n 1 d 1 < \frac{m}{4} \times 1.3 \qquad Mathematical formula ( 9 )$$

In the mathematical formula (9), m is a positive odd number, n1 is a refractive index of the low refractive index layer, and d1 is a thickness (nm) of the low refractive index layer. Further, λ is a wavelength having a value in the range of 500 to 550 nm.

The materials to form the low-refractive index layer that can be used in the present invention will be explained.

The low-refractive index layer that can be used in the present invention generally contains a fluorine-containing polymer as a low-refractive index binder. The fluorine-containing polymer is preferably one which has a dynamic friction coefficient of 0.03 to 0.20, a contact angle of 90 to 120° with water, and a pure water slip-off angle of 700 or less, and which is crosslinkable by heat or ionizing radiation. It is preferable that when the antireflection film, in the present invention, is set to an image display device, the peeling strength of the antireflection film from a commercially available adhesive tape be lower, because seals or memorandums are easily peeled off after they are adhered. The peeling strength is preferably 500 gf or less, more preferably 300 gf or less, and most preferably 100 gf or less. As the surface hardness of the antireflection film is higher when measured by a micro-hardness meter, the low-refractive index layer is damaged easily, and the surface hardness is preferably 0.3 GPa or more, more preferably 0.5 GPa or more.

Examples of the fluorine-containing polymer that can be used in the low refractive index layer, include hydrolysates or dehydrocondensates of a perfluoroalkyl group-containing silane compound (for example, (heptadecafluoro-1,1,2,2-tetrahydrodecyl)triethoxysilane), and in addition, fluorine-containing copolymers derived from a fluorine-containing monomer and a constitutional unit for imparting crosslinking reactivity, as constituent units.

Specific examples of the fluorine-containing monomer unit include, for example, fluoroolefins (for example, fluoroethylene, vinylidene fluoride, tetrafluoroethylene, perfluorooctylethylene, hexafluoropropylene, perfluoro-2,2-dimethyl-1,3-dioxol), partially or completely fluorinated alkyl ester derivatives of (meth)acrylic acid (for example, BISCOAT 6FM (trade name), manufactured by Osaka Organic Chemical Industry, Ltd., and M-2020 (trade name), manufactured by Daikin Industries, Ltd.), and completely or partially fluorinated vinyl ethers, or the like. Among these, a perfluoroolefin is preferred. From the viewpoints of refractive index, solubility, transparency, and availability, hexafluoropropylene is particularly preferable.

Examples of the constituting unit for imparting crosslinking reactivity include the constituting unit obtained by polymerization of a monomer already having a self-crosslinking functional group in the molecule, such as glycidyl(meth)acrylate, and glycidyl vinyl ether; the constituting unit obtained by polymerization of a monomer having a carboxyl group, a hydroxyl group, an amino group, a sulfo group, or the like (for example, (meth)acrylic acid, methylol(meth)acrylate, hydroxyalkyl(meth)acrylate, allyl acrylate, hydroxyethyl vinyl ether, hydroxybutyl vinyl ether, maleic acid, crotonic acid, etc.); and the constituting unit comprised of the above-mentioned unit(s) to which a crosslinking reactive group such as (meth)acryloyl group has been introduced by a polymer reaction (for example, an acryloyl group can be introduced by a technique in which acrylic chloride is allowed to act on a hydroxyl group in the above-mentioned unit).

Further, besides the above-mentioned fluorine-containing monomer unit and the constituting unit for imparting crosslinking reactivity, a monomer containing no fluorine atom may be copolymerized therewith, in some cases appropriately, from the viewpoints of solubility in a solvent, transparency of the resulting film, and the like. The monomer unit that can be used in combination is not particularly limited, and examples of the monomer unit include olefins (e.g., ethylene, propylene, isoprene, vinyl chloride, vinylidene chloride), acrylic esters (e.g., methyl acrylate, ethyl acrylate, 2-ethylhexyl acrylate), methacrylic esters (e.g., methyl methacrylate, ethyl methacrylate, butyl methacrylate, ethyleneglycol dimethacrylate), styrene and derivatives thereof (e.g., styrene, divinylbenzene, vinyltoluene, α-methylstyrene), vinyl ethers (e.g., methyl vinyl ether, ethyl vinyl ether, cyclohexyl vinyl ether), vinyl esters (e.g., vinyl acetate, vinyl propionate, vinyl cinnamate), acrylamides (e.g., N-tert-butylacrylamide, N-cyclohexylacrylamide), methacrylamides, and acrylonitrile derivatives.

A curing agent may be used in combination with the above-mentioned polymer(s) appropriately, as disclosed in JP-A-10-25388 and JP-A-10-147739.

<Light Scattering Layer>

The light scattering layer is formed for imparting, to the film, light scattering characteristics resulting from surface scattering and/or internal scattering, and hardcoat characteristics to improve scratch resistance of the film. The light scattering layer is generally formed to contain a binder, which imparts hardcoat characteristics; matt particles, which impart light scattering characteristics; and, if necessary, inorganic fillers, which raise refractive index, prevent crosslinking shrinkage from occur, and enhance mechanical strength.

The film thickness of the light scattering layer is preferably 1 to 10 μm and more preferably 1.2 to 6 μm, to impart the hardcoat characteristics. When the light scattering layer is too thin, the hard characteristics are insufficient, and on the other hand when too thick, the resultant film becomes poor due to its curling and brittle characteristics, thereby resulting poor treating or processing suitability.

As the compound (a binder polymer) used in the light scattering layer, a polymer having a saturated hydrocarbon chain or a polyether chain, as a main chain, is preferred. Among them, a polymer having a saturated hydrocarbon chain as a main chain is more preferred. Further, it is preferred that the binder polymer has a cross-linking structure, As the binder polymer having a saturated hydrocarbon chain as a main chain, polymers of ethylenically unsaturated monomers are preferred. As the binder polymer having a saturated hydrocarbon chain as a main chain and in addition a cross-linking structure, (co)polymers of monomers having at least two ethylenically unsaturated groups are preferred. In order to produce a binder polymer having a high refractive index, it is also possible to incorporate an aromatic ring, or at least one atom selected from a group consisting of halogen (except for fluorine), sulfur, phosphorus, and nitrogen atoms, into the structure of the foregoing monomer.

Examples of the monomer having two or more ethylenically unsaturated groups include esters of a polyhydric alcohol and a (meth)acrylic acid (e.g., ethyleneglycol di(meth)acrylate, butanediol di(meth)acrylate, hexanediol di(meth)acrylate, 1,4-cyclohexane di(meth)acrylate, pentaerythritol tetra(meth)acrylate, pentaerythritol tri(meth)acrylate, trimethylolpropane tri(meth)acrylate, trimethylolethane tri(meth)acrylate, dipentaerythritol tetra(meth)acrylate, dipentaerythritol penta(meth)acrylate, dipentaerythritol hexa(meth)acrylate, pentaerythritol hexa(meth)acrylate, 1,2,3-cyclohexane tetra(meth)acrylate, polyurethane poly(meth)acrylate, polyester poly(meth)acrylate), modified products of the aforementioned ethylene oxide, vinyl benzene and its derivatives (e.g., 1,4-divinylbenzene, 4-vinylbenzoic acid-2-acryloylethyl ester, 1,4-divinylcyclohexanone), vinylsulfones (e.g., divinylsulfone), acrylamides (e.g., methylene-bis-acrylamide), and methacrylamides. These monomers may be used singly or in combination of two or more of these.

Specific examples of the high-refractive-index monomer include bis(4-methacryloylthiophenyl)sulfide, vinylnaphthalene, vinylphenylsulfide, and 4-methacryloxyphenyl-4′-methoxyphenyl thioether. These monomers may also be used singly or in combination of two or more kinds of these.

Polymerization of any of these monomers having ethylenically unsaturated groups can be conducted by irradiation of ionization radiation or heat, in the presence of a photo radical initiator or a thermal radical initiator.

Accordingly, an anti-reflection film can be formed by the steps of: preparing a coating solution containing a monomer having ethylenically unsaturated groups, a photo radical initiator or a thermal radical initiator, matt particles, and an inorganic filler; applying said coating solution onto a transparent support; and then curing the same by a polymerization reaction by ionization radiation or heat. As the initiator, e.g. a photo radical initiator, any initiator may be used.

The polymer having polyether as a main chain is preferably a ring-opened polymer of a polyfunctional epoxy compound. The ring-opening polymerization of a multi-functional epoxy compound can be performed by irradiation of ionization radiation or heat, in the presence of a light-induced acid-generating agent or a heat-induced acid-generating agent.

Accordingly, an anti-reflection film may be formed by a method comprising the steps of: preparing a coating solution containing a multi-functional epoxy compound, a light-induced acid-generating agent or a heat-induced acid-generating agent, matt particles, and an inorganic filler; applying said coating solution on a transparent support; and then hardening the resultant coating by a polymerization reaction by ionization radiation or heat.

Using a monomer having a cross-linkable functional group in place of, or in addition to, the monomer having 2 or more ethylenically unsaturated groups, cross-linkable functional groups may be introduced into a polymer so that a cross-linking structure can be introduced into a binder polymer by the reaction of said cross-linkable functional groups.

Examples of the cross-linkable functional group include an isocyanato group, an epoxy group, an aziridine group, an oxazoline group, an aldehyde group, a carbonyl group, a hydrazine group, a carboxyl group, a methylol group, and an active methylene group. Vinyl sulfonic acid, acid anhydride, cyanoacrylate derivatives, melamine, etherificated methylol, ester and urethane, and also metal alkoxides such as tetramethoxysilane may be used as a monomer to introduce a cross-linking structure. It is also possible to use a functional group capable of exerting a cross-linking performance as a result of a decomposition reaction, such as a blocked isocyanate group. In other words, the term “cross-linkable functional group” referred to herein embraces those exerting a cross-linking reaction as a result of decomposition even though they do not react instantly.

In a binder polymer having the cross-linkable functional group, a cross-linking structure can be formed by coating the binder polymer on a base, followed by heating.

In order to give anti-glare property to a light-scattering layer, the light-scattering layer may contain matt particles (such as inorganic compound particles or resin particles) having an average particle size of generally 1 to 10 μm (preferably 1.5 to 7.0 μm) that is larger than the filler-particle size.

Preferable specific examples of the afore-mentioned matt particles include inorganic compound particles, such as silica particles, and TiO₂ particles; and resin particles, such as acrylic particles, cross-linking acrylic particles, polystyrene particles, cross-linking styrene particles, melamine resin particles, and benzoguanamine resin particles. Among them, cross-linking styrene particles, cross-linking acryl particles, cross-linking acrylstyrene particles, and silica particles are preferred.

The shape of matt particles to be used may be any of a spherical form or an amorphous form.

Further, 2 or more kinds of the matt particles different in particle diameter may be used in combination. It is possible to impart antiglare characteristics using matt particles having a larger particle diameter and to impart other optical characteristics using matt particles having a smaller particle diameter.

The particle size distribution of the above-mentioned matt particles is preferably mono-disperse, and it is more preferable that the particle sizes of individual particles are almost same as much as possible. For example, assuming that particles having a larger particle size by 20% or more than the average particle size are designated as coarse particles, the content of said coarse particles is preferably 1% or less, more preferably 0.1% or less, and further more preferably 0.01% or less, to the total number of particles. The matt particles having the above-mentioned particle size distribution can be obtained according to a usual synthetic reaction followed by classification. Matt particles with a more preferable particle size distribution can be obtained by increasing the number of times of the classification, or by advancing the degree of the classification.

The above matt particles are incorporated in a light-scattering layer so that the amount of matt particles in the formed light-scattering layer becomes preferably in the range of 10 to 1,000 mg/m², more preferably in the range of 100 to 700 mg/m².

The particle size distribution of matt particles may be measured by a Coulter counter method, and the measured distribution may be converted into a particle number distribution.

The light scattering layer preferably contains, in addition to the above-mentioned matt particles, an inorganic filler, which is composed of an oxide of at least one metal selected from titanium, zirconium, aluminum, indium, zinc, tin, and antimony, and which has an average particle diameter of 0.2 μm or less, preferably 0.1 μm or less, and more preferably 0.06 μm or less, in order to increase the refractive index of the layer.

On the contrary, in a light scattering layer containing high-refractive-index matt particles, in order to increase a difference in refractive index between the layer and the matt particles, it is preferred to use an oxide of silicon for maintaining the refractive index of the layer at a low level. A preferred particle size of the matt particles is the same as that of the above-mentioned inorganic filler.

Specific examples of the inorganic filler that can be used in the light scattering layer include TiO₂, ZrO₂, Al₂O₃, In₂O₃, ZnO, SnO₂, Sb₂O₃, ITO (indium-tin oxide), and SiO₂. TiO₂ ZrO₂ are particularly preferable in view of increasing a refractive index. It is also preferable that the surface of the inorganic filler is subjected to a silane coupling treatment or a titanium coupling treatment. For this purpose, a surface treating agent having a functional group capable of reacting with the binder species is preferably used on the surface of the filler.

The addition amount of the inorganic filler is preferably 10 to 90 mass %, more preferably 20 to 80 mass %, and particularly preferably 30 to 75 mass %, to the total mass of the light scattering layer.

Note that such a filler has a sufficiently small particle size as compared with the wavelength of light so that it causes no scattering of light, and a dispersion of the filler dispersed in a binder polymer behaves as an optically uniform substance.

The mixture of the binder and the inorganic filler in the light scattering layer has a refractive index in the bulk thereof of preferably 1.48 to 2.00, more preferably 1.50 to 1.80. The refractive index can be set within the above-mentioned range, by appropriately selecting the kinds of the binder and the inorganic filler and the ratio of addition amounts thereof. By preliminary conducting experiments, such a selection can be known in a simple manner.

To secure surface state uniformity by particularly suppressing surface deficiency, such as coating unevenness, drying unevenness, and spot defects, the light-scattering layer may be formed from a coating composition for an antiglare layer that contains a fluorine-containing surfactant, a silicone-series surfactant, or both therein. In particular, the fluorine-containing surfactant is preferably used, since it exhibits, even with a smaller addition amount, the effect of obviating the surface deficiency, such as coating unevenness, drying unevenness or spot defects of the antireflection film according to the present invention. Such a surfactant is to be used, for improving productivity by imparting high-speed coatability with improving surface state uniformity.

(2) Antireflection Film Having a Layer Structure Obtained by Forming, on a Transparent Protective Film, a Middle Refractive Index Layer, a High Refractive Index Layer, and a Low Refractive Index Layer, in This Order

An antireflection film at least having a layer structure obtained by forming, on a substrate, a middle refractive index layer, a high refractive index layer, and a low refractive index layer (the outermost layer), in this order, is preferably designed to have refractive indexes satisfying the following relationship.
(The refractive index of the high refractive index layer)>(the refractive index of the middle refractive index layer)>(the refractive index of the transparent substrate)>(the refractive index of the low refractive index layer)

A hard coat layer may be formed between the transparent substrate and the middle refractive index layer. The antireflection film may be composed of a middle-refractive-index hardcoat layer, a high refractive index layer, and a low refractive index layer Examples thereof are described in JP-A-8-122504, JP-A-8-110401, JP-A-10-300902, JP-A-2002-243906, and JP-A-2000-111706. A different function may be given to each of the layers. Examples thereof include a low refractive index layer having antifouling property, and a high refractive index layer having antistatic property (described in JP-A-10-206603, JP-A-2002-243906, and the like).

The haze of the antireflection film is preferably 5% or less, more preferably 3% or less. The mechanical strength of the film is preferably H or harder, further preferably 2H or harder, and most preferably 3H or harder, in terms of the pensile hardness test, according to JIS K5400.

<High-Refractive Index Layer and Middle-Refractive Index Layer>

The layer having a higher refractive index in the antireflection film is generally composed of a curable film at least containing a matrix binder and high-refractive index inorganic compound superfine particles of average particle size 100 nm or less.

The high refractive index, inorganic compound superfine particles may be made of an inorganic compound having a refractive index of 1.65 or more, preferably a refractive index of 1.9 or more. Examples of the inorganic compound include oxides, for example, of Ti, Zn, Sb, Sn, Zr, Ce, Ta, La, or In; and composite oxides containing two or more out of these metal atoms.

Examples of the embodiment of such superfine particles include the particles whose surface is treated with a surface-treating agent (e.g. a silane coupling agent, as described in JP-A-11-295503, JP-A-11-153703, and JP-A-2000-9908, or an anionic compound or an organometallic coupling agent, as described in JP-A-2001-310432,), the particles in which a core-shell structure is formed to have high refractive index particles be a core (as described in JP-A-2001-166104, and the like), and the particles to be used in combination with a specific dispersing agent (as described in JP-A-11-153703, U.S. Pat. No. 6,210,858B1, JP-A-2002-2776069, and the like).

The material which forms the matrix may be any of thermoplastic resins and thermosetting resins.

Further, the material is preferably at least one composition selected from a composition comprising a polyfunctional compound containing at least two radical polymerizable groups and/or cation polymerizable groups, a composition comprising an organometallic compound containing a hydrolyzable group, and a composition comprising a partial condensate thereof. Examples of thereof include those described in JP-A-2000-47004, JP-A-2001-315242, JP-A-2001-31871, and JP-A-2001-296401.

Further, a curable film obtained from a metal alkoxide composition and a colloid metal oxide which is obtained from a hydrizate-condensation product of a metal alkoxide, is also preferable. Examples thereof is described in JP-A-2001-293818.

The refractive index of the high-refractive-index layer is generally in the range of 1.70 to 2.20. The thickness of the high-refractive-index layer is preferably from 5 nm to 10 μm, more preferably from 10 nm to 1 μm.

The refractive index of the middle-refractive-index layer is adjusted so as to become a value (magnitude) between the refractive index of the low-refractive-index layer and the refractive index of the high-refractive-index layer. The refractive index of the middle-refractive-index layer is preferably in the range of 1.50 to 1.70. The thickness of the middle-refractive-index layer is preferably from 5 nm to 10 μm, more preferably from 10 nm to 1 μm.

<Low-Refractive-Index Layer>

The low-refractive-index layer is generally laminated on the high-refractive-index layer. The low-refractive-index layer has a refractive index generally in the range of 1.20 to 1.55, preferably in the range of 1.30 to 1.50.

The low-refractive-index layer is preferably formed as the outermost layer having scratch resistance and antifouling property. As a means for improving the scratch resistance largely, it is effective to impart lubricity to the surface, and a known means of making the layer thinner, for example, by introducing of a silicone (group) or introducing of a fluorine(-containing group), can be applied.

The refractive index of the fluorine-containing compound is preferably 1.35 to 1.50, more preferably 1.36 to 1.47. The fluorine-containing compound is preferably a compound which contains a cross-linkable or polymerizable functional group and which contains fluorine atoms in an amount of 35 to 80% by mass.

Examples thereof include compounds, as described in JP-A-9-222503 paragraphs [0018] to [0026], JP-A-11-38202 paragraphs [0019] to [0030], JP-A-2001-40284 paragraphs [0027] to [0028], and JP-A-2000-284102.

The silicone-containing compound is generally a compound which has a polysiloxane structure, and preferably a compound which contains, in the polymer chain thereof, a curable functional group or polymerizable functional group, to have a crosslinked structure in the film to be formed. Examples thereof include reactive silicones (such as “Silaplane” (trade name), manufactured by Chisso Corporation), and polysiloxane containing at both ends thereof silanol groups (as described in JP-A-11-258403), and the like.

It is preferable to conduct the crosslink or polymerization reaction of the fluorine-containing and/or siloxane polymer having a crosslinkable or polymerizable group, by radiation of light or heating at the same time of or after applying a coating composition containing a polymerization initiator, a sensitizer, and the like, for forming an outermost layer.

It is also preferable to use a sol-gel cured film obtained by curing an organometallic compound, such as a silane coupling agent, and a silane coupling agent which contains a specific fluorine-containing hydrocarbon group, in the presence of a catalyst, by condensation reaction.

Examples thereof include a silane compound which contains a polyfluoroalkyl group, or a partially-hydrolyzed condensate thereof (those as described, for example, in JP-A-58-142958, JP-A-58-147483, JP-A-58-147484, JP-A-9-157582, and JP-A-11-106704), and a silyl compound which contains a poly(perfluoroalkyl ether) group, which is a long chain group containing fluorine (those as described, for example, in JP-A-2000-117902, JP-A-2001-48590, and JP-A-2002-53804).

The low refractive index layer may contain, as an additive other than the above, for example, a filler {e.g. silicon dioxide (silica); low refractive index inorganic compound particles having a primary average particle size of 1 to 150 nm made, for example, of fluorine-containing particles (e.g. magnesium fluoride, calcium fluoride, barium fluoride); organic fine-particles, as described in JP-A-11-3820, paragraphs [0020] to [0038]}, a silane coupling agent, a lubricant, a surfactant.

In the case that the low refractive index layer is positioned beneath the outermost layer, the low refractive index layer may be formed by a gas phase method (such as a vacuum vapor deposition method, a sputtering method, an ion plating method, or a plasma CVD method). The low refractive index layer is preferably formed by a coating method, since the layer can be formed at low costs.

The thickness of the low-refractive-index layer is preferably from 30 to 200 nm, more preferably from 50 to 150 nm, and most preferably from 60 to 120 nm.

(3) Other Layers in the Antireflective Layer

Further, any of a hardcoat layer, a forward scattering layer, a primer layer, an antistatic layer, an undercoat layer, and protective layer may be provided.

<Hardcoat Layer>

The hard coat layer is provided on the surface of the transparent support, for imparting physical strength to the transparent protective film having an antireflective layer provided thereon. In particular, the hardcoat layer is preferably disposed between the transparent support and the high-refractive index layer.

The hard coat layer is preferably formed by crosslinking reaction or polymerizing reaction of a curable compound through light and/or heat.

The curable functional group thereof is preferably a photopolymerizable functional group. An organometallic compound which contains a hydrolyzable functional group is preferably an organic alkoxysilyl compound.

Specific examples of these compounds are the same as exemplified as the high refractive index layer. Specific examples of the composition which constitutes the hard coat layer, include those as described in JP-A-2002-144913, JP-A-2000-9908, and International Publication No. WO 00/46617 pamphlet.

The high refractive index layer can function as a hard coat layer also. In this case, it is preferable to use the manner described about on the high refractive index layer, to disperse fine particles finely to be incorporated into the hard coat layer to be formed.

The hard coat layer may contain particles having an average particle size of 0.2 to 10 μm, thereby to impart an antiglare function to behave as an anti-glare layer also.

The film thickness of the hard coat layer, which may be appropriately set according to the application thereof, is preferably from 0.2 to 10 μm, more preferably from 0.5 to 7 μm.

The mechanical strength of the hard coat layer is preferably H or harder, further preferably 2H or harder, and most preferably 3H or harder, in terms of the pensile hardness, according to JIS K5400 test. The hard coat layer is preferably one which is less in an abraded amount in a taber test according to JIS K5400, which means a test piece made of said hardcoat layer is less in the abraded amount after the test.

<Antistatic Layer>

When an antistatic layer is to be formed, the antistatic layer is preferably provided with such conductivity that the volume resistance is 10⁻⁸ (Ωcm⁻³) or less. Although the antistatic layer may be made to have a volume resistance of as low as 10⁻⁸ (Ωcm⁻³), by using a hygroscopic material, a water-soluble inorganic salt, a certain type of surfactant, a cationic polymer, an anionic polymer, or a colloidal silica, these materials have the problem that they have large dependency on temperature and humidity and they cannot ensure sufficient conductivity under low humidity. Thus, a metal oxide is preferable as a conductive layer material. There is a metal oxide colored. If the colored metal oxide is used as the conductive layer raw material, the entire film is colored, which is not preferable. Examples of metal capable of forming uncolored metal oxide include Zn, Ti, Al, In, Si, Mg, Ba, Mo, W, or V. Any of metal oxides using the metal as a major component is preferably used. Specific examples of the metal oxide include ZnO, TiO₂, SnO₂, Al₂O₃, In₂O₃, SiO₂, MgO, BaO, MoO₃, V₂O₅, or a composite oxide of these. In particular, ZnO, TiO₂, and SnO₂ are preferable. As examples of the metal oxide containing a hetero atom, an addition product of Al, In or the like to ZnO; an addition product of Sb, Nb, a halogen element or the like to SnO₂; and an addition product of Nb, Ta or the like to TiO₂ are effective. Moreover, materials obtained by adhering the aforementioned metal oxide to other crystalline metal grains or fibrous substance (e.g., titanium oxide), as described in JP-B-59-6235, may be used. In this connection, the volume resistance and the surface resistance are different properties and are not simply compared with each other, but for ensuring a conductivity of 10⁻⁸ (Ωcm⁻³) or less in terms of volume resistance, it is sufficient that the conductive layer has a surface resistance of generally about 10⁻¹⁰ (Ω/□, i.e. ohm per square) or less, preferably 10⁻⁸ (Ω/□) or less. It is necessary that the surface resistance of the conductive layer is measured as a value obtained when the antistatic layer is formed as the outermost layer, and the surface resistance may be measured in the course of forming a laminated film as described herein.

[Liquid Crystal Display Device]

The polarizing plate in which the cellulose acylate film of the present invention is used can be used advantageously in a liquid crystal display device. The polarizing plate of the present invention may be used in liquid crystal cells driven in various displaying modes. There are proposed various display modes including: TN (Twisted Nematic), IPS (In-Plane Switching), FLC (Ferroelectric Liquid Crystal), AFLC (Anti-ferroelectric Liquid Crystal), OCB (Optically Compensatory Bend), STN (Supper Twisted Nematic), VA (Vertically Aligned), and HAN (Hybrid Aligned Nematic). Among these, the present invention can be preferably applied to OCB-mode or VA-mode.

In an OCB mode liquid crystal display device, the liquid crystal cell of OCB mode is a liquid crystal cell of bend orientation mode in which rod-like liquid crystal molecules in a upper part and a lower part in the liquid crystal cell are substantially reversely (symmetrically) oriented. The liquid crystal cell of OCB mode is disclosed in U.S. Pat. Nos. 4,583,825 and 5,410,422. Since rod-like liquid crystal molecules in the upper part and the lower part of the liquid crystal cell are symmetrically oriented, the liquid crystal cell of bend orientation mode has self-optical compensatory function. Therefore, this liquid crystal mode is also referred to as OCB (optically compensatory bend) liquid crystal mode. The liquid crystal display of bend orientation mode has such an advantage that a responding speed is fast.

In a liquid crystal cell of VA mode, rod-like liquid crystal molecules are substantially vertically oriented, while no voltage is applied.

Examples of the liquid crystal cell of VA mode include: (1) a liquid crystal cell of VA mode in a narrow sense (as described in JP-A-2-176625), in which rod-like liquid crystal molecules are substantially vertically oriented while no voltage is applied, and the molecules are substantially horizontally oriented while a voltage is applied; (2) a liquid crystal cell (of MVA mode) (as described in SID97, Digest of Tech. Papers (Synopsis), 28 (1997), 845), in which the VA mode is modified to be multi-domain type, to enlarge the viewing angle; (3) a liquid crystal cell of (n-ASM mode) (as described in Nippon Ekisho Toronkai (Liquid Crystal Forum of Japan), Digest of Tech. Papers (1998), 58-59), in which rod-like liquid crystal molecules are substantially vertically oriented while no voltage is applied, and the molecules are oriented in twisted multi-domain orientation while a voltage is applied; and (4) a liquid crystal cell of SURVIVAL mode (as presented in LCD International 98).

In liquid crystal display devices driven in an OCB mode or VA mode, a liquid crystal cell may be disposed and two polarizing plates may be disposed on both sides of the liquid crystal cell. In the VA mode, the polarizing plate may be disposed in the back light side of the cell. The liquid crystal cell supports a liquid crystal between two electrode substrates.

The cellulose compound film of the present invention has a developability of a negative retardation in the film thickness direction, and further has a low water permeability and a low moisture content. When the film of the present invention is used as a protective film for a polarizing plate, the film of the present invention exhibits such excellent effects as excellent durability of the polarizing plate, remarkably less deterioration of the polarizing plate performance particularly under high temperature and high humidity conditions.

The cellulose compound film of the present invention can be preferably used in optical compensation sheets, polarizing plates, and liquid crystal display devices. According to the present invention, there can be provided a liquid crystal display device which provides high contrast, shows little chromatic change with different viewing angles, further shows little changes in image quality upon environmental humidity changes, and has excellent durability.

The present invention will be described in more detail based on examples given below, but the invention is not meant to be limited by these.

### EXAMPLES

### Example 1

<Cellulose Compound>

Cellulose compounds, as shown in Table 5, were synthesized as follows: The cellulose compound that can be used in the present invention was prepared from, as a starting, material, cellulose acetate having an acetyl substitution degree of 2.45 (manufactured by Aldrich), cellulose acetate having an acetyl substitution degree of 2.41 (trade name: L-70, manufactured by Daicel Chemical Industries, Ltd,), or cellulose acetate having an acetyl substitution degree of 2.14 (trade name: LM-80, manufactured by Daicel Chemical Industries, Ltd.), through reaction with a corresponding acid chloride. Further, cellulose acetate low in acetyl substitution degree was prepared, by synthesizing, an intermediate having an acetyl substitution degree of 1.80 from, as a starting material, microcrystalline cellulose (manufactured by Aldrich) by the method as described in the following Synthetic Example 1, and then reacting the intermediate with a corresponding acid chloride.

In Table 5, TAC 1 and TAC 2 were each prepared by the method described in Hatsumei Kyokai Kokai Giho (Kogi No. 2001-1745, Mar. 15, 2001, Hatsumei Kyokai), pp. 7 to 12.

The polarizability anisotropy Δα of each of the substituents of the cellulose compounds was calculated with Gaussian03 (Revision B.03, trade name, software manufactured by Gaussian, Inc.). Specifically, using a structure optimized at the B3LYP/6-31G* level, the polarizability tensor was calculated on the B3LYP/6-311+G** level with a substituent bonded to a hydroxy group on a β-glucose ring that is a constituting unit of cellulose, as a partial structure containing an oxygen atom of the hydroxy group, the resulting polarizability tensor was diagonalized, and the diagonal components were assigned to the mathematical formula (1), to thereby determine the polarizability anisotropy Δα. In Table 5, in the columns of ‘Polarizability anisotropy’, the name of the acyl group substituted is shown, and the polarizability anisotropy of said group as calculated according to the above method is shown in parenthesis.

The substitution degrees of substituents with a high polarizability at the 2-, 3-, or 6-position of the cellulose compound were each measured by ¹³C-NMR. The results are summarized in Table 5.

### Synthetic Example 1

### Synthesis of Cellulose Acetate (Acetyl Substitution Degree 1.80)

To 50 parts by mass of cellulose (manufactured by Aldrich, microcrystalline cellulose, hardwood pulp), 50 parts by mass of acetic acid was sprayed, and left standing for 3 hours at room temperature. Separately, a mixture of 3.5 parts by mass of sulfuric acid, 331 parts by mass of anhydrous acetic acid, and 319 parts by mass of acetic acid, as acylating agents, was provided, the mixture was then cooled to −10° C. and added to the reaction vessel containing the cellulose which had been subjected to the above-described pretreatment. After a lapse of 1 hour, the internal temperature of the vessel was increased to 40° C., followed by stirring for 1 hour, then the liquid temperature was adjusted to 30° C., followed by stirring to continue until the solution viscosity measured at 30° C. would reach 1,900 cP.

Then, the reaction vessel was cooled on an ice-water bath at 0° C., to which 183 parts by mass of a 50% acetic acid aqueous solution cooled to 0° C. was added. The internal temperature was increased to 85° C., followed by stirring for further 9 hours.

Then, to the reaction vessel, a mixed solution of 12.2 parts by mass of magnesium acetate tetrahydrate, 12.2 parts by mass of acetic acid, and 12.2 parts by mass of water was added, followed by stirring at 60° C. for 2 hours. Thereto, a mixture of acetic acid and water was added with gradually increasing the ratio of water in the total amount of 2,500 parts by mass of acetic acid and 6,500 parts by mass of water, to precipitate cellulose acetate. The resultant cellulose acetate precipitated was washed with hot water at 75° C. for 4 hours with the washing water was occasionally replaced. After washing, the cellulose acetate was stirred for 0.5 hour in a 0.002-mass % aqueous calcium hydroxide solution, followed by deliquoring, and then dried under vacuum at 70° C.

The thus-obtained cellulose acetate had a degree of acetylation of 1.80, the number average molecular weight of 63,000, the weight average molecular weight of 178,000, and the viscosity average degree of polymerization of 280.

### Synthetic Example 2

### Synthesis of M-001

To a 1-L three-necked flask equipped with a mechanical stirrer, a thermometer, a cooling tube, and an addition funnel, 40 g of cellulose acetate (acetyl substitution degree 2.45, manufactured by Aldrich), 46.0 mL of pyridine, and 300 mL of methylene chloride were placed, followed by stirring at room temperature. Thereto, 62.4 mL of benzoyl chloride was slowly added dropwise, and after the completion of the addition, the mixture was stirred for another 6 hours at room temperature. After the reaction, the reaction solution was poured into 4 L of methanol while vigorously stirred, to deposit a white solid. The white solid was filtered by suction filtration, and washed three times with a large amount of methanol. The resultant white solid was dried overnight at 60° C., then dried under vacuum for 6 hours at 90° C., to obtain the target cellulose compound (M-001) as white powder (45.8 g, yield 98%).

### Synthetic Example 3

### Synthesis of M-002

To a 1-L three-necked flask equipped with a mechanical stirrer, a thermometer, a cooling tube, and an addition funnel, 40 g of cellulose acetate (acetyl substitution degree 2.45, manufactured by Aldrich), 46.0 mL of pyridine, and 300 mL of acetone were placed, followed by stirring at room temperature. Thereto, 62.4 mL of benzoyl chloride was slowly added dropwise, and after the completion of the addition, the mixture was stirred for another 4 hours at room temperature. After the reaction, the reaction solution was poured into 4 L of methanol while vigorously stirred, to deposit a white solid. The white solid was filtered by suction filtration, and washed three times with a large amount of methanol. The resultant white solid was dried overnight at 60° C., then dried under vacuum for 6 hours at 90° C., to obtain the target cellulose compound (M-002) as white powder (45.8 g, yield 99%).

### Synthetic Example 4

### Synthesis of M-003

To a 1-L three-necked flask equipped with a mechanical stirrer, a thermometer, a cooling tube, and an addition funnel, 40 g of cellulose acetate (acetyl substitution degree 2.45, manufactured by Aldrich), 46.0 mL of pyridine, and 300 mL of acetone were placed, followed by stirring at room temperature. Thereto, 62.4 mL of benzoyl chloride was slowly added dropwise, and after the completion of the addition, the mixture was stirred for another 4 hours at room temperature. After the reaction, the reaction solution was poured into 4 L of methanol while vigorously stirred, to deposit a white solid. The white solid was filtered by suction filtration, and washed three times with a large amount of methanol. The resultant white solid was dried overnight at 60° C., then dried under vacuum for 6 hours at 90° C., to obtain the target cellulose compound (M-003) as white powder (44.2 g, yield 97%).

### Synthetic Example 5

### Synthesis of Asaronic Acid Chloride

To a 1-L three-necked flask equipped with a mechanical stirrer, a thermometer, a cooling tube, and an addition funnel, 106.1 g of asaronic acid (2,4,5-trimethoxybenzoic acid) and 400 mL of toluene were placed, followed by stirring at 80° C. Thereto, 40.1 mL of thionyl chloride was slowly added dropwise, and after the completion of the addition, the mixture was stirred for another 2 hours at 80° C. After the reaction, the reaction solvent was distilled off with an aspirator, to obtain a white solid. To the resultant white solid, 300 mL of hexane was added, followed by vigorously stirring and dispersing, and then the white solid was filtered by suction filtration, and washed three times with a large amount of hexane. The resultant white solid was dried under vacuum for 4 hours at 60° C., to obtain the target asaronic acid chloride as white powder (115.3 g, yield 99%).

### Synthetic Example 6

### Synthesis of M-004

To a 1-L three-necked flask equipped with a mechanical stirrer, a thermometer, a cooling tube, and an addition funnel, 40 g of cellulose acetate (acetyl substitution degree 2.45, manufactured by Aldrich), 46.0 mL of pyridine, and 300 mL of acetone were placed, followed by stirring at room temperature. Thereto, 84.0 g of asaronic acid chloride was added powdery in some separated portions, and after the completion of the addition, the mixture was stirred for another 6 hours at room temperature. After the reaction, the reaction solution was poured into 4 L of methanol while vigorously stirred, to deposit a whity-pink solid. The whity-pink solid was filtered by suction filtration, and washed three times with a large amount of methanol. The resultant whity-pink solid was dried overnight at 60° C., then dried under vacuum for 6 hours at 90° C., to obtain the target cellulose compound (M-004) as white powder (47.0 g, yield 96%).

### Synthetic Example 7

### Synthesis of M-005

To a 1-L three-necked flask equipped with a mechanical stirrer, a thermometer, a cooling tube, and an addition funnel, 40 g of cellulose acetate (acetyl substitution degree 2.41, manufactured by Daicel Chemical Industries, Ltd.), 46.0 mL, of pyridine, and 300 mL of methylene chloride were placed, followed by stirring at room temperature. Thereto, 62.4 mL of benzoyl chloride was slowly added dropwise, and after the completion of the addition, the mixture was stirred for another 4 hours at room temperature. After the reaction, the reaction solution was poured into 4 L of methanol while vigorously stirred, to deposit a white solid. The white solid was filtered by suction filtration, and washed three times with a large amount of methanol. The resultant white solid was dried overnight at 60° C., then dried under vacuum for 6 hours at 90° C., to obtain the target cellulose compound (M-005) as white powder (43.8 g, yield 97%).

### Synthetic Example 8

### Synthesis of M-006

To a 1-L three-necked flask equipped with a mechanical stirrer, a thermometer, a cooling tube, and an addition funnel, 40 g of cellulose acetate (acetyl substitution degree 2.45, manufactured by Aldrich), 46.0 mL of pyridine, and 300 mL of methylene chloride were placed, followed by stirring at room temperature. Thereto, 84.0 g of asaronic acid chloride was added powdery in some separated portions, and after the completion of the addition, the mixture was stirred for another 6 hours at room temperature. After the reaction, the reaction solution was poured into 4 L of methanol while vigorously stirred, to deposit a whity-pink solid. The whity-pink solid was filtered by suction filtration, and washed three times with a large amount of methanol. The resultant whity-pink solid was dried overnight at 60° C., then dried under vacuum for 6 hours at 90° C., to obtain the target cellulose compound (M-006) as whity-pink powder (45.0 g, yield 97%).

### Synthetic Example 9

### Synthesis of M-007

To a 1-L three-necked flask equipped with a mechanical stirrer, a thermometer, a cooling tube, and an addition funnel, 40 g of cellulose acetate (acetyl substitution degree 2.41, manufactured by Daicel Chemical Industries, Ltd.), 46.0 mL of pyridine, and 300 mL of acetone were placed, followed by stirring at room temperature. Thereto, 62.4 mL of benzoyl chloride was slowly added dropwise, and after the completion of the addition, the mixture was stirred for another 4 hours at room temperature. After the reaction, the reaction solution was poured into 4 L of methanol while vigorously stirred, to deposit a white solid. The white solid was filtered by suction filtration, and washed three times with a large amount of methanol. The resultant white solid was dried overnight at 60° C., then dried under vacuum for 6 hours at 90° C., to obtain the target cellulose compound (M-007) as white powder (45.0 g, yield 99%).

### Synthetic Example 10

### Synthesis of M-008

To a 1-L three-necked flask equipped with a mechanical stirrer, a thermometer, a cooling tube, and an addition funnel, 40 g of cellulose acetate (acetyl substitution degree 2.41, manufactured by Daicel Chemical Industries, Ltd.), 46.0 mL of pyridine, and 300 mL of acetone were placed, followed by stirring at room temperature. Thereto, 62.4 mL of benzoyl chloride was slowly added dropwise, and after the completion of the addition, the mixture was stirred for another 6 hours at room temperature. After the reaction, the reaction solution was poured into 4 L of methanol while vigorously stirred, to deposit a white solid. The white solid was filtered by suction filtration, and washed three times with a large amount of methanol. The resultant white solid was dried overnight at 60° C., then dried under vacuum for 6 hours at 90° C., to obtain the target cellulose compound (M-008) as white powder (42.0 g, yield 92%).

### Synthetic Example 11

### Synthesis of M-009

To a 1-L three-necked flask equipped with a mechanical stirrer, a thermometer, a cooling tube, and an addition funnel, 40 g of cellulose acetate (acetyl substitution degree 2.41, manufactured by Daicel Chemical Industries, Ltd.), and 400 mL of pyridine were placed, followed by stirring at room temperature. Thereto, 62.4 mL, of benzoyl chloride was slowly added dropwise, and after the completion of the addition, the mixture was stirred for another 6 hours at room temperature. After the reaction, the reaction solution was poured into 4 L of methanol while vigorously stirred, to deposit a white solid. The white solid was filtered by suction filtration, and washed three times with a large amount of methanol. The resultant white solid was dried overnight at 60° C., then dried under vacuum for 6 hours at 90° C., to obtain the target cellulose compound (M-009) as white powder (41.0 g, yield 91%).

### Synthetic Example 12

### Synthesis of M-010

To a 1-L three-necked flask equipped with a mechanical stirrer, a thermometer, a cooling tube, and an addition funnel, 40 g of cellulose acetate (acetyl substitution degree 2.45, manufactured by Aldrich), and 400 mL of pyridine were placed, followed by stirring at room temperature. Thereto, 62.4 mL of benzoyl chloride was slowly added dropwise, and after the completion of the addition, the mixture was stirred for another 2 hours at 50° C. After the reaction, the reaction solution was poured into 4 L of methanol while vigorously stirred, to deposit a white solid. The white solid was filtered by suction filtration, and washed three times with a large amount of methanol. The resultant white solid was dried overnight at 60° C., then dried under vacuum for 6 hours at 90° C., to obtain the target cellulose compound (M-010) as white powder (44.8 g, yield 97%).

### Synthetic Example 13

### Synthesis of M-011

To a 1-L three-necked flask equipped with a mechanical stirrer, a thermometer, a cooling tube, and an addition funnel, 40 g of cellulose acetate (acetyl substitution degree 2.41, manufactured by Daicel Chemical Industries, Ltd.), 46.0 mL of pyridine, and 300 mL of acetone were placed, followed by stirring at room temperature. Thereto, 62.4 mL of benzoyl chloride was slowly added dropwise, and after the completion of the addition, the mixture was stirred for another 6 hours at room temperature. After the reaction, the reaction solution was poured into 4 L of methanol while vigorously stirred, to deposit a white solid. The white solid was filtered by suction filtration, and washed three times with a large amount of methanol. The resultant white solid was dried overnight at 60° C., then dried under vacuum for 6 hours at 90° C., to obtain the target cellulose compound (M-011) as white powder (42.0 g, yield 92%).

### Synthetic Example 14

### Synthesis of M-012

To a 1-L three-necked flask equipped with a mechanical stirrer, a thermometer, a cooling tube, and an addition funnel, 40 g of cellulose acetate (acetyl substitution degree 2.14, manufactured by Daicel Chemical Industries, Ltd.), 46.0 mL of pyridine, and 300 mL of acetone were placed, followed by stirring at room temperature. Thereto, 62.4 mL of benzoyl chloride was slowly added dropwise, and after the completion of the addition, the mixture was stirred for another 6 hours at room temperature. After the reaction, the reaction solution was poured into 4 L of methanol while vigorously stirred, to deposit a white solid. The white solid was filtered by suction filtration, and washed three times with a large amount of methanol. The resultant white solid was dried overnight at 60° C., then dried under vacuum for 6 hours at 90° C., to obtain the target cellulose compound (M-012) as white powder (48.0 g, yield 97%).

### Synthetic Example 15

### Synthesis of M-013

To a 1-L three-necked flask equipped with a mechanical stirrer, a thermometer, a cooling tube, and an addition funnel, 40 g of cellulose acetate (acetyl substitution degree 2.14, manufactured by Daicel Chemical Industries, Ltd.), 46.0 mL of pyridine, and 300 mL of methylene chloride were placed, followed by stirring at room temperature. Thereto, 62.4 mL of benzoyl chloride was slowly added dropwise, and after the completion of the addition, the mixture was stirred for another 6 hours at room temperature. After the reaction, the reaction solution was poured into 4 L of methanol while vigorously stirred, to deposit a white solid. The white solid was filtered by suction filtration, and washed three times with a large amount of methanol. The resultant white solid was dried overnight at 60° C., then dried under vacuum for 6 hours at 90° C., to obtain the target cellulose compound (M-013) as white powder (49.2 g, yield 98%).

### Synthetic Example 16

### Synthesis of M-014

To a 1-L three-necked flask equipped with a mechanical stirrer, a thermometer, a cooling tube, and an addition funnel, 40 g of cellulose acetate (acetyl substitution degree 2.14, manufactured by Daicel Chemical Industries, Ltd.), 46.0 mL of pyridine, and 300 mL of acetone were placed, followed by stirring at room temperature. Thereto, 62.4 mL of benzoyl chloride was slowly added dropwise, and after the completion of the addition, the mixture was stirred for another 6 hours at room temperature. After the reaction, the reaction solution was poured into 4 L of methanol while vigorously stirred, to deposit a white solid. The white solid was filtered by suction filtration, and washed three times with a large amount of methanol. The resultant white solid was dried overnight at 60° C., then dried under vacuum for 6 hours at 90° C., to obtain the target cellulose compound (M-014) as white powder (48.1 g, yield 97%).

### Synthetic Example 17

### Synthesis of M-015

To a 1-L three-necked flask equipped with a mechanical stirrer, a thermometer, a cooling tube, and an addition funnel, 40 g of cellulose acetate (acetyl substitution degree 2.14, manufactured by Daicel Chemical Industries, Ltd.), 46.0 mL of pyridine, and 300 mL of acetone were placed, followed by stirring at room temperature. Thereto, 62.4 mL of benzoyl chloride was slowly added dropwise, and after the completion of the addition, the mixture was stirred for another 4 hours at room temperature. After the reaction, the reaction solution was poured into 4 L of methanol while vigorously stirred, to deposit a white solid. The white solid was filtered by suction filtration, and washed three times with a large amount of methanol. The resultant white solid was dried overnight at 60° C., then dried under vacuum for 6 hours at 90° C., to obtain the target cellulose compound (M-015) as white powder (48.2 g, yield 99%).

### Synthetic Example 18

### Synthesis of M-016

To a 1-L three-necked flask equipped with a mechanical stirrer, a thermometer, a cooling tube, and an addition funnel, 40 g of cellulose acetate (acetyl substitution degree 2.14, manufactured by Daicel Chemical Industries, Ltd.), and 400 mL of pyridine were placed, followed by stirring at room temperature. Thereto, 62.4 mL of benzoyl chloride was slowly added dropwise, and after the completion of the addition, the mixture was stirred for another 2 hours at room temperature. After the reaction, the reaction solution was poured into 4 L of methanol while vigorously stirred, to deposit a white solid. The white solid was filtered by suction filtration, and washed three times with a large amount of methanol. The resultant white solid was dried overnight at 60° C., then dried under vacuum for 6 hours at 90° C., to obtain the target cellulose compound (M-016) as white powder (49.0 g, yield 96%).

### Synthetic Example 19

### Synthesis of M-017

To a 1-L three-necked flask equipped with a mechanical stirrer, a thermometer, a cooling tube, and an addition funnel, 36 g of cellulose acetate (acetyl substitution degree 1.80) described in the Synthetic Example 1, and 400 mL of pyridine were placed, followed by stirring at room temperature. Thereto, 93.0 mL, of benzoyl chloride was slowly added dropwise, and after the completion of the addition, the mixture was stirred for another 4 hours at room temperature. After the reaction, the reaction solution was poured into 4 L of methanol while vigorously stirred, to deposit a white solid. The white solid was filtered by suction filtration, and washed three times with a large amount of methanol. The resultant white solid was dried overnight at 60° C., then dried under vacuum for 6 hours at 90° C., to obtain the target cellulose compound (M-017) as white powder (46.0 g, yield 88%).

### Synthetic Example 20

### Synthesis of M-018

To a 1-L three-necked flask equipped with a mechanical stirrer, a thermometer, a cooling tube, and an addition funnel, 36 g of cellulose acetate (acetyl substitution degree 1.80) described in the Synthetic Example 1, and 400 mL of pyridine were placed, followed by stirring at room temperature. Thereto, 84.0 g of asaronic acid chloride was added powdery in some separated portions, and after the completion of the addition, the mixture was stirred for another 6 hours at room temperature. After the reaction, the reaction solution was poured into 4 L of methanol while vigorously stirred, to deposit a yellow solid. The yellow solid was filtered by suction filtration, and washed three times with a large amount of methanol. The resultant yellowish-white solid was dried overnight at 60° C., then dried under vacuum for 6 hours at 90° C., to obtain the target cellulose compound (M-018) as yellowish-white powder (53.6 g, yield 85%).

### Synthetic Example 21

### Synthesis of M-019

To a 1-L three-necked flask equipped with a mechanical stirrer, a thermometer, a cooling tube, and an addition funnel, 36 g of cellulose acetate (acetyl substitution degree 1.80) described in the Synthetic Example 1, 46.0 mL of pyridine, and 300 mL of acetone were placed, followed by stirring at room temperature. Thereto, 93.0 mL of benzoyl chloride was slowly added dropwise, and after the completion of the addition, the mixture was stirred for another 2 hours at 50° C. After the reaction, the reaction solution was poured into 4 L of methanol while vigorously stirred, to deposit a white solid. The white solid was filtered by suction filtration, and washed three times with a large amount of methanol. The resultant white solid was dried overnight at 60° C., then dried under vacuum for 6 hours at 90° C., to obtain the target cellulose compound (M-019) as white powder (41.3 g, yield 85%).

### Synthetic Example 22

### Synthesis of M-020

To a 1-L three-necked flask equipped with a mechanical stirrer, a thermometer, a cooling tube, and an addition funnel, 36 g of cellulose acetate (acetyl substitution degree 1.80) described in the Synthetic Example 1, 46.0 mL of pyridine, and 500 mL, of acetone were placed, followed by stirring at room temperature. Thereto, 120.0 g of asaronic acid chloride was added powdery in some separated portions, and after the completion of the addition, the mixture was stirred for another 6 hours at room temperature. After the reaction, the reaction solution was poured into 4 L of methanol while vigorously stirred, to deposit a yellow solid. The yellow solid was filtered by suction filtration, and washed three times with a large amount of methanol. The resultant yellowish-white solid was dried overnight at 60° C., then dried under vacuum for 6 hours at 90° C., to obtain the target cellulose compound (M-020) as yellowish-white powder (50.9 g, yield 87%).

TABLE 5
Cellulose compound

| | Substituent low in polarizability | | Substituent high in polarizability | | | | | |
|---|---|---|---|---|---|---|---|---|
| | | Total of | | Total of | | | | |
| | Polarizability | substitution | Polarizability | substitution | Substitution degree distribution (*2) | | | |
| | anisotropy (*1) | degrees | anisotropy (*1) | degrees | C2 | C3 | C6 | Remarks |
| TAC1 | Acetyl (1.01) | 2.86 | — | — | — | — | — | Comparative example |
| TAC2 | Acetyl (1.01) | 2.89 | — | — | — | — | — | Comparative example |
| M-001 | Acetyl (1.01) | 2.45 | Benzoyl (6.82) | 0.45 | 0.19 | 0.09 | 0.17 | This invention |
| M-002 | Acetyl (1.01) | 2.45 | Benzoyl (6.82) | 0.40 | 0.11 | 0.03 | 0.26 | Comparative example |
| M-003 | Acetyl (1.01) | 2.45 | Benzoyl (6.82) | 0.40 | 0.08 | 0.03 | 0.26 | Comparative example |
| M-004 | Acetyl (1.01) | 2.45 | Asaronic acid (8.61) | 0.36 | 0.03 | 0.02 | 0.31 | Comparative example |
| M-005 | Acetyl (1.01) | 2.41 | Benzoyl (6.82) | 0.40 | 0.11 | 0.06 | 0.23 | This invention |
| M-006 | Acetyl (1.01) | 2.45 | Asaronic acid (8.61) | 0.46 | 0.11 | 0.16 | 0.18 | This invention |
| M-007 | Acetyl (1.01) | 2.41 | Benzoyl (6.82) | 0.40 | 0.03 | 0.02 | 0.35 | Comparative example |
| M-008 | Acetyl (1.01) | 2.41 | Benzoyl (6.82) | 0.40 | 0.03 | 0.04 | 0.33 | Comparative example |
| M-009 | Acetyl (1.01) | 2.41 | Benzoyl (6.82) | 0.39 | 0.11 | 0.06 | 0.22 | This invention |
| M-010 | Acetyl (1.01) | 2.45 | Benzoyl (6.82) | 0.46 | 0.11 | 0.16 | 0.18 | This invention |
| M-011 | Acetyl (1.01) | 2.41 | Benzoyl (6.82) | 0.40 | 0.03 | 0.02 | 0.35 | Comparative example |
| M-012 | Acetyl (1.01) | 2.14 | Benzoyl (6.82) | 0.64 | 0.09 | 0.05 | 0.50 | Comparative example |
| M-013 | Acetyl (1.01) | 2.14 | Benzoyl (6.82) | 0.71 | 0.28 | 0.22 | 0.21 | This invention |
| M-014 | Acetyl (1.01) | 2.14 | Benzoyl (6.82) | 0.65 | 0.11 | 0.07 | 0.47 | Comparative example |
| M-015 | Acetyl (1.01) | 2.14 | Benzoyl (6.82) | 0.59 | 0.08 | 0.02 | 0.49 | Comparative example |
| M-016 | Acetyl (1.01) | 2.14 | Benzoyl (6.82) | 0.75 | 0.35 | 0.15 | 0.25 | This invention |
| M-017 | Acetyl (1.01) | 1.8 | Benzoyl (6.82) | 1.16 | 0.51 | 0.25 | 0.40 | This invention |
| M-018 | Acetyl (1.01) | 1.8 | Asaronic acid (8.61) | 1.04 | 0.40 | 0.28 | 0.36 | This invention |
| M-019 | Acetyl (1.01) | 1.8 | Benzoyl (6.82) | 0.91 | 0.20 | 0.10 | 0.61 | Comparative example |
| M-020 | Acetyl (1.01) | 1.8 | Asaronic acid (8.61) | 0.87 | 0.15 | 0.10 | 0.62 | Comparative example |

(*1): Unit of polarizability anisotropy: ×10⁻²⁴ cm³
(*2): C2, C3, and C6 in the substitution degree distribution each represent the substituted site on the glucopyranose ring that is a constituting
unit of cellulose.

<Preparation of Cellulose Compound Solution>

Any one of the compositions, as shown in Table 6, was placed in a pressure-resistant mixing tank, followed by stirring for 6 hours, to dissolve the components, to thereby prepare a cellulose compound solution (hereinafter also referred to as ‘dope’) T-1 to T-30, respectively.

(Calculation According to the Mathematical Formula (11-1))

With respect to each of the additives (plasticizers and retardation-controlling agents) added to the cellulose compound solutions T-1 to T-30, the left side value of the mathematical formula (11-1) was calculated as follows.

First, any one of the following compositions was placed in a mixing tank, followed by stirring under heating, to dissolve the components, to thereby prepare a cellulose acylate solution, respectively.

| | |
|---|---|
| Cellulose acylate (acetyl substitution degree 2.86) | 100 mass parts |
| Additive(s), as described in Table 6 | 12 mass parts |
| Methylene chloride | 317 mass parts |
| Methanol | 48 mass parts |

Separately, the following composition was placed in a mixing tank, followed by stirring under heating, to dissolve the components, to thereby prepare a cellulose acylate solution for comparison, which contained no retardation-controlling agent.

| | |
|---|---|
| Cellulose acylate (acetyl substitution degree 2.86) | 100 mass parts |
| Methylene chloride | 317 mass parts |
| Methanol | 48 mass parts |

Any one of the thus-prepared cellulose acylate solutions was formed into a cellulose acylate film of thickness 80 μm, in the same manner as the cellulose acylate film sample 001 as described below, respectively.

The retardation of each cellulose acylate film (Rth at 589 nm) was measured using KOBRA 21ADH (trade name, manufactured by Oji Scientific Instruments Co., Ltd,) in the same manner as described in the present description, and the resultant Rth values were each designated to as Rth(a) and Rth(0). The left side value of the mathematical formula (11-1) was calculated from a=12 and the thus-measured Rth(a) and Rth(0). The results are summarized in Table 6.

(Measurement of Octanol-Water Partition Coefficient (log P Value))

With respect to each of the additives added to the cellulose compound solutions T-1 to T-30 (plasticizers and retardation-controlling agents), the octanol-water partition coefficient (log P value) thereof was calculated by a computational chemical method, in place of actual measurement. Chem Draw Ultra 5.0 was used as calculation software. The measurement results are also summarized in Table 6.

TABLE 6
Table showing cellulose compound solution components (unit: part by mass)

| Cellulose | | | Plasticizer | | | | UV absorber, | | |
|---|---|---|---|---|---|---|---|---|---|
| compound | Cellulose compound | | | | Mathematical | | Re/Rth controlling agent | | |
| solution | Kind | Amount | Kind | Amount | formula (11-1) | logP | Kind | Amount | Remarks |
| T-1 | TAC | 100 | TPP/BDP | 11.70% | 0.43 | 4.455/6.343 | UVB-3/UVB-7 | 1.20% | Comparative Example |
| T-2 | TAC | 100 | PL-1 | 11.70% | −5.56 | 0.457 | none | — | Comparative Example |
| T-3 | M-001 | 100 | TPP/BDP | 11.70% | 0.43 | 4.455/6.343 | none | — | This invention |
| T-4 | M-002 | 100 | TPP/BDP | 11.70% | 0.43 | 4.455/6.343 | none | — | Comparative Example |
| T-5 | M-003 | 100 | TPP/BDP | 11.70% | 0.43 | 4.455/6.343 | none | — | Comparative Example |
| T-6 | M-004 | 100 | TPP/BDP | 11.70% | 0.43 | 4.455/6.343 | none | — | Comparative Example |
| T-7 | M-005 | 100 | TPP/BDP | 11.70% | 0.43 | 4.455/6.343 | none | — | This invention |
| T-8 | M-006 | 100 | TPP/BDP | 11.70% | 0.43 | 4.455/6.343 | none | — | This invention |
| T-9 | M-007 | 100 | TPP/BDP | 11.70% | 0.43 | 4.455/6.343 | none | — | Comparative Example |
| T-10 | M-008 | 100 | TPP/BDP | 11.70% | 0.43 | 4.455/6.343 | none | — | Comparative Example |
| T-11 | M-009 | 100 | TPP/BDP | 11.70% | 0.43 | 4.455/6.343 | none | — | This invention |
| T-12 | M-010 | 100 | TPP/BDP | 11.70% | 0.43 | 4.455/6.343 | none | — | This invention |
| T-13 | M-011 | 100 | TPP/BDP | 11.70% | 0.43 | 4.455/6.343 | none | — | Comparative Example |
| T-14 | M-012 | 100 | TPP/BDP | 11.70% | 0.43 | 4.455/6.343 | none | — | Comparative Example |
| T-15 | M-013 | 100 | TPP/BDP | 11.70% | 0.43 | 4.455/6.343 | none | — | This invention |
| T-16 | M-014 | 100 | TPP/BDP | 11.70% | 0.43 | 4.455/6.343 | none | — | Comparative Example |
| T-17 | M-015 | 100 | TPP/BDP | 11.70% | 0.43 | 4.455/6.343 | none | — | Comparative Example |
| T-18 | M-016 | 100 | TPP/BDP | 11.70% | 0.43 | 4.455/6.343 | none | — | This invention |
| T-19 | M-017 | 100 | TPP/BDP | 11.70% | 0.43 | 4.455/6.343 | none | — | This invention |
| T-20 | M-018 | 100 | TPP/BDP | 11.70% | 0.43 | 4.455/6.343 | none | — | This invention |
| T-21 | M-019 | 100 | TPP/BDP | 11.70% | 0.43 | 4.455/6.343 | none | — | Comparative Example |
| T-22 | M-020 | 100 | TPP/BDP | 11.70% | 0.43 | 4.455/6.343 | none | — | Comparative Example |
| T-23 | M-005 | 100 | C-416 | 11.70% | −5.38 | 2.43 | none | — | This invention |
| T-24 | M-006 | 100 | A-20 | 11.70% | −5.90 | 3.58 | none | — | This invention |
| T-25 | M-009 | 100 | FA-26 | 11.70% | −3.85 | 11.635 | none | — | This invention |
| T-26 | M-010 | 100 | CA-13 | 11.70% | −5.81 | 4.228 | none | — | This invention |
| T-27 | M-013 | 100 | I-6 | 11.70% | −3.50 | 8.318 | none | — | This invention |
| T-28 | M-016 | 100 | SC-1 | 11.70% | −4.36 | 2.206 | none | — | This invention |
| T-29 | M-017 | 100 | D-7 | 11.70% | −4.96 | 3.89 | none | — | This invention |
| T-30 | M-018 | 100 | FA-1 | 11.70% | −5.56 | 2.376 | none | — | This invention |
| T-31 | M-005 | 100 | C-51 | 11.70% | −1.88 | 1.14 | none | — | This invention |
| T-32 | M-005 | 100 | C-226 | 11.70% | −2.31 | 1.31 | none | — | This invention |
| T-33 | M-005 | 100 | B-2 | 11.70% | −2.31 | 3.792 | none | — | This invention |
| T-34 | M-005 | 100 | PL-10 | 11.70% | −3.59 | 3.627 | none | — | This invention |
| T-35 | M-005 | 100 | E-1 | 11.70% | −2.74 | 2.895 | none | — | This invention |

TPP: Triphenyl phosphate
BDP: Biphenyl diphenyl phosphate
EPEG: Ethyl phthalyl ethyl glycolate
UVB-3: 2-(2′-Hydroxy-3′,5′-di-tert-butylphenyl)-5-chlorobenzotriazole
UVB-7: 2-(2′-Hydroxy-3′,5′-di-tert-pentylphenyl)-benzotriazole

<Preparation of Cellulose Compound Film Sample 001>

The thus-prepared cellulose compound solution T-1 was cast on a metal support using a band casting machine, followed by drying, and the self-supporting dope cast film was stripped off from the band. The thus-stripped dope film was dried with being grasped by a tenter for keeping the film width, and then taken up on a roll, to thereby prepare a cellulose compound film sample 001 of thickness 80 μm and length 1.3 m in the transverse direction.

<Preparation of Cellulose Compound Film Samples 002 to 018, and 020 to 026>

Cellulose compound film samples 002 to 018, and 020 to 026 were prepared such that the resultant films each would have a film thickness and a length in the transverse direction, as shown in Table 7, in the same manner as in the preparation method of the cellulose compound film sample 001, except that any of the cellulose compound solutions T-2 to T-18 and T-20 to T-26 was used in place of the cellulose compound solution T-1, respectively.

<Preparation of Cellulose Compound Film Samples 019, and 027 to 030>

Cellulose compound film samples 019, and 027 to 030 were prepared such that the resultant films each would have a film thickness and a length in the transverse direction, as shown in Table 7, in the same manner as in the preparation method of the cellulose compound film sample 001, except that any of the cellulose compound solutions T-19 and T-27 to T-30 was used in place of the cellulose compound solution T-1, respectively, and that, in the step of drying the self-supporting dope film stripped from the band, an orienting step was added in which the film sample was oriented in the TD direction (i.e. the direction perpendicular to the conveyance direction) at an orientation ratio, as shown in Table 7, with being grasped with a tenter.

<Surface Treatment>

Then, the thus-prepared film sample 001 was subjected to a surface treatment as follows.

The film sample 001 prepared was immersed in a 1.5-N aqueous sodium hydroxide solution, at 55° C. for 2 minutes. The resultant sample was washed in a water washing bath at room temperature, followed by neutralization with 0.1 N sulfuric acid at 30° C. Then, the resultant sample was washed again in a water washing bath at room temperature, and dried with hot air at 100° C. Thus, a cellulose compound film sample whose surface was alkali saponified was prepared.

Further, other film samples 002 to 030 prepared each were subjected to surface treatment in the same manner as above, to give the surface treated samples, respectively.

<Evaluation of Optical Performance>

With respect to the film samples prepared above, the Re(589) and Rth (589) were measured using KOBRA 21ADH (trade name, manufactured by Oji Scientific Instruments Co., Ltd.) in the same manner as described in the present description. The results are summarized in Table 7.

<Measurement of Equilibrium Moisture Content of Film>

With respect to the film samples prepared above, the equilibrium moisture content of the film at 25° C. and 80% RH was measured in the same manner as described in the present description. The results are also summarized in Table 7.

<Preparation of Polarizing Plate>

The following polarizing plates were prepared from the thus-surface-treated film samples 001 to 030, respectively. Specifically, a roll-form polyvinyl alcohol film of thickness 80 μm was continuously oriented by a oriented magnification 5, in an aqueous iodine solution, followed by drying, to obtain a polarizing film. The thus-prepared polarizing film was sandwiched between two sheets of the surface-treated film sample prepared above, with the surface-treated side of each film sample facing to the polarizing film side, and the resultant was adhered together using a polyvinyl alcohol-based adhesive. Thus, a polarizing plate, protected by the cellulose compound film 001 on both sides, was prepared. In that procedure, the pieces of the cellulose compound film sample 001 on each sides each were adhered such that the retardation slow axis of the sample would be in parallel with the transmission axis of the polarizing film. Polarizing plates containing the surface-treated film samples 002 to 030 were also prepared in the same manner, respectively,

<Evaluation of Polarizing Plate Durability>

With respect to the polarizing plate samples prepared above, the average transmittance at 400 nm to 700 nm in a crossed nicols state was measured, and the difference in the average between those of before and after standing the samples for 1,300 hours under conditions at 60° C. and 95% RH was determined, thereby to evaluate the durability of the polarizing plates. The results are also summarized in Table 7.

TABLE 7

| | | | | | | | | Durability | IPS panel evaluation | | |
|---|---|---|---|---|---|---|---|---|---|---|---|
| | | | | | Film performance | | | of | | Black | |
| Film | | | Film | | Retardation | | | polarizing | Light | luminance | |
| sample | | Oriented | thickness | Width | Re | Rth | Water | plate | leakage | increasing rate | |
| No. | Dope | ratio | (μm) | (nm) | (nm) | (nm) | content (%) | Δp (%) | (%) | (%) | Remarks |
| 001 | T-1 | none | 80 | 1.3 | 2 | 45 | 3.2 | 0.27 | 0.63 | 0.32 | Comparative Example |
| 002 | T-2 | none | 80 | 1.3 | −3 | −65 | 4.4 | 0.47 | — | — | Comparative Example |
| 003 | T-3 | none | 92 | 1.3 | −30 | −108 | 1.5 | 0.02 | — | — | This invention |
| 004 | T-4 | none | 92 | 1.3 | 3 | 24 | 1.7 | 0.03 | — | — | Comparative Example |
| 005 | T-5 | none | 92 | 1.3 | 10 | 53 | 1.7 | 0.03 | — | — | Comparative Example |
| 006 | T-6 | none | 92 | 1.3 | 24 | 109 | 1.9 | 0.05 | — | — | Comparative Example |
| 007 | T-7 | none | 92 | 1.3 | −7 | −9 | 1.7 | 0.03 | — | — | This invention |
| 008 | T-8 | none | 92 | 1.3 | −28 | −104 | 1.5 | 0.02 | — | — | This invention |
| 009 | T-9 | none | 92 | 1.3 | 27 | 118 | 1.7 | 0.03 | — | — | Comparative Example |
| 010 | T-10 | none | 92 | 1.3 | 19 | 90 | 1.7 | 0.03 | — | — | Comparative Example |
| 011 | T-11 | none | 92 | 1.8 | −5 | −7 | 1.7 | 0.03 | — | — | This invention |
| 012 | T-12 | none | 92 | 1.8 | −32 | −121 | 1.4 | 0.02 | — | — | This invention |
| 013 | T-13 | none | 92 | 1.8 | 24 | 109 | 1.7 | 0.03 | — | — | Comparative Example |
| 014 | T-14 | none | 92 | 1.8 | 2 | 20 | 2.1 | 0.09 | — | — | Comparative Example |
| 015 | T-15 | none | 92 | 1.3 | −37 | −140 | 1.9 | 0.05 | — | — | This invention |
| 016 | T-16 | none | 92 | 1.3 | 2 | 20 | 2 | 0.07 | — | — | Comparative Example |
| 017 | T-17 | none | 92 | 1.3 | 9 | 49 | 2.3 | 0.12 | — | — | Comparative Example |
| 018 | T-18 | none | 92 | 1.3 | −50 | −195 | 1.2 | 0.02 | — | — | This invention |
| 019 | T-19 | 1.05 | 70 | 1.5 | −81 | −319 | 1 | 0.02 | — | — | This invention |
| 020 | T-20 | none | 70 | 1.5 | −62 | −244 | 1 | 0.02 | — | — | This invention |
| 021 | T-21 | none | 92 | 1.3 | 25 | 115 | 1.6 | 0.03 | — | — | Comparative Example |
| 022 | T-22 | none | 92 | 1.3 | 37 | 162 | 1.6 | 0.03 | — | — | Comparative Example |
| 023 | T-23 | none | 92 | 1.3 | −9 | −92 | 1.8 | 0.04 | 0.11 | 0.07 | This invention |
| 024 | T-24 | none | 92 | 1.3 | −31 | −203 | 1.5 | 0.02 | — | — | This invention |
| 025 | T-25 | none | 92 | 1.3 | −7 | −107 | 1.8 | 0.04 | 0.05 | 0.06 | This invention |
| 026 | T-26 | none | 92 | 1.3 | −43 | −221 | 1.6 | 0.03 | — | — | This invention |
| 027 | T-27 | 1.05 | 70 | 1.8 | −36 | −178 | 2 | 0.07 | — | — | This invention |
| 028 | T-28 | 1.05 | 70 | 1.8 | −47 | −246 | 1.2 | 0.02 | — | — | This invention |
| 029 | T-29 | 1.1 | 70 | 1.3 | −76 | −355 | 1 | 0.02 | — | — | This invention |
| 030 | T-30 | 1.05 | 70 | 1.3 | −58 | −295 | 1.1 | 0.02 | — | — | This invention |
| 031 | T-31 | none | 92 | 1.6 | −7 | −51 | 1.8 | 0.05 | — | — | This invention |
| 032 | T-32 | none | 92 | 2 | −7 | −63 | 1.8 | 0.05 | — | — | This invention |
| 033 | T-33 | none | 92 | 1.8 | −9 | −69 | 1.7 | 0.04 | — | — | This invention |
| 034 | T-34 | none | 92 | 1.5 | −8 | −82 | 1.8 | 0.05 | — | — | This invention |
| 035 | T-35 | none | 92 | 1.5 | −7 | −71 | 1.5 | 0.03 | — | — | This invention |

As is apparent from the results in Table 7, the samples 001 and 002 each of which was composed of the cellulose compound which did not have two or more substituents different in the polarizability anisotropy, exhibited a conspicuously high equilibrium moisture content, and were poor in durability of the polarizing plate. Further, the samples 004 to 006, 009, 010, 013, 014, 016, 017, 021, and 022, each of which was composed of the cellulose compound in which the substituent having the highest polarizability anisotropy did not satisfy the relationship as defined by the mathematical formula (A1), each exhibited a positive Rth value, and thus are not suitable for a liquid crystal display device of IPS mode.

Contrary to the above samples for comparison, the film samples according to the present invention, each of which was composed of the cellulose compound in which the substituent having the highest polarizability anisotropy satisfied the relationship as defined by the mathematical formula (A1), exhibited a negative Rth value. Further, the samples according to the present invention each had a remarkably low equilibrium moisture content, thus when used as a protective film for a polarizing plate, the samples according to the present invention are possible to suppress the decrease in the degree of polarization after the durability test under the high temperature and high humidity conditions. These results indicate that the samples according to the present invention are capable of improving the durability of polarizing plates.

Further, in comparison between the samples composed of the same cellulose compound, it can be understood that the samples 023 to 030 containing a specific retardation-controlling agent as described in the present description each exhibited a further lower Rth value than the samples 007, 008, 011, 012, 015, 018, 019, and 020 containing no retardation-controlling agent.

Furthermore, in comparison between the samples composed of the same cellulose compound M-005, the samples 023, 031 to 035 containing a compound having an octanol-water partition coefficient (log P value) of 1 to 10 as the retardation-controlling agent each exhibited a further lower Rth value than the sample 007 containing a compound having a log P value exceeding 10 as the retardation-controlling agent.

### Example 2

<Preparation of Polarizing Plate-Incorporated Optical Compensation Film Sample 001>

The surface of the cellulose compound film sample 001 as prepared in Example 1 was saponified in the same manner as in Example 1, and then the resultant film was coated with an oriented-film-coating solution having the following composition in a quantity of 20 ml/m² using a wire bar coater. The coating was dried with hot air at 60° C. for 60 seconds, and further dried with hot air at 100° C. for 120 seconds, to form a film. Then, the thus-formed film was rubbed in the direction in parallel with the retardation slow axis direction of the film, to thereby form an oriented film.

(Composition of the oriented-film-coating solution)

| | | |
|---|---|---|
| The following modified polyvinyl | 10 | mass parts |
| alcohol | | |
| Water | 371 | mass parts |
| Methanol | 119 | mass parts |
| Glutaraldehyde | 0.5 | mass part |
| Tetramethyl ammonium fluoride | 0.3 | mass part |
| Modified polyvinyl alcohol | | |

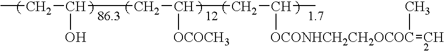

Then, the thus-oriented film was coated, using a #5.4 wire bar coater, with a solution prepared by dissolving 1.8 g of the following discotic liquid crystal compound, 0.2 g of an ethylene oxide-modified trimethylolpropane triacrylate (trade name: V#360, manufactured by Osaka Organic Chemical Industry, Ltd.), 0.06 g of a photopolymerization initiator (trade name; IRGACURE-907, manufactured by Ciba-Geigy Japan, Ltd.), 0.02 g of a sensitizer (trade name: KAYACURE DETX, manufactured by Nippon Kayaku Co., Ltd.), and 0.01 g of the following air interface-side vertically orienting agent (P-6) in 3.9 g of methyl ethyl ketone. The thus-coated film was attached to a metal frame, and heated in a thermostat bath at 125° C. for 3 minutes, to orient the discotic liquid crystal compound. Then, the resultant film was irradiated with a ultraviolet ray with a high-pressure mercury lamp of 120 W/cm² at 90° C., for 30 seconds, to crosslink the discotic liquid crystal compound, followed by cooling to room temperature, to thereby form a discotic liquid crystal retardation layer. The thus-prepared film having a discotic liquid crystal retardation layer and a support composed of the cellulose compound film sample 001, is designated to as an optical anisotropy layer-containing cellulose compound film sample 001.

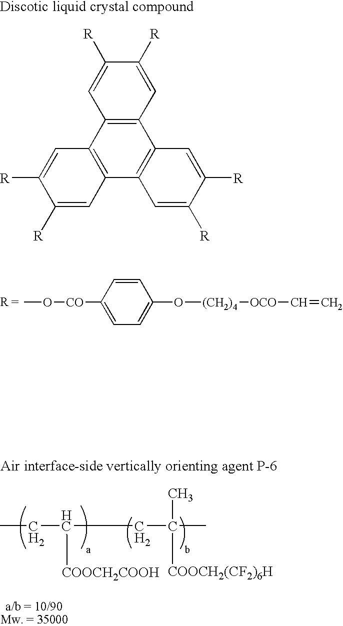

The light-incident-angle dependency of Re of the optical anisotropy layer-containing cellulose compound film 001 was measured, using an automatic birefringence meter(trade name: KOBRA-21ADH, manufactured by Oji Scientific Instruments Co., Ltd.); and, from the thus-measured light-incident-angle dependency of Re, was subtracted the contribution of the cellulose compound film sample 001, which had been measured previously, to determine the optical properties of the discotic liquid crystal retardation layer alone. As a result of measurement, Rth was −97 nm and Re was 195 nm at 589.3 nm, and the average inclination angle of the liquid crystals was 89.9°. Thus, it was confirmed that the discotic liquid crystal was oriented perpendicular to the film plane. Further, the direction of the retardation slow axis was in parallel with the direction of rubbing the oriented film. The discotic liquid crystal retardation layer prepared above was a retardation layer, in which the refractive index anisotropy was negative, and the light axis was in substantially parallel with the layer plane. The discotic liquid crystal retardation layer is designated to as an optical compensation layer 1.

In the same manner as in Example 1, iodine was adsorbed to an oriented polyvinyl alcohol film, to form a polarizing film. The surface of the optical anisotropy layer-containing cellulose compound film sample 001 was saponified in the same manner as in Example 1, and the resultant film sample was adhered to one side of the polarizing film, using a polyvinyl alcohol-based adhesive, so that the cellulose compound film was positioned to the polarizing film side. The transmission axis of the polarizing film was arranged orthogonal to the retardation slow axis of the optical anisotropy layer-containing cellulose compound film sample 001, whose retardation slow axis was consistent with the retardation slow axis of the optical compensation layer 1. Further, a commercially available cellulose acetate film (trade name: FUJITAC TD80UF, manufactured by Fuji Photo Film Co., Ltd.) was saponified, and adhered to the other side of the polarizing film using a polyvinyl alcohol-based adhesive, thus a polarizing plate-incorporated optical compensation film sample 001 was prepared.

<Preparation of Polarizing Plate-Incorporated Optical Compensation Film Samples 023 and 025>

Polarizing plate-incorporated optical compensation film samples 023 and 025 were prepared in the same manner as the preparation method of the polarizing plate-incorporated optical compensation film sample 001, except that the cellulose compound film sample 023 or 025 as prepared in Example 1 was used in place of the cellulose compound film sample 001.

<Preparation of IPS-Mode Liquid Crystal Cell>

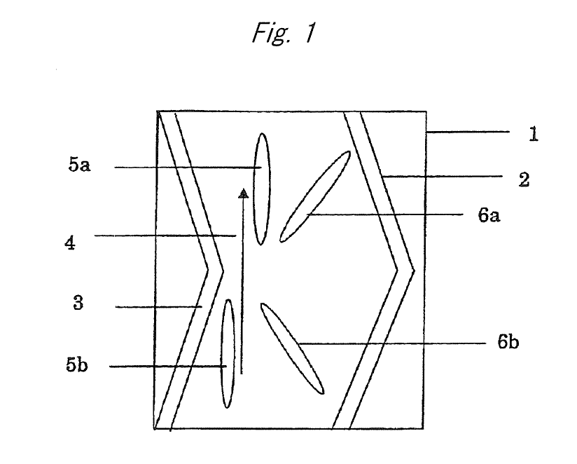

FIG. 1 is a schematic view showing an IPS-mode liquid crystal cell. As shown in FIG. 1, electrodes (a pixel electrode 2 and a display electrode 3, in FIG. 1) were arranged in the liquid crystal device pixel area 1 on a glass substrate such that the distance between the adjacent electrodes would be 20 μm. Then, on the glass substrate on which the electrodes were provided, a polyimide film was provided as an oriented film, followed by rubbing in the rubbing direction 4 as shown in FIG. 1. Separately, a glass substrate was provided, a polyimide film was provided on one surface of the substrate, followed by rubbing, to form an oriented film. The thus-prepared two glass substrates were adhered together in such a manner that the oriented films would be adhered facing each other, the distance (gap; d) between the substrates would be 3.9 μm, and the rubbing directions of the two glass substrates would be in parallel with each other. Then, a nematic liquid crystal composition having a refractive index anisotropy (Δn) of 0.0769 and a permittivity anisotropy (Δε) of positive 4.5 (in FIG. 1, directors 5a and 5b for the liquid crystal compound during displaying black, and directors 6a and 6b for the liquid crystal compound during displaying white), was sealed in. The d·Δn value of the liquid crystal layer was 300 nm.

<Evaluation of Light Leakage in IPS-Mode Liquid Crystal Display Device>

Then, using the thus-prepared polarizing plate-incorporated optical compensation film, a liquid crystal display device was prepared, and it evaluated as to light leakage. Meanwhile, the polarizing plate-incorporated optical compensation film prepared in a lengthy form was cut into a predetermined size, and the cut film was incorporated into the liquid crystal display device.

The polarizing plate-incorporated optical compensation film 001 was adhered to one side of the IPS-mode liquid crystal cell using an adhesive, in such a manner that the retardation slow axis of the optical anisotropy layer-containing cellulose compound film sample 001 would be orthogonal to the direction of rubbing the liquid crystal cell (i.e., the retardation slow axis of the optical compensation layer 1 would be orthogonal to the retardation slow axis of the liquid crystal molecules of the liquid crystal cell during displaying black), and that the side of the discotic liquid crystal retardation layer plane would be positioned in the liquid crystal cell side. Then, a commercially available polarizing plate (trade name: HLC2-5618, manufactured by Sanritz Corporation) was adhered to the other side of the IPS-mode liquid crystal cell 1 in a crossed nicols state, thus a liquid crystal display device 001 was prepared.

The liquid crystal display devices 023 and 025 were prepared in the same manner as above, by incorporating the polarizing plate-incorporated optical compensation films 023 and 025 into IPS-mode liquid crystal display devices, respectively.

<Evaluation of Viewing Angle Dependency of Liquid Crystal Display Device Thus Prepared>

The viewing angle dependency of transmittance of the liquid crystal display device prepared above was measured. Measurements were conducted at elevation angles up to 80° with 10° intervals from the front direction to an oblique direction, and at azimuth angles from the horizontal right direction (0°) to 360° with 10° intervals. It was observed that the luminance during displaying black was increased due to leakage light as the elevation angle increased from the front direction, that the increase had the maximum value in the vicinity of the elevation angle of 70°, and further that the increase in the luminance during displaying black deteriorated the contrast.

Taking the above into consideration, a luminance LA during displaying black was measured at an elevation angle of 60° and an azimuth angle rotated by 45° to the left from the direction of rubbing the liquid crystal cell, and a luminance LB during displaying white was measured at an elevation angle of 60° and an azimuth angle rotated in 45° to the left from the direction of rubbing the liquid crystal cell, and the light leakage (%) was determined as the proportion of LA to LB, by which the contrast was evaluated.
(Light leakage)=LA/LB

The results are summarized in Table 8.

<Evaluation of Durability of Liquid Crystal Display Device Prepared>

The image center region of the liquid crystal display device prepared above was observed, to measure the black luminance in the direction from the front plane before and after the durability test, and the ratio (%) of the (difference of the black luminance between before and after the lapse of time) to the (white luminance before the lapse of time) was determined as a black luminance increase rate with the lapse of time, by which the durability of the liquid crystal display device was evaluated.
(Durability evaluation)={(black luminance with the lapse of time)−(black luminance before the lapse of time)}/(white luminance before the lapse of time)

The results of the evaluation are also summarized in Table 8.

TABLE 8

| Liquid crystal | | | |
|---|---|---|---|
| display | Light leakage | Black luminance | |
| sample No. | (%) | increase rate (%) | Remarks |
| 001 | 0.63 | 0.32 | Comparative |
| | | | example |
| 023 | 0.11 | 0.07 | This invention |
| 025 | 0.05 | 0.06 | This invention |

As is apparent form the results in Table 8, it can be understood that the liquid crystal display devices using the polarizing plate in which the film sample according to the present invention (the film sample 023 or 025) was used as the protective film for the polarizing plate, were excellent in the viewing angle properties, and that the liquid crystal display devices of the present invention suppressed the increase in black luminance after the durability test under the high temperature and high humidity conditions, which indicates that they are excellent in durability.

Having described our invention as related to the present embodiments, it is our intention that the invention not be limited by any of the details of the description, unless otherwise specified, but rather be construed broadly within its spirit and scope as set out in the accompanying claims.

This non-provisional application claims priority under 35 U.S.C. §119 (a) on Patent Application No. 2006-128452 filed in Japan on May 2, 2006, which is entirely herein incorporated by reference.

What we claim is:

1. A cellulose compound film containing a cellulose compound having two or more substituents whose polarizability anisotropies Δα which are calculated by mathematical formula (1) are different from each other, wherein substitution degrees of the following substituents A and B in the cellulose compound satisfy relationship as defined by mathematical formula (A1), in which the substituent A has the lowest polarizability anisotropy Δα and the substituent B has the highest polarizability anisotropy Δα:
$$Δ α = α \times - \frac{α y + α z}{2} \qquad Mathematical formula ( 1 )$$
wherein αx is the largest component in characteristic values obtained after diagonalization of polarizability tensor; αy is the second largest component in the characteristic values obtained after diagonalization of the polarizability tensor; and αz is the smallest component in the characteristic values obtained after diagonalization of the polarizability tensor;
DS_{B}2+DS_{B}3−DS_{B}6≧0.1 Mathematical formula (A1)
wherein DS_{B}2, DS_{A}3, and DS_{B}6 represent a substitution degree of the substituent B at the 2-, 3-, or 6-position of a β-glucose ring that is a constituting unit of cellulose, respectively.

2. The cellulose compound film as claimed in claim 1, wherein the retardation Rth in the film thickness direction is negative.

3. The cellulose compound film as claimed in claim 1, wherein the total of the substitution degrees of the substituents A and B satisfies relationship as defined by mathematical formula (A2):
DS_{A}2+DS_{A}3+DS_{A}6>DS_{B}2+DS_{B}3+DS_{B}6 Mathematical formula (A2)
wherein DS_{A}2, DS_{A}3, and DS_{A}6 represent a substitution degree of the substituent A at the 2-, 3-, or 6-position of a β-glucose ring that is a constituting unit of cellulose, respectively; and DS_{B}2, DS_{B}3, and DS_{B}6 represent a substitution degree of the substituent B at the 2-, 3-, or 6-position of a β-glucose ring that is a constituting unit of cellulose, respectively.

4. The cellulose compound film as claimed in claim 1, wherein the total of the substitution degrees of the substituents A and B satisfies relationship as defined by mathematical formula (A3):
1.5≦DS_{A}2+DS_{A}3+DS_{A}6+DS_{B}2+DS_{B}3+DS_{B}6≦3.0 Mathematical formula (A3)
wherein DS_{A}2, DS_{A}3, and DS_{A}6 represent a substitution degree of the substituent A at the 2-, 3-, or 6-position of a β-glucose ring that is a constituting unit of cellulose, respectively; and DS_{B}2, DS_{B}3, and DS_{B}6 represent a substitution degree of the substituent B at the 2-, 3-, or 6-position of a β-glucose ring that is a constituting unit of cellulose, respectively.

5. The cellulose compound film as claimed in claim 1, wherein the polarizability anisotropy of the substituent B is 2.5×10⁻²⁴ cm³ or more.

6. The cellulose compound film as claimed in claim 5, wherein the substituent B having a polarizability anisotropy of 2.5×10⁻²⁴ cm³ or more is an aromatic acyl group.

7. The cellulose compound film as claimed claim 1, containing a retardation-controlling agent which has an octanol-water partition coefficient (log P value) of 1.0 to 10.0.

8. The cellulose compound film as claimed in claim 1, wherein the equilibrium moisture content of the film at 25° C. and 80% RH is 3.0% or less.

9. The cellulose compound film as claimed in claim 1, wherein the film is oriented in an amount of 1% or more but 100% or less in the film conveyance direction and/or the direction perpendicular to the film conveyance direction.

10. The cellulose compound film as claimed in claim 1, containing at least one retardation-controlling agent which satisfies relationship as defined by mathematical formula (11-1):
$$\frac{Rth ( a ) - Rth ( 0 )}{a} ≦ - 1.5 \qquad Mathematical formula ( 11 \text{-} 1 )$$
in which, a is: 0.01≦a≦3.0
wherein Rth(a) is a Rth (nm) of a cellulose acetate film at wavelength 589 nm, which film has a thickness of 80 μm and contains the retardation-controlling agent in an amount of a % by mass to cellulose acetate whose substitution degree of an acetyl group is 2.86; Rth(0) is a Rth (nm) of a film at wavelength 589 nm, which film has a thickness of 80 μm, and is composed of cellulose acetate whose substitution degree of an acetyl group is 2.86 which does not contain the retardation-controlling agent, and a is an amount in part by mass of the retardation-controlling agent to 100 parts by mass of cellulose acetate.

11. The cellulose compound film as claimed in claim 10, wherein the retardation-controlling agent is at least one of compounds represented by any one of formulae (1) to (19): 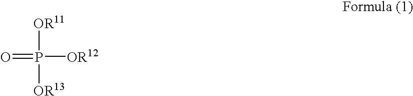
wherein R¹¹, R¹² and R¹³ each independently represent an aliphatic group having 1 to 20 carbon atoms, in which the aliphatic group may have a substituent, and R¹¹, R¹² and R¹³ may be combined each other to form a ring; 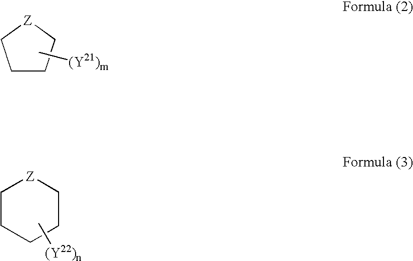
wherein Z represents a carbon atom, an oxygen atom, a sulfur atom, or −NR²⁵—, in which R²⁵ represents a hydrogen atom or an alkyl group, the 5- or 6-membered ring formed by containing Z may have a substituent; Y²¹ and Y²² each independently represent an ester group, an alkoxycarbonyl group, an amido group, or a carbamoyl group, each having 1 to 20 carbon atoms, or Y²¹s may be combined each other to form a ring, and Y²²s may be combined each other to form a ring; m represents an integer of 1 to 5; and n represents an integer of 1 to 6; 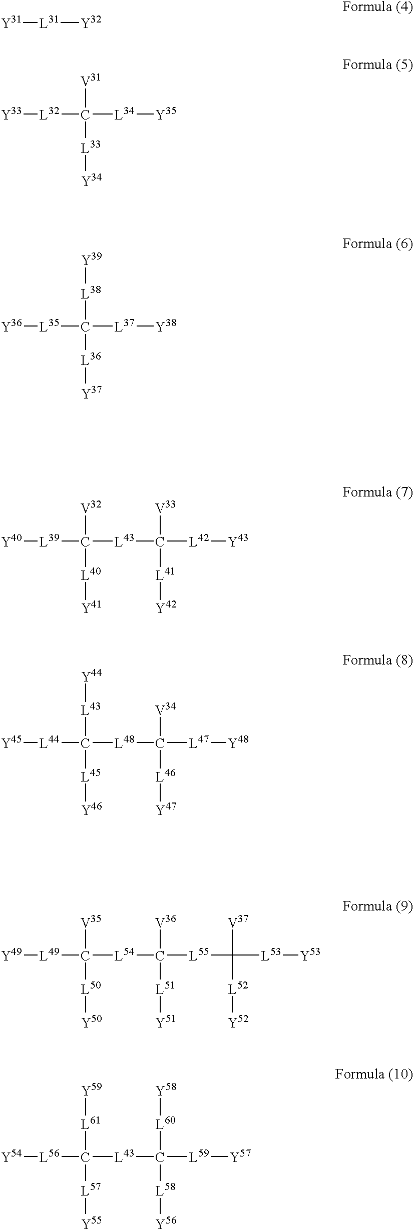 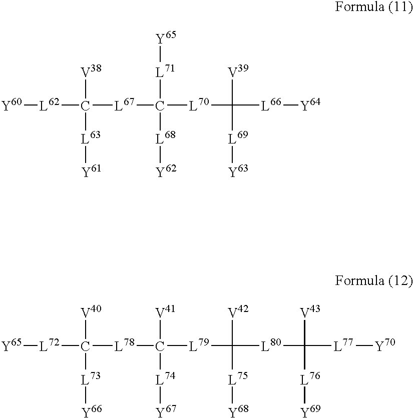
wherein Y³¹ to Y⁷⁰ each independently represent an ester group, an alkoxycarbonyl group, an amido group, or a carbamoyl group, each having 1 to 20 carbon atoms, or a hydroxy group; V³¹ to V⁴³ each independently represent a hydrogen atom or an aliphatic group having 1 to 20 carbon atoms, L³¹ to L⁸⁰ each independently represent a saturated divalent linking group which is composed of 0 to 40 atoms for constituting the group and which has 0 to 20 carbon atoms; when L³¹ to L⁸⁰ are each composed of zero (0) atom, it means that L³¹ to L⁸⁰ each represent a single bond; and V³¹ to V⁴³ and L³¹ to L⁸⁰ each may further have a substituent; 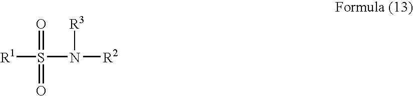
wherein R¹ represents an alkyl group or an aryl group, and R² and R³ each independently represent a hydrogen atom, an alkyl group, or an aryl group, in which the total of carbon atoms of R¹, R², and R³ is 10 or more, and the alkyl group and the aryl group each may have a substituent; 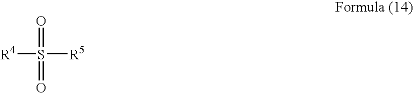
wherein R⁴ and R⁵ each independently represent an alkyl group or an aryl group, in which the total of carbon atoms of R⁴ and R⁵ is 10 or more, and the alkyl group and the aryl group each may have a substituent; 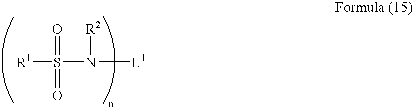
wherein R¹ represents a substituted or unsubstituted aliphatic group, or a substituted or unsubstituted aromatic group; R² represents a hydrogen atom, a substituted or unsubstituted aliphatic group, or a substituted or unsubstituted aromatic group; L¹ represents a divalent to hexavalent linking group; and n represents an integer of 2 to 6 corresponding to the valence of L¹; 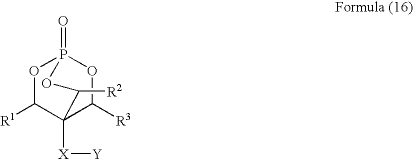
wherein R¹, R², and R³ each independently represent a hydrogen atom or an alkyl group; X represents a divalent linking group composed of at least one selected from the following ‘linking groups 1’; and Y represents a hydrogen atom, an alkyl group, an aryl group, or an aralkyl group:
‘Linking groups 1’ includes a single bond, —O—, —CO—, —NR⁴— (in which R⁴ represents a hydrogen atom, an alkyl group, an aryl group, or an aralkyl group.), an alkylene group, and an arylene group; 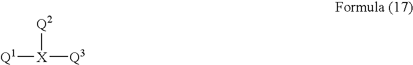
wherein Q¹, Q², and Q³ each independently represent a 5- or 6-membered ring; and X represents B, C—R, N, P, or P═O, in which R represents a hydrogen atom or a substituent; 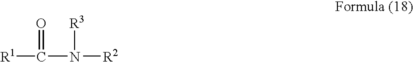
wherein R¹ represents an alkyl group or an aryl group, and R² and R³ each independently represent a hydrogen atom, an alkyl group, or an aryl group, in which the alkyl group and the aryl group each may have a substituent; 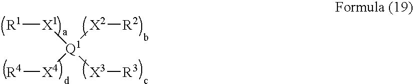
wherein R¹, R², R³, and R⁴ each independently represent a hydrogen atom, a substituted or unsubstituted aliphatic group, or a substituted or unsubstituted aromatic group; X¹, X², X³, and X⁴ each independently represent a divalent linking group formed by at least one selected from the group consisting of a single bond, —CO—, and —NR⁵— (in which R⁵ represents a substituted or unsubstituted aliphatic group, or a substituted or unsubstituted aromatic group); a, b, c, and d each are an integer of 0 or more, and a+b+c+d is 2 or more; and Q¹ represents an organic group having a valence of (a+b+c+d).

12. An optical compensation sheet, comprising the cellulose compound film as claimed in claim 1.

13. A polarizing plate, comprising a polarizing film, and two transparent protective films disposed on both sides of the polarizing film, wherein at least one of the transparent protective films is the optical compensation sheet as claimed in claim 12.

14. A liquid crystal display device, comprising a liquid crystal cell, and two polarizing plates disposed on both sides of the liquid crystal cell, wherein at least one of the polarizing plates is the polarizing plate as claimed in claim 13.

15. The liquid crystal display device as claimed in claim 14, wherein a display mode of the liquid crystal display device is an IPS mode.

16. An optical compensation sheet, having an optical anisotropic layer on the cellulose compound film as claimed in claim 1.

17. A polarizing plate, comprising a polarizing film, and two transparent protective films disposed on both sides of the polarizing film, wherein at least one of the transparent protective films is the optical compensation sheet as claimed in claim 16.

18. A liquid crystal display device, comprising a liquid crystal cell, and two polarizing plates disposed on both sides of the liquid crystal cell, wherein at least one of the polarizing plates is the polarizing plate as claimed in claim 17.

19. The liquid crystal display device as claimed in claim 18, wherein a display mode of the liquid crystal display device is an IPS mode.
